(19) United States
(12) Patent Application Publication
(10) Pub. No.: US 2015/0298992 A1
(43) Pub. Date: Oct. 22, 2015

(54) Process Water Treatment Using Liquid-Liquid Extraction Technology

(71) Applicant: BATTELLE MEMORIAL INSTITUTE, Columbus, OH (US)

(72) Inventors: Bruce F. Monzyk, Town Creek, AL (US); Tenisha Highsmith, Beavercreek, OH (US); Paul J. Usinowicz, Delaware, OH (US); Niharika Chauhan, Chicago, IL (US); Ann Lane, Upper Arlington, OH (US); Rick Peterson, Galloway, OH (US); Slawomir Winecki, Dublin, OH (US)

(73) Assignee: BATTELLE MEMORIAL INSTITUTE, Columbus, OH (US)

(21) Appl. No.: 14/437,540

(22) PCT Filed: Oct. 31, 2013
(86) PCT No.: PCT/US2013/067863

§ 371 Date: Apr. 22, 2015

Related U.S. Application Data
(60) Provisional application No. 61/720,435, filed on Oct. 31, 2012.

(51) Int. Cl. C02F 1/26; C02F 1/66

(52) U.S. Cl. CPC C02F 1/26; C02F 1/66; C02F 2101/105

(57) ABSTRACT

The invention provides an efficient method to treating a nutrient rich process water, such as municipal, agricultural, and/or farm water. The process water is treated by first extracting one or more P- and/or N-based ionic species from the process water with an extractant phase, resulting in an ion-loaded extractant phase; and then stripping one or more ionic species from the ion-loaded extractant phase to obtain a stripped extractant phase and useful concentrated ionic products. The stripped extractant phase is preferably recycled. A continuous flow treatment process is provided. The process is also capable of inactivating pathogens and reducing odors.

### FIELD OF THE INVENTION

The invention provides for a large scale process water treatment process that is suitable for treating agricultural, municipal, anaerobic- and aerobic-digested, or farm water by removing one or more ionic species, such as phosphates, ammoniums, and/or nitrates; and by producing useful, concentrated ionic products.

### BACKGROUND OF THE INVENTION

The demand for decontaminated fresh water has been steadily increasing in the United States and worldwide due to increasing populations and increasing industrial, municipal, agriculture, and farm uses; and this trend is projected to continue. A particularly problematic example is the use of chemical or natural fertilizers that contain a substantial amount of nitrogen, ammonium and phosphorus since presence of these species in drinking waters can cause serious illness in human beings. Especially, if excessive amounts of phosphorus or nitrogen are added to any surface or ground water source, such as lakes, streams, ponds, gulfs, or rivers of any size, blue green “algae” (actually a bacterium) and aquatic plants can grow in large quantities. When these algae and plants die, they are decomposed by bacteria, which use dissolved oxygen, reducing the dissolved oxygen concentration in the water, which is called “eutrophication.” Eutrophication and algal blooms are very harmful to the environment because they remove a large amount of oxygen from the water, causing death of fish and other aquatic organisms in the water. Excessive amounts of algae can also clog water-intake pipes, and give rise to foul odors by their rapid decomposition. More importantly, nutrient pollution in drinking water is also harmful to humans, particularly nitrate and nitrite to infants and unborn children, and/or mycocystin to the larger population.

At the same time, nutrients available for fertilizer, such as phosphorus, nitrates and ammonia, are in danger of being short of future supplies. Phosphorus (P) is a critical nutrient of life and is used in its fully oxidized “phosphate” oxidation state to stimulate high agricultural food crop yields. Currently, phosphate comes from anthropogenic mining of ancient coral and ancient sea bed sediment deposits. These deposits have been taxed heavily, creating some questions of sufficient future supplies. Ammonia production is very energy intense, since it requires breaking the triple bond in N₂ gas and reforming H₂O into H₂, and therefore it is costly to produce in the current high energy cost environment worldwide.

The most typical method that farms use for treating process water is a lagoon where the waste can be kept away from water sources and where bacteria can slowly decompose and remove the organic pollutants over time (it is also called Biological Nutrient Removal—BNR). However, these lagoon operations still leave in the treated water the inorganic soluble nutrients, especially P and N. In addition, lagoons are exposed to the environment, and as such, they are typically kept away from fresh water sources and other important areas on a farm. As the result, a couple acres of land are generally devoted to multiple lagoons. Further, lagoons can produce gases, such as methane, carbon dioxide, ammonia, hydrogen sulfide, and the like, which are harmful to the environment. Moreover, lagoons are prone to leaks and spills, especially in regions of excess rain and runoff. According to the National Resources Defense Council, heavy rains on hog lagoons in 1995 caused them to rupture and spilled 25 million gallons of manure into the New River of North Carolina, which results in killing millions of fish and closing thousands of acres of wetlands to fishing because of resulting high growth of toxic human parasite growth. Finally, this method requires further processing steps to recover the nutrients in a usable form, making the whole process more expensive.

U.S. Pat. Nos. 5,522,997 and 5,968,364 (patents '997 and '364) to Virnig et al. disclose a method of extracting anionic metal species from aqueous alkaline solutions by contacting the aqueous alkaline solutions with an extractant compound that is capable of being protonated at a pH of 9 or above (the extractant). According to Virnig et al., the extractant becomes protonated upon contacting with the aqueous solution and thus raises the pH of the aqueous solution to 11 or even over 12. That is, as the pH of the extractant increases, the efficiency of extraction for certain anions decreases for the extractant. To prevent this decrease of the extraction efficiency, an aqueous buffer solution having a pH between about 8.5 and about 10.5 is added to the extractant phase to pre-equilibrate the extractant phase. Preferably, the buffer is a mixture of carbonate and bicarbonate ions.

PCT patent application publication no. WO2008/100610 to Monzyk et al. disclose a method for purifying an aqueous solution, typically mine drainage water, by simultaneously removing both cationic and anionic components while neutralizing acidity and lowering total dissolved solids by a liquid-liquid extraction method. This method includes two phases: one is the extraction phase and the other is the stripping phase. During the extraction phase, flocs are formed, which are colloids with at least one cationic and at one anionic component that are extracted from the aqueous solution. Such flocs require special equipment to remove from the extraction phase. The stripping solution in Monzyk et al.'s method can be in the pH range of 0 to about 14.

In addition, process water streams associated with concentrated animal feeding operations (CAFOs) represented particular challenges regarding microbial pathogens. Several waterborne disease outbreaks have been linked to livestock manure including Walkerton, Canada, where a virulent strain of E. coli O157H7 contaminated a public water system, resulting in 7 deaths. Protozoan pathogens such as Cryptosporidium and Giardia are also associated with livestock manure and source tracking studies have suggested that infectivity is related to manure management strategies. Traditional chemical-based approaches for control of pathogens, such as using chlorine, can result in the generation of disinfection byproducts such as trihalomethane and haloacetic acids, which have health and environmental implications.

### BRIEF DESCRIPTION OF THE INVENTION

There exists a need for a practical, low-cost, large-scale, continuous water treatment process to remove ionic species, such as phosphate and polyphosphate ions, from process water streams, especially nutrient rich process water such as agriculturally use 710d water. Nutrient rich process water (also called “Process Water”) refers to farm lagoon discharge water (“farm water”), barn flush water, industrial or agricultural runoff or stormwaters, anaerobic digester effluent process waters (“AD process water” or “AD effluent”), other aqueous solutions (such as aqueous feed solution, aqueous feed, water feed, or surrogate water) or other process waters that contain P- and/or N-based nutrient species. In other words, the term “aqueous phase,” “aqueous feed solution,” “aqueous feed,” “aqueous solution,” “aqueous inflow feed,” “water feed,” “feed water,” “AD effluent,” “farm water” or “AD water feed” refers to a type of the process waters that are suitable for the present water treatment process. The term “feed” refers to the flow rate of the incoming stream of solutions, such as the extractant phase or the process water. Sometimes, to provide a better contrast to the extractant phase or to describe the phase separation better among other reasons, the process water and/or the treated process water is referred as the aqueous phase in the application.

Broadly, this invention provides an efficient method to treat an aqueous solution, such as a nutrient rich process water (for example, agriculturally used water), by using an extraction phase liquid-liquid extraction (LLX) process to remove one or more ionic species, and then stripping such ionic species to produce useful concentrated ionic products, while at the same time, regenerating the extractant phase for reuse. Preferably, the continuous treatment of these waters using the method of the present invention results in waters suitable for reuse or discharge according to environmental requirements.

The invention provides an efficient means to treat or purify water by removing ionic species, especially the removal of anionic species, such as phosphates, poly and/or bio-phosphates, and/or nitrates, and especially to remove these ions to very low ppm levels (mg/L), or even to very low ppb levels (μg/L), so that it is possible to discharge such treated waters without causing the P—PO₄ based water eutrophication, which otherwise would happen under normal conditions. Though applicable for treating water at all scales, the invention is most useful in treating very large volumes of water of ten to ten thousand gallons per minute flow rate in a continuous-flow fashion using a unique combination of kinetic process chemistry and physical separation technologies based on liquid-liquid extraction process (LLX process).

Unique attributes of the process chemistry of the present invention are that it:
provides for the fast removal of specific ionic species (mostly from agricultural water), such as phosphate ions, polyphosphate ions, organo-phosphate ion, nitrate ion, nitrite ion, including the protonated versions of these ions, simultaneously at rates 10-100 times faster than conventional phosphate or nutrient removal technologies;
provides for the fast removal of the ionic species, on the order of seconds to minutes, depending on the equipment, operation condition, equipment design for the mixing and phase disengagement;
provides for the removal of these ionic species to trace levels (low ppm to ppb);
provides simultaneous removal of pathogens and/or process water vapors along with the removal of specific ionic species from nutrient rich process water or similar process water;
provides the production of useful ion concentrate products, such as phosphate/nitrate ion concentrate products, which are of significant value to the crop farmer due to the high cost needed to obtain these nutrients from primary sources (e.g. ore bodies or atmospheric N₂); and
provides for the fast recovery of the regenerated (stripped) extractant phase for recycling back into the LLX process up to possibly thousands of times, which reduces the inventory, logistics and cost of the E-phase chemicals in the deployment of said LLX technology.

One broad embodiment of the present invention includes a method for treating a process water to remove one or more P- and/or N-based ionic species, comprising steps of:
mixing the aqueous solution with an extractant phase to form a first unstable emulsion wherein the extractant phase comprises:
   an extractant that forms the first unstable emulsion with one or more of the ionic species of the aqueous solution, wherein the extractant comprises a positively charged molecule having at least 8 carbon atoms, and an anionic base;
   an optional diluent; and
   an optional modifier for modifying phase disengagement;
disengaging and separating a first treated process water and an ion-loaded extractant phase from the first unstable emulsion to generate a separated ion-loaded extractant phase; and
stripping one or more ionic species from the separated ion-loaded extractant phase to obtain a stripped extractant phase and concentrate ionic products, comprising steps of
   i. mixing the separated ion-loaded extractant phase with a first aqueous base solution to form a second unstable emulsion;
wherein one or more ionic species, such as phosphate, in the separated ion-loaded extractant phase are stripped from the separated ion-loaded extractant phase and loaded into the first aqueous base solution; wherein a second aqueous base solution is added to the second unstable emulsion during the stripping process to keep the equilibrium pH of the second unstable emulsion to be about 11 or above, preferably at about pH of 13 to 14; and
   ii. disengaging and separating a stripped extractant phase and a loaded first aqueous base solution from the second unstable emulsion, resulting in a regenerated extractant phase and an ion-loaded aqueous phase containing concentrated ionic products.

In simplified terms, the method is divided into two parts: an extraction stage or phase, where the incoming process water is treated to remove certain ionic species; and a stripping stage or phase, where the extractant is regenerated and the removed ionic species becomes concentrated ionic products. The ionic species suitable for removal by the present inventive method are phosphate, polyphosphate, organo-phosphate, nitrate, nitrite, or a mixture thereof.

During the extraction stage, an extractant phase is used to treat the process water. The extractant phase is an organic phase that is immiscible with the process water, which is an aqueous phase. Preferably, the extractant phase contains an extractant, an optional diluent, and an optional modifier for modifying phase disengagement. The extractant includes (or comprises) a positively charged molecule having at least 8 atoms and an anionic base.

The positively charged extractant component comprises a quaternary ammonium or phosphonium compound selected from the group consisting of R₄N⁺, R₄P⁺, an alkylated monoguanadinium compound, and a mixture thereof; where the R groups may differ and are a hydrocarbon consisting of alkyl groups, aryl groups, alkylaryl groups, any combination of these, including atoms of other elements such as N, P, O, X and S, where “X” is halogen or pseudohalogen, so that the water solubility is not significantly increased or the monocationic charge for the whole molecule is not changed, and the charge does not change with pH up until a pH of about 11, and where the minimum carbon number (CN) is >8, preferably >17, and more preferably >24, and most preferably where at least one alkyl group in the molecule is branched, and wherein the anionic base is selected from the group consisting of CO₃²⁻, HCO₃⁻, OH⁻, HS⁻, S²⁻, and a mixture thereof. The preferred extractant is methyl tri(n-octyl) ammonium ion, or R₄N⁺. See Table A-1 for the preferred composition of the extractant phase.

Preferably, the ratio (in volume) between the extractant phase and the incoming process water (aqueous phase), which is called E/A ratio, is in the range of 1:3 to 3:1, preferably in the range of 1:1 to 1:3, most preferably is 1:2. The E/A ratio is somewhat dependent upon the characteristics of the process water. After mixing the extractant phase and the process water, the formation of the unstable emulsion enables the removal of the ionic species from the process water to the extractant phase. Then, the ion-loaded extractant phase and the treated process water is separated or disengaged, a process called phase disengagement. The phase disengagement can be sped up or managed through pH adjustment (reducing pH from 9 to 7, 6, or 5), increasing temperature (increasing from 30° C. to 40° C. and even to 50° C.), varying mixing method or strength of mixing (vigorous vs. gentle), viscosity adjustment of the process water, and providing sufficient or enough time for the phase separation (separating the treated aqueous phase and the ion loaded extraction phase).

The time provided for phase separation can vary depending on the method of separation and the strength of mixing, preferably in the range of 10 seconds to 50 minutes. If the mixing is vigorous, then more time is needed, preferably in the range of 20 to 50 min. Alternatively, if a centrifuge is used to separate the phases, the phase separation can be accomplished in 2-10 minutes.

Preferably, the process water undergoes two or more extraction stages, preferably two to fifteen extraction stages, more preferably two to ten extraction stages, most preferably two to six extraction stages in order to remove most of or substantially all of P- and/or N-based ionic species. One extraction stage refers to the mixing of the process water with the extractant phase for a time to form an unstable emulsion (the first unstable emulsion), through which the ions are extracted from the process water, and the subsequent separation and disengagement. For example, the process water is mixed with the extractant phase together long enough to become the first treated process water. After separating and disengaging from the extractant phase, the first treated process water is then mixed with the fresh or regenerated (recycled) extractant phase to become the second treated process water, and so on, until the process water becomes the sixth treated process water after the sixth extraction stage.

In some preferred embodiments, the extraction stage can be arranged in a counter-current configuration (FIGS. 25 to 26) or a co-current configuration (FIG. 27). To speed up the initial phase separation, the co-current configuration is preferred.

After each extraction stage, the extractant phase becomes loaded with the ions removed or extracted from the process water. The loaded extractant phase then preferably undergoes two to ten stripping stages, preferably two to six stripping stages, to strip away (also called “remove”) the ions through an unstable emulsion (the second unstable emulsion) to become the regenerated extractant phase, which is then recycled back into the surge tank to be used to extract ions from the incoming process water. The stripped ions are stripped into the stripping aqueous solution (or “aqueous stripping solution”) in the stripping stage (or in the stripping chamber) so that the stripping aqueous solution becomes the ion-loaded aqueous solution containing concentrated ionic products (short as “the ion-loaded aqueous solution”).

The ratio between the extractant phase and the aqueous stripping solution is called the E/A ratio in the stripping stage. The E/A ratio in the stripping stage is preferably in the range of 3:1 to 1:6, more preferably 1:1 to 1:4, so that the emulsification in the mixing chamber is preferably minimized.

Two solutions are preferably used in the stripping stage: one is the first aqueous base solution for the stripping; the other is the second aqueous based solution for maintaining the pH of the unstable emulsion in the stripping stage. Another term for the first aqueous base solution is the aqueous stripping solution or the stripping solution. The first aqueous base solution is selected from a group consisting of aqueous carbonate solution; aqueous hydroxide solution; an aqueous solution of ionic bases selected from a group consisting of CO₃²⁻, HCO₃⁻, OH⁻, HS⁻ and S²⁻, wherein CO₃²⁻ is most preferred; other bases with a pKa value of >11; and a mixture thereof. CO₃²⁻ is the most preferred because it is most capable of displacing the P- and/or N-based ionic species in the process water so long as it is being kept in the CO₃²⁻ form by the second aqueous base solution (by raising the pH to be at or above pH 11). HCO₃⁻ is preferred to remove N-based nutrient, or to remove P- and/or N-based nutrient in combination with OH⁻ group.

The second aqueous base solution is a highly basic solution used to maintain the high equilibrium pH of the unstable emulsion (at or above pH 11, preferably pH 13-14), through which the ions from the loaded extraction phase can be stripped into the stripping solution or into the mixture of the stripping solution and the second aqueous base solution. Preferably, the second aqueous base solution is selected from a group consisting of potassium hydroxide, sodium hydroxide, milk of lime, or other Oft basic solutions, or a mixture thereof.

In some embodiments of the invention, when the process water is too viscous or contains too much solid waste, it is preferred that the aqueous process water is diluted with a second aqueous solution prior to the mixing step of the extraction stage. The preferred ratio for dilution is 2:1 to 1:2, more preferably 1:1. The second aqueous phase includes water, deionized water, process water, cistern water, city water, surface water, well water, process product water, or a mixture thereof. Alternatively, or in combination with the dilution, the process water further undergoes a step of removing solid particulates prior to the mixing step of the extraction stage.

In some further embodiments, after the stripping stage, the ion-loaded aqueous phase is further treated by one or more of an oil/water separator, a solid/liquid separator, a sorbent for odor removal, or a mixture thereof, wherein one or more aqueous ion concentrate products are obtained.

According to some embodiments of the invention, ammonium ions, such as ammonia vapor, can be removed from the step of the extractant stage, in which the extractant phase is mixing with the process water. Then, the removed ammonium ions are recovered as concentrated ammonium products, such as ammonia liquid, aqueous ammonia solution, or ammonium ions.

According to some further embodiments, the stripped or regenerated extractant phase is washed with a third aqueous solution to obtain a washed ion-stripped extractant phase reduced in one or more water soluble ions, preferable reduced in entrained water soluble ions. The washed ion-stripped extractant phase is then recycled back to the mixing step of the extraction stage to be used to treat the process water. The third aqueous solution includes water, deionized water, process water, cistern water, city water, surface water, well water, process product water, or a mixture thereof.

According to some embodiments of the present invention, the method can be used to treat the process water with a phosphate concentration in a range of about 3 ppm to about 15 ppm.

According to some embodiments, the phosphate ion concentration in the treated process water is reduced to a range of about 50 ppb to about 200 ppb.

According to some embodiments, the polyphosphate concentration in the treated process water is reduced to a range of about 1 to 75 ppm.

According to some embodiments, the present invention is able to remove the pathogens and/or waste vapors from the process water. This pathogen and/or vapor removal is preferably accomplished simultaneously with the extraction or removal of the P- and/or N-based ionic species from the process water. Preferably, the removed pathogens include Listeria monocytogenes, Enterococcus coli, Salmonella spp., Mycobacterium paratuberculosis, fecal coliforms, Fecal Stretococci. Pathogens suitable for removal using the present invention can be bacteria, protozoans, and/or viruses. Protozoans can include Cryptosporidia parvum, and Giardia spp. Viruses include bovine virus, diarrhea virus, Coronavirus, and food and mouth disease virus.

### BRIEF DESCRIPTION OF THE DRAWINGS

FIG. 1 is a schematic diagram illustrating a presently preferred flow scheme according to one aspect of the invention for the liquid-liquid extraction (LLX) process portion of the invention, showing two strippers, S1 and S2.

FIG. 2 is a schematic diagram showing the general process involved in a broad embodiment of the invention.

FIG. 3 is a schematic diagram illustrating the extraction and stripping of the (HPO₄)²⁻ ions from the aqueous solution for one embodiment of the invention.

FIG. 4 is a schematic diagram illustrating an overall process flow scheme according to the LLX portion of one embodiment of the invention, showing six strippers, S1-S6.

FIG. 5 is a schematic diagram illustrating an ammonium recovery circuit process flow scheme according to one aspect of the invention for the LLX process portion.

FIG. 6 is a schematic drawing showing a side cutaway view of a typical extraction mixer, settler, and Y-connector overflow weir for the aqueous phase for one embodiment of the invention, including details of their uses in the LLX process portion of the invention.

FIG. 7A is a schematic drawing showing a top view of a U-shaped extraction mixer and settler for one embodiment of the invention.

FIG. 7B is a schematic drawing showing a side view of the U-shaped extraction mixer and settler for the embodiment of FIG. 7A.

FIG. 8 is a schematic drawing illustrating a cutaway side view of a typical stripper mixer and settler including a buffer next the mixer overflow weir to guide the flow of the loaded E-phase into the settler for one embodiment of the invention.

FIG. 9 is a schematic showing an end view and a side view of an auger that facilitates the removal of the solid precipitates from the extractant settler according to one aspect of the LLX process portion of the invention.

FIG. 10 is a schematic drawing of a scrubber unit that facilitates the removal and recovery of ammonium ions from the aqueous solution in the extractant mixer according to one aspect of the invention for the LLX process portion of the invention.

FIG. 11 is a schematic drawing, illustrating the washing process of the stripped extractant phase to remove entrained water soluble ions from the extractant phase according a further embodiment of the present invention.

FIG. 12 is a diagram illustrating the phosphate concentration in ppm (y-axis) for E1, E2, and S1 to S2 over the entire run time (x-axis) for Runs 1-2 of Example 5 using the LLX process of the present invention. The run time is presented in hours.

FIG. 13 is a diagram illustrating the phosphate concentration in ppm (y-axis) for strippers S1-S6 over the run times (x-axis) of Runs 1-2 of Example 5 using the LLX process of the present invention. The run time is presented in hours.

FIG. 14 is a diagram illustrating the extractor and stripper pH profiles (y-axis) over time (x-axis) for Runs 1 and 2 of Example 5.

FIG. 15 is a diagram illustrating the residual PO₄ level (y-axis) over time (x-axis) after the LLX extraction for Runs 3-5 of Example 5.

FIG. 16 is a diagram illustrating accumulation of PO₄ (y-axis) over time (x-axis) for stripper stages 1 and 2 of Runs 3-5 of Example 5. 1,000 mg/L PO₄ in the concentrate product was achieved.

FIG. 17 is a diagram illustrating E1, E2 and aqueous raffinate (Raffinate) phosphate concentration (y-axis) over time (x-axis) for Runs 3-5 of Example 5.

FIG. 18 is a diagram illustrating S1 & S2 PO₄ concentration (y-axis) over time (x-axis) for Run 7 of Example 5.

FIG. 19 is a diagram illustrating S3-S6 total orthophosphate (PO4) concentration (y-axis) over time (x-axis) for Run 7 of Example 5.

FIG. 20 is a diagram illustrating S1 phosphate concentration (y-axis) over time (x-axis) for Example 8.

FIG. 21 is a diagram illustrating aqueous raffinate (Raffinate) phosphate concentration (y-axis) over time (x-axis) for Example 8. The aqueous raffinate was the treated aqueous solution, and the phosphate level in the raffinate shows the residual PO₄ level after the LLX process treatment.

FIG. 22 is an IC Chromatogram of the treated AD process water or the AD raffinate, which was Dairy OEP AD process water after the LLX batch process treatment of Example 10, illustrating the concentration of various phosphate species in the treated AD process water or raffinate. The eluent's peak height of the AD raffinate in μs (y-axis) over the retention time in the IC column (x-axis) was shown.

FIG. 23 is an IC Chromatogram of the stripped product concentrate filtrate of Example 10, which was the phosphate concentrate product after Dairy OEP AD process water went through the LLX process of Example 10. The stripped product concentrate filtrate was processed according to the IC analysis procedure, and its eluent's peak height in μs (y-axis) over the retention time in the IC column (x-axis) was shown.

FIG. 24 is McCabe Thiele Plot of the Extraction Equilibrium Line and 3:1 E:A Ratio Operating Line for Example 18.

FIG. 25 is a flow schematic diagram of the continuous flow mixer-settler LLX unit configured for the continuous extraction and stripping verification run—Test Run #1 of Example 19, in which the AD process water and the extractant phase were fed counter-current to the two extraction stages—the extractant phase was fed into the mixing chamber of E2 (the second extraction stage), while the AD process water was fed into the mixing chamber of E1 (the first extraction stage).

FIG. 26 is a flow schematic diagram of the continuous flow mixer-settler LLX unit configured for the Test Run #2 of Example 19—the KOH pretreatment test, in which the AD process water and the extractant phase were fed counter-current to the two extraction stages.

FIG. 27 is a flow schematic diagram of the continuous flow mixer-settler LLX unit configured for the Test Run #3 of Example 19—the phase Disengagement and Product Concentration Run, in which the AD process water and the extractant phase were fed co-current to the two extraction stages—the AD process water and the extractant phase were both fed to the mixing chamber of E1.

### DETAILED DESCRIPTION OF THE INVENTION AND BEST MODE

Broadly, this invention provides a means to treat a process water in a unique manner by first using an extractant phase (E-phase) liquid-liquid extraction (LLX) process to remove one or more ionic species simultaneously from an aqueous solution. Then one or more aqueous base solutions are used to strip or remove the extracted ionic species from the extractant phase, producing useful concentrated ionic products, such as phosphate ion/salt products, and/or bi-products of phosphate/nitrate. Optionally, the present invention also provides a method to remove ammonium ions from the same aqueous stream.

In the application, all percentages are by weight unless otherwise designated.

### Types of Process Water Suitable for Treatment by the Present Invention

The present invention is especially interested in treating nutrient rich process water mostly from agriculture uses (“process water”), such as aqueous process streams derived from farming, especially livestock farming (such as dairy, swine, fowl, beef, sheep, and the like), anaerobic digestion water effluent (referred to as “AD effluents” or “AD process water”), or other similar process water with P- and/or N-ionic species. The process water of the greatest flow and content value is derived from concentrated animal feeding operations (CAFOs), and the like.

These washings, drainages and associated ground and surface waters contain problematic macronutrients, especially phosphorus (P) and nitrogen (N), including both organic and inorganic forms. P and N nutrients are powerful stimulants of algal and bacterial growth that far exceed natural waters' ability to handle it, resulting in deoxygenated zones (“anoxic” zones) that are lethal to aquatic fish, and moreover, generate highly toxic myocystins.

As such, the P- and N-based nutrients lead to the extensive accumulation of algae and bacteria in ponds, lakes, and rivers, which extends to large lakes, such as Lake Erie, gulfs, like the Gulf of Mexico, and bays, like Pamlico Sound (all in the USA but equivalent water bodies can be found worldwide).

For purposes of the present invention, nutrient rich process water (also called “Process Water”) refers to farm lagoon discharge water (“farm water”), barn flush water, industrial or agricultural runoff or stormwaters, anaerobic digester effluent process waters (“AD process water” or “AD effluent”), other aqueous solutions (such as aqueous feed solution, aqueous feed, water feed, or surrogate water) or other process waters that contain P- and/or N-based nutrient species. In other words, the term “aqueous phase,” “aqueous feed solution,” “aqueous feed,” “aqueous solution,” “aqueous inflow feed,” “water feed,” “feed water,” “AD effluent,” “farm water” or “AD water feed” refers to a type of the process waters that are suitable for the present water treatment process. The term “feed” refers to the flow rate of the incoming stream of solutions, such as the extractant phase or the process water. Sometimes, to provide a better contrast to the extractant phase or to describe the phase separation better among other reasons, the process water and/or the treated process water is referred as the aqueous phase in the application.

### Types of Nutrients and Pollutants Suitable for Removal by the Present Invention

The most important feature of the current invention is its ability to remove all forms of phosphate ions from process water. It includes the orthophosphate (P-(o-PO₄)); many different types of polyphosphate (P-(poly-PO₄)); and “organic” phosphates (P-(organo-PO₄)). “Organic” phosphate refers to bio-organic phosphates, such as ADP, soluble phospholipid fragments, ATP, ADP, AMP, DNA, cell wall material, phosphate saccharides, phosphate carboxylates, and other hydrolysable phosphate esters. All mentioned above forms of phosphates can be collectively referred as total phosphate (P—PO₄ (total)).

As is known in the art, the phosphate ions are very difficult to remove from water since they are generally negatively charged ions and highly water soluble. As such, these poly-phosphate and bio-phosphate ions are especially resistant to being extracted into a hydrophobic media. However, the present LLX process was shown to be unexpectedly capable of removing essentially all of the orthophosphate ions, including poly-phosphate and/or bio-phosphate. While not wishing to be bound by theory, it is presently believed that such nanoscale ion species (phosphate/poly-phosphate) could be extracted by dissolution or by micro-colloid formation.

In the present invention, the extractant chemistry discovered for the role of the total phosphate removal includes a formulation containing an oil soluble quaternary amine, R₄N⁺, with the increasing of pH in the extraction and the stripping stages as a critical aspect of the invention. The use of quaternary ammonium LLX extractants for anion extraction is known in the prior art. However, prior art has indicated that increasing pH reduces the extraction efficiency, and that the E-phase needs to be buffered to prevent a decrease of the extraction efficiency. In the present invention, the E-phase does not need to be buffered, and actually, increasing pH increases the extraction efficiency by keeping the carbonate ions in the E-phase.

The present invention is capable of extracting numerous additional anions including nitrate, nitrite, phosphate, polyphosphate, biophosphate, phosphonate, organo-phosphate, including the protonated versions of these ions, including those protonated species that would render the ion neutral or of lesser charge or greater charge, and any combination or mixture of these.

Further, the present invention is capable of removing ammonium ions. Simultaneous, the present invention is capable of removing pathogens and/or waste vapors along with removing other ionic species, mostly P- and/or N-based ionic species. It is interesting to note that the present invention is capable of removing the trace amount of the phosphate, including orthophosphate or polyphosphate (such as in the range of about 1 mg/L to about 75 mg/L), and the phosphate level in the treated process water can be reduced to about 50 to about 200 ppb.

### Optional or Preferred Solid Separation Pretreatment

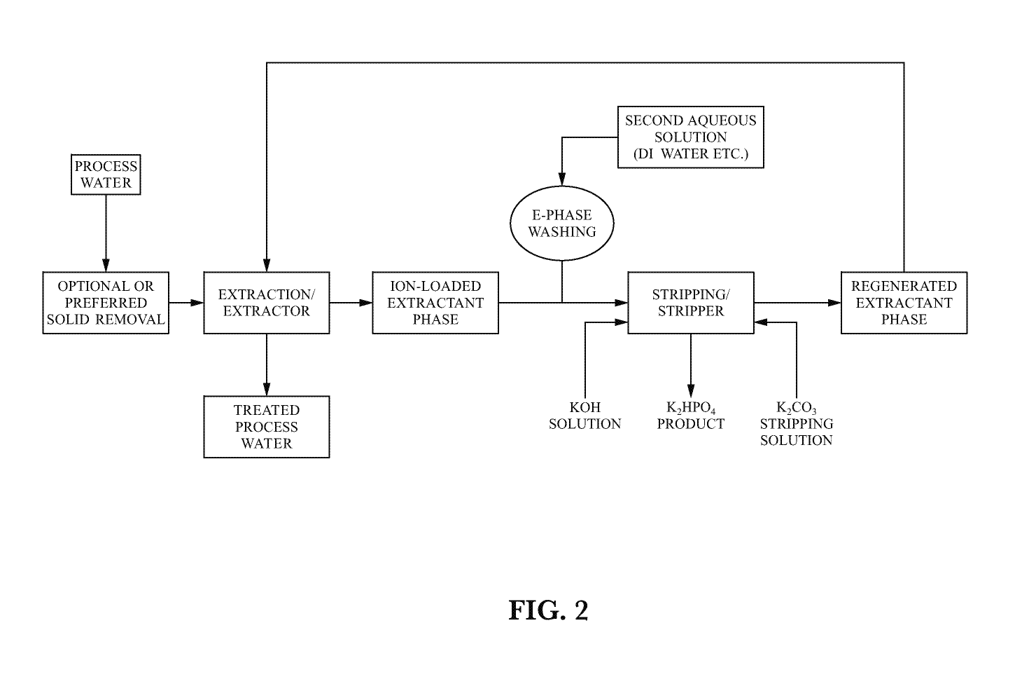

Process water, such as farm process water, typically contains waste solids, such as small particulates of animal feed wastes (manure, undigested grains and cellulosic matter, bedding straws, floor dust and debris, and the like). Therefore, it is desirable (for certain types of the process water, this process is optional) to filter the process water (FIG. 2). This is a desirable process since it prevents clogging of the system from undigested particulates, which are either undigested by the farm livestock or by the AD Process micro-organisms, or both. The filtration process can also reduce excess emulsion formation by such solids during the extraction stage. Traditional solid/liquid separators can be used, such as a hydrocyclone, screw, filter, or belt presses, one or more particulate filters hooked in series, and/or a coagulation/floculation process with settling and clarification, with or without the use of inorganic, organic, or inorganic and organic, coagulants and floculents.

Most preferred process is to first filter out any suspended solids by conventional solids/liquid separation technologies. Conventional S/L separation technologies include filtration, membranes, centrifugation, hydrocyclone, gravity settling, and the like. Filtrations can be micro, nano, ultra, belt, plug flow or cross-current or co-current, and the like.

Preferably, the filtration can remove particulate matters with preferably <10 μm filter, or more preferably with a <0.2 μm filter. The filtration with the 100 micron to 25 micron filter also sterilizes the clarified process water by removing many bacteria, yeast and algae from the nutrient rich process water.

Alternatively, or in combination with the filtration, the process water can be first diluted with water or other similar aqueous solution, such as deionized water, process water, cistern water, city water, surface water, well water, process product water, or a mixture thereof. The preferred dilution ratio is 2:1 to 1:2, more preferably is 1:1.

### Extractant Composition and Structure

Effective active extractant compounds of the invention are all sufficiently hydrophobic so as to have essentially no aqueous solubility, nonflammable, and very oil-soluble in both aliphatic and/or aromatic solvents. Having essentially no aqueous solubility can include low or minimum aqueous solubility. Suitable extractants are those with a total carbon number of at least eight (8), but preferably about 16 to 18, with at least minor branching, and most preferably about 25 with at least minor branching. Carbon numbers up to about 40 are still effective. The extractant can be a pure compound or a blend of molecular weights and structures. The extractant can have additional functional groups such as halogens, ether linkages, ester linkages, aromatic groups, be linear or branched, blends of these, and the like, so long as the extraction chemistry and the oil solubility of the reagent is not adversely affected. Branched or extensive tripodal structure is desired since it discourages gelation and solidification throughout the process load, strip and storage cycle.

Preferably, the positively charged extractant component comprises a quaternary ammonium or phosphonium compound selected from the group consisting of R₄N⁺, R₄P⁺, an alkylated monoguanadinium compound, and a mixture thereof; where the R groups may differ and are a hydrocarbon consisting of alkyl groups, aryl groups, alkylaryl groups, any combination of these, including atoms of other elements such as N, P, O, X and S, where “X” is halogen or pseudohalogen, so that the water solubility is not significantly increased or the monocationic charge for the whole molecule is not changed, and the charge does not change with pH up until a pH of about 11, and where the minimum carbon number (CN) is >8, preferably >17, and more preferably >24, and most preferably where at least one alkyl group in the molecule is branched, and wherein the anionic base is selected from the group consisting of CO₃²⁻, HCO₃⁻, OH⁻, HS⁻, S²⁻, and a mixture thereof.

The most preferred extractant compound is an oil soluble quaternary ammonium compound, comprising R₄N⁺ of 25 carbon number, especially N-methyl N,N,N-tri(octyl)ammonium ion. It is available commercially as Aliquat® 336 or Aliquot® 134 from Cognis, Inc.

Other extractants can also be effective, and a list of effective extractant structures is summarized in Table A. They can be used neat if their corresponding bicarbonate/carbonate/biphosphate or phosphate ion forms are sufficiently fluid at short mixing and settling times can be achieved.

Note that the prior art teaches that all such insoluble salt composition systems will form solids which precipitate within conventional LLX hardware requiring process hardware shutdown, solids removal, repair of damaged equipment and other maintenance. The current invention avoids this serious problem. If enhanced fluidity is needed, as is normally the case, then one or more of the quaternary extraction compounds are blended with a predominantly hydrocarbon diluent of eight or more carbon atoms.

Suitable diluents are included in Table A. Also included in Table A are candidate “modifiers” that can be added to the extraction formulation that can aid in displacing entrained water in the extractant phase carrying anions, such as phosphate ions. Modifier can also help the unstable emulsion in the extractor solubilize in the hydrocarbon diluent, resulting in faster phase disengagement into two liquid phases: loaded E-phase and the treated (purified) aqueous phase. Suitable modifiers are water-immiscible terminal aliphatic alcohols or mixtures thereof.

Suitable diluents can be water-immiscible aliphatic, aromatic solvents or blends of such solvents. Preferred diluents are alcohols that are classified nonflammable (flash point>140° F.), nonhalogenated, low-odor, aliphatic, either linear or branched, with a carbon number of 8-16, most preferably 9-13, or mixtures thereof. Specific examples are given in Table A.

Most preferred are solvents that are classified nonflammable (flash point>140° F.), non-halogenated (to avoid environmental release issues), low-odor, aliphatic, aromatic, or a blend of aliphatic and aromatic solvents such as are petroleum distillates, though synthetic hydrocarbons are also functional. Preferably, for odor control and/or other purposes, the aromatic concentration should be at 1 vol % or less, and the density is less than 0.80 g/cc (about 6.7 lb/gal). However, the density can rise to 0.82-0.85 g/cc with high use levels of modifier (measured on the stripped E-phase). The aliphatic diluent(s) can be linear but are preferably branched with one or more very short branches (one carbon or a few) to maintain a very low viscosity, even when loaded with the phosphate and nitrate species. The aromatic diluent(s) can be un-substituted aromatic liquids but are preferably aliphatically-substituted aromatic liquid compounds. Extractant mixtures suitable for the invention contain at least 25% diluent (v/v), preferably 60% (v/v), and most preferably 85% (v/v). For applications with a relatively low total phosphate concentration in the pre-treated water, such as CAFO recirculated barn flush water, then 99.5% diluent is preferred.

In order to extract phosphate ions from the process water, especially when the phosphate ions are presented in “organo phosphates”, polyphosphates, ortho-phosphates, and/or bio-phosphate forms, the concentration of the active extractant needs to be adjusted. For example, when a farm lagoon water with about 100 ppm phosphate ion is being treated, a lower concentration of the active extractant (0.6% Aliquat 336) should be used. When treating a process water with a high concentration of polyphosphate, for example hundreds to thousands of ppm total phosphate, a higher concentration of the active extractant (9% Aliquat 336) should be used.

TABLE A
Typical Compounds Useful for the Extractant Phase

| Extractant | Chemical Class (used | | | |
|---|---|---|---|---|
| Formulation | alone or in combination | | | Level of |
| Component | with any other extractant) | Specific Compounds | | Preference |
| Extractant | Quaternary | N-methyl tri-(n- | | Most preferred |
| | Amines | octyl)ammonium ion | | |
| | | N-methyl tri-(n- | | Most preferred |
| | | decyl)ammonium ion | | |
| | | N-methyl tri-(n- | | Most preferred |
| | | dodecyl)ammonium ion | | |
| | | Aliquat ® 134 | | Most preferred |
| | | Aliquat ® 336 | | Most preferred |
| | | Tri-octyl methylammonium ions | | Most preferred |
| | | Mixture of tridecyl- and trioctyl- | | Most preferred |
| | | methylammonium ions | | |
| | | HOE S 2706 | | Most preferred |
| | | Adogen ® 464 | | Most preferred |
| | | Tri(C₈-C₁₀) methylammonium ions | | Most preferred |
| | | R¹R²R³N⁺CH³ | R¹═R²═ R³═CH₃(CH₂)₉— | Most preferred |
| | | | R¹═R²═R³═CH₃(CH₂)₇— | Most preferred |
| | | | and | |
| | | | R¹═R²═R³═CH₃(CH₂)₉— | Most preferred |

| | | | |
|---|---|---|---|
| | | Blends of the above quaternary | Most preferred |
| | | ammonium ions in any proportion | |
| | Mono | e.g. LIX-79 ® | Most preferred |
| | guanadinium | | |
| | Quaternary | N-methyl tri(n-octyl) phosphonium | Functional |
| | phosphonium | | |
| Modifier | b-isodecanol | | Most preferred |
| | (or decyl | | |
| | alcohol, or | | |
| | Exxal ® 10) | | |
| | Isotridecanol | | Most preferred |
| | (or b- | | |
| | Tridecyl | | |
| | alcohol | | |
| | Nonyl phenol | Aromatic | Functional |
| | Dodecyl phenol | Aromatic | Functional |
| Diluent | Aromatic ® 150 | | Functional |
| | Aromatic ® 200 | | Functional |
| | Calumet ® 400-500 | | Most Preferred |
| | Conoco ® 170 | | Preferred |
| | Isopar ® M | | Preferred |

### Optional Pretreatments of Extractant Phase

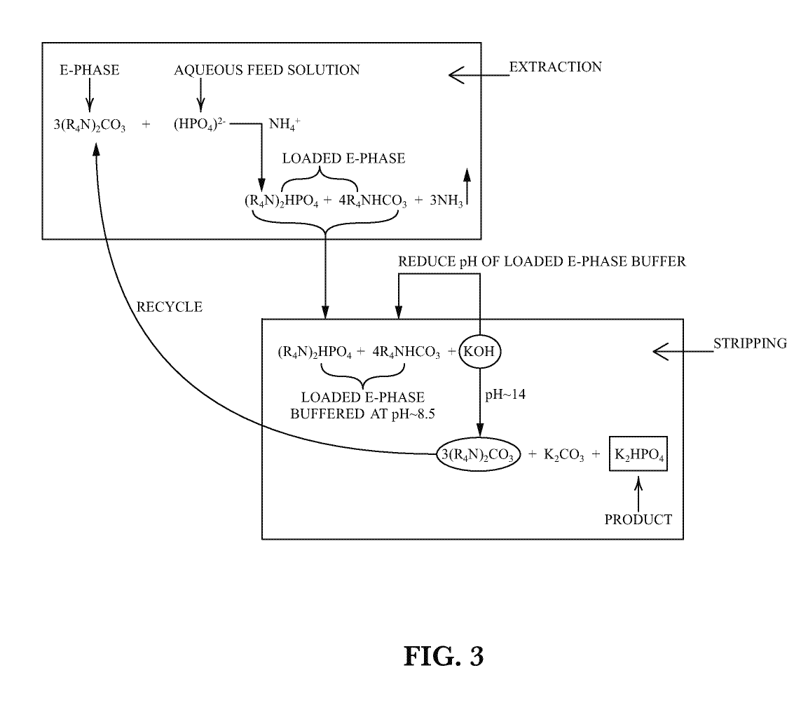

First, an E-phase is optionally pretreated with a CO₃²⁻ solution to become an E-phase with a carbonate anion (as shown in Eq. 1 in FIG. 3). The preferred CO₃²⁻ solution is 8% K₂CO₃. Preferably, this optional pretreatment is carried out in the strippers of the LLX unit with the extractors disconnected. This carbonation treatment not only puts the E-phase in its carbonate form, but also takes the Cl⁻ ion contamination off the E-phase by replacing Cl⁻ ions, typical contaminants from the supplied source, with the carbonate ions. A mixed liquid phase pH titration method can be used to verify the level of carbonation on the E-phase, and the relative fraction of the extractant loaded as its carbonate or bicarbonate form.

Further, the carbonate loaded E-phase preferably undergoes an optional water washing treatment, in which it is washed with the DI water to take off excess water soluble CO₃²⁻ ions and other organic impurities, especially the counter ion cation (normally K⁺ or Na⁺). The typical E/A ratio used for this washing treatment is 2:1 or lower. The washed carbonate loaded E-phase can be further treated with more carbonate solutions, if needed, to remove more organic impurities from the E-phase.

Removal of organic impurities from the E-phase is very helpful to enable the LLX of the present invention to remove the ionic species from the process water effectively and efficiently. The “organic phase” impurities in the E-phase should be kept low enough to ensure that they do not interfere with the goal of achieving the target level of water purification in the Extractor(s) circuit. The impurities in the E-phase can come from the supplier and from the LLX process as the E-phase recycled from the stripper back to the extractor.

When the E-phase is mixed with the aqueous process water containing the phosphate and/or nitrate/ammonia ions, an unstable emulsion forms as the result of mixing and extracting the process water with the E-phase, during which time the phosphate ions and other ions if present are extracted from the process water into the E-phase. Then the unstable emulsion proceeds to a settler container, or the equivalent, to be disengaged into a loaded E-phase and a treated aqueous phase, which is separated by a interface.

For a more effective extraction process, the interface of the two phases is preferably clear. In some cases, the interface can contain a layer of residual or tertiary emulsion, which can be either breaking into separate phases or are stable. While not wishing to be bound by theory, it is presently believed that the impurities in the E-phase might be contributing to the build-up of this layer of residual or tertiary emulsion. This layer of residual emulsion can grow slowly over time due to the build-up of the impurities from the incoming E-phase (either fresh or recycled). If the residual emulsion layer has grown into a relatively thick layer, it can be easily swept from the unit during a maintenance cycle.

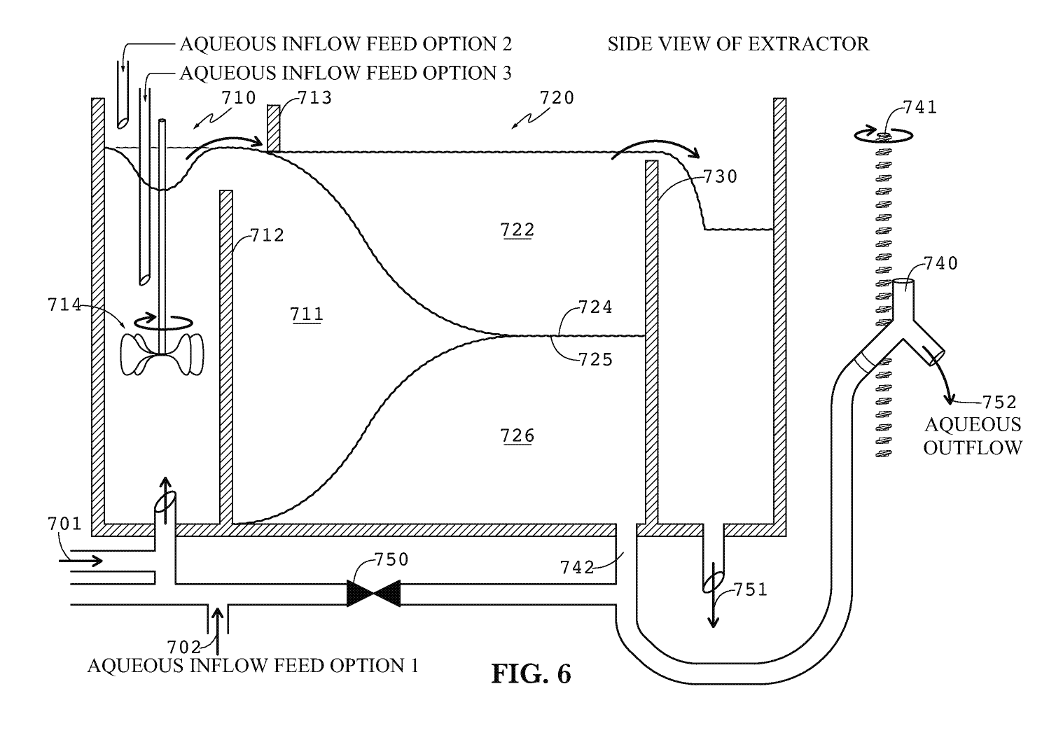

While not wishing to be bound by theory, it is presently believed that these impurities in the E-phase interact with the ions in the process water during the extraction mixing so as to become a part of unstable emulsion, and then remain in a stable emulsion band at the interface between the separated E-phase and the aqueous phase (see FIG. 6). As such, if the impurities build up during the LLX operation the present invention, it can create backflow problems associated with excess unstable and/or stable emulsion.

### Description of the Extraction Process of the Present Invention

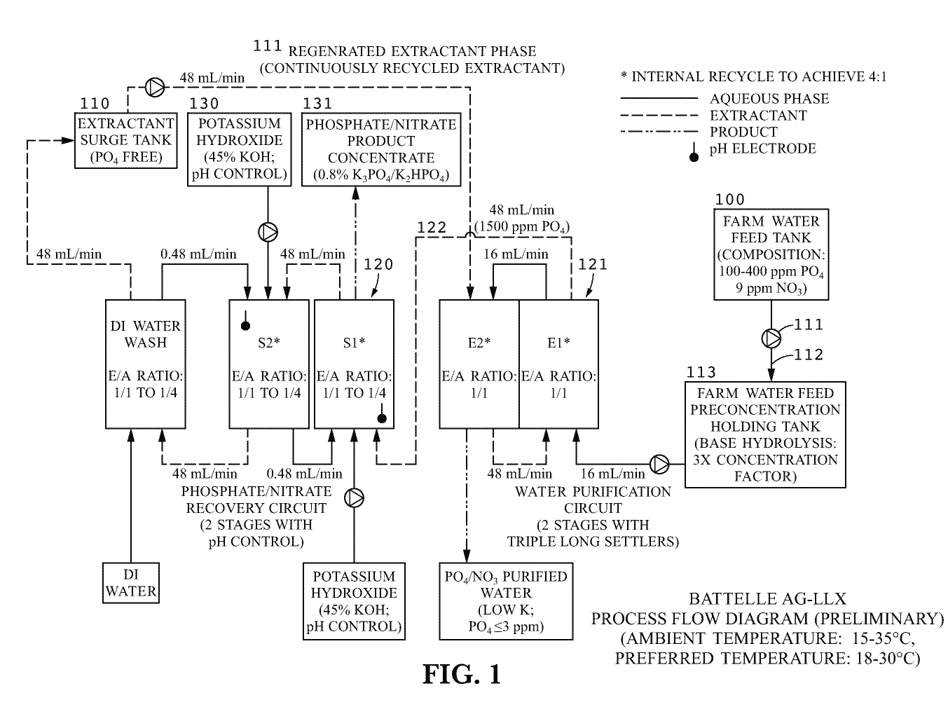

One embodiment describing the invention is the general process flow diagram (FIG. 1) using the term “farm water” as a type of the process water to be treated by the LLX process of the present invention. The first step involves treatment of the farm water stream 100 (hereafter referred to as the “process water” or “process water stream”) with a particular Aliquat 336-based extractant phase formulation 110. The preferred pH range for the extractant phase is 4 to 13, more preferably 5-12, and most preferably 6-11. The preferred pH range for surrogate process water, such as surrogate farm lagoon water (about 100 ppm phosphate) is about pH 7 to about pH 11. The preferred pH range for the AD process water is from about pH 5 to about pH 12.

The process water stream can go through two or more extraction stages. The extraction stages can be configured entirely counter-current, or cross-current where one or more phosphate-stripped (regenerated) extractant phases (see below) are blended with the process water as it flows serially through two or more stages, or co-current flow, cross-flow, or a combination of these flow configurations.

Two extraction stages have been shown to be sufficient to extract >90% phosphate from the farm water (the process water) using an E/A ratio of 3/1 or above (E refers the extractant phase, while A refers to the process water, which is an aqueous phase). Other E/A ratios for the extraction stage in the range of 4:1 to 1:4, preferably 3:1 to 1:3, more preferably 2:1 to 1:2, can also be used, depending on the type of the process water. If a lower phosphate concentration in the resulting treated water is required, or if the process water contains a much higher level of phosphate ions, a higher number of extraction stages may be required, and thus the LLX process may include 2 or more extraction stages, up to possibly 15 to 20 extraction stages to achieve the required low concentration of phosphate in the treated process water.

If two extraction stages are used, each extraction stage contains a mixer and settler, and each is arranged counter-current or cross-current to the other. If four extraction stages are used, the most preferred configuration is to operate the extractors with the four stages separated into two sets of at least two mixer settlers each, where each set is arranged counter-current with its partner, and each set internally is piped up to be counter-current, but the two sets are configured cross-current flow with respect to each other where the extractant phase is the crossing phase and the aqueous phase is piped to flow serially from stage to stage across the first set and then across the second set, and then if present, across the third set, and so on. However, other combinations are easily arranged and tested since piping changes are readily made as is already appreciated in the current art of liquid-liquid extraction technology using staged devices such as mixer-settlers, centrifuges, columns, in-line static mixers, and the like and any combination of these.

A general flow diagram of the LLX process is illustrated in FIG. 2. First, the process water (the aqueous phase) undergoes an optional solid removal preferably through a hydrocylone, centrifuge and/or filtration process, resulting in a low total suspended solids (TSS) “clarified” process water that is more suitable for the LLX process. Without the optional solid removal process, such solids would accumulate in the LLX contacting settler and therefore require periodic removal. This pre-LLX clarification is optional because the LLX operation can operate with solids accumulation ongoing, but dense solids do need to be physically removed, e.g. by rakes, screens, emptying and scrapings, augering, etc. Alternatively, or in combination with solid removal, the process water is diluted with water first. The clarified or diluted process water then flows through the liquid-liquid extraction operation. During the extraction operation where the E-phase is mixed with the clarified or diluted process water, one or more anionic species from the clarified process water are extracted from the process water into the E-phase by forming an unstable emulsion. Preferably, the extracted ion species are P- and/or N-based ionic species, such as phosphate and nitrate ions, more preferably phosphate ions. Typically, the equilibrium pH of the unstable emulsion in the extraction stage is about 5 to 12 depending on desired E to A (or E/A) flow ratio, and ionic components for removal.

Due to the special E-phase formulation, this emulsion separates into two phases within a relatively short period of time: an anion-loaded E-phase and a treated process water (also called an aqueous raffinate or just raffinate, or called treated aqueous phase). The relative time for phase separation is dependent on the type of the process water (for example, nutrient concentration and/or viscosity of the process water). It also depends on the E/A ratio along with the mixing method. The suitable length of time is in the range of 0 or a few seconds to 50 minutes, preferably 10 to 45 minutes, more preferably 10 to 30 minutes. Other time ranges can also be used depending on the mixing method.

This treated process water for the first extraction stage is often referred to as the first treated process water to distinguish it from the aqueous phases or solutions from other steps, such as the stripping step and the E-phase washing step.

The loaded E-phase and the treated process water (aqueous phase) are at least partially disengaged from the unstable emulsion by gravity separation, optionally sped up through cetrifugation and/or use with a hydrocyclone, or optionally sped up through the use of coalesce agents, such as oil soluble alcohols, such as decyl alcohol or tridecyl alcohol, preferrably the branched versions (available commercially as Exxal® 10 or Exxal® 13.

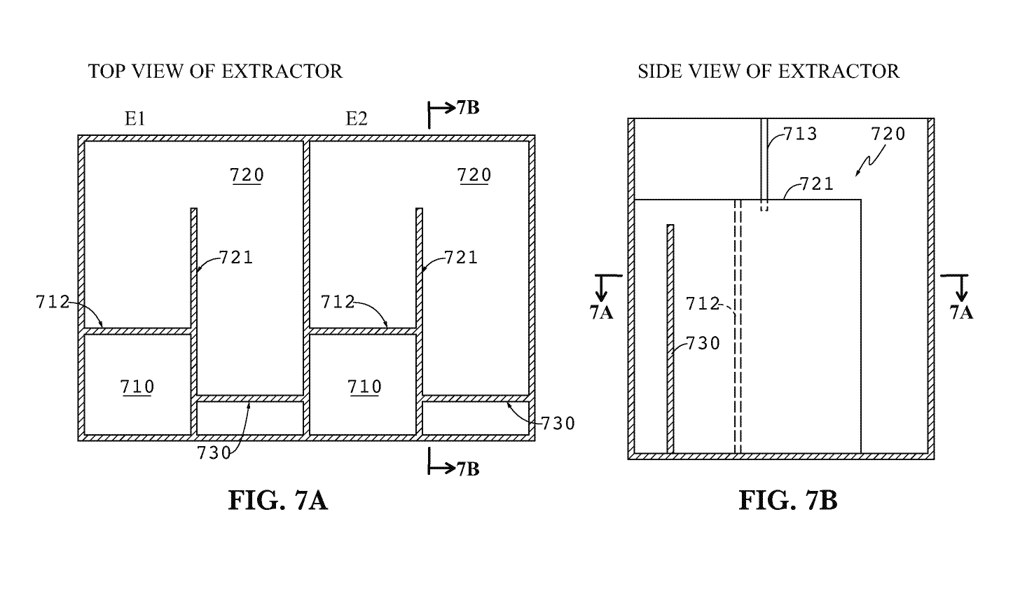

Once disengaged, the loaded E-phase can be separated by using a standard weir design, or an optional skimming weir design if the unstable emulsion does not fully coalesce into two phases within the residence time provided by the settler. However, it is more preferred to increase the residence time by increasing the length and/or depth of the settler, or changing the shape of the settler to a U-shape so that the residence can be increased without increasing footprint of the unit excessively (shown in FIG. 7A). The footprint of the unit refers to the space that the LLX unit occupies on the bench top of the laboratory.

The extraction phase to aqueous phase ratio (E/A) is typically about 1:4 to about 4:1 in the extraction circuit, preferably about 3:1 to 1:3. Although E/A ratio of 4:1 or above are very effective too, but the higher ratios require an enlargement of the apparatus size to accommodate the higher flow rate of E-phase for a particular aqueous phase flow rate. The extractant concentration in the E-phase needs to be at least 0.1%, can be neat (100%), more preferably 0.5 to 15%, and most preferably 6-9.1%. The percentage amount and the strength of the unstable emulsion and its subsequent phase disengagement are influenced by the concentration of the active extractant and modifier in the extractant phase.

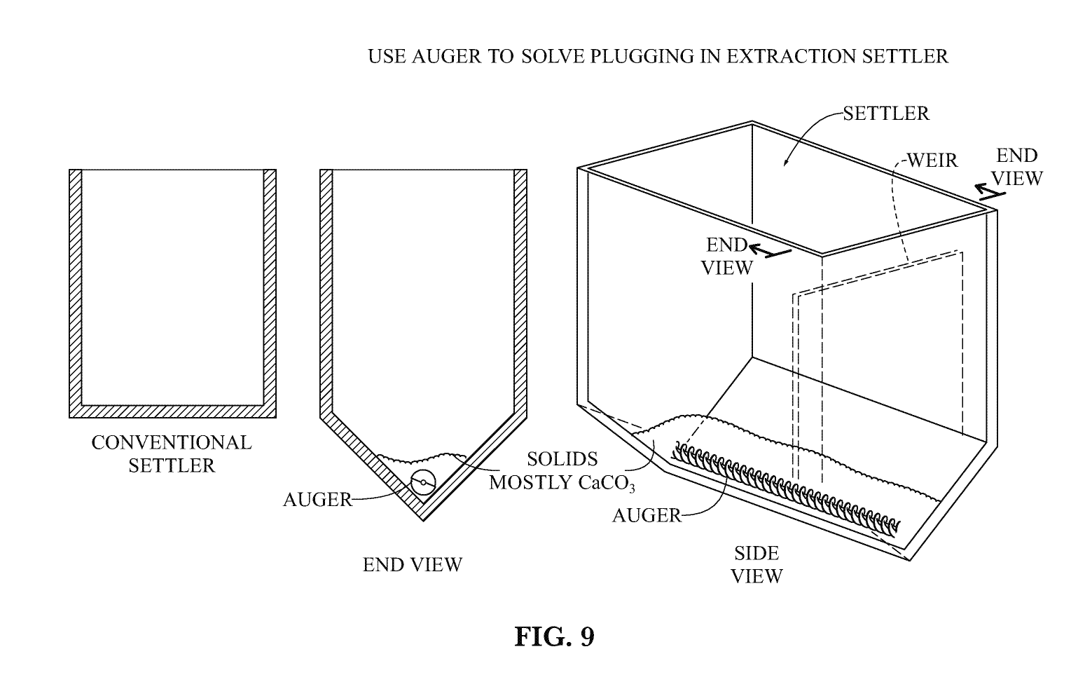

In a further embodiment, according to FIG. 9, one or more extractant phase (E-Phase) washing using water or aqueous solution can be used to remove any entrained water soluble ions, especially those of nutritive, valuable and/or costly nature, such as potassium ion, from the stripped extractant phase during the process of the present invention.

According to some embodiments of the present invention, the hydroxide ion (OH⁻), carbonate ion (CO₃⁻), carbonic acid (H₂CO₃) and/or bicarbonate ion (HCO₃⁻) form of the quaternary ammonium extractant is preferred, with the most preferred form being carbonated form of the quaternary ammonium extractant. It is important that the quaternary amine does not require protonation to possess a positive charge and is positively charged over the entire pH range. In this manner the strong base options of carbonate ion and/or hydroxide ion can be used, which is very important for efficient stripping and continuous extraction in the LLX process. The process chemistry identification and selection are further developed below to explain the fundamental separation process chemistry and the proposed mechanism of action.

Extractor Configuration to Maximize Extraction or Removal of Phosphate Ions from the Process Water

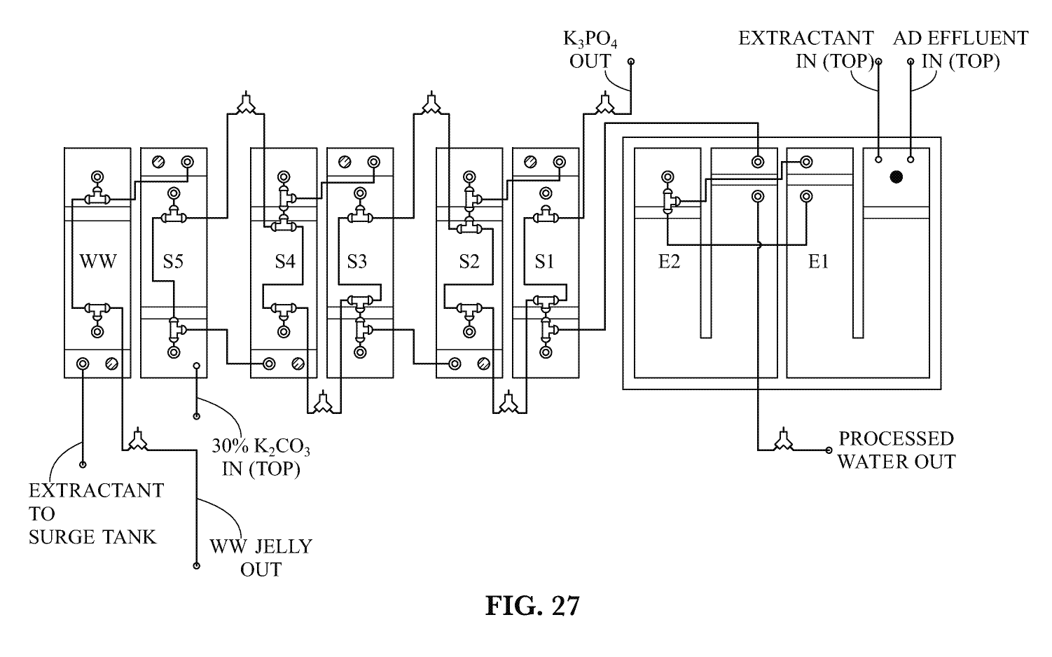

A broadly applicable version of the invention is given in FIGS. 1, 4, 25, 26, and 27, with FIG. 27 being the most preferred version. This water treatment process provides new and useful process chemistry, water treatment devices, and methods.

The major features of the invention, the operation of which is detailed in the examples below, include a novel emulsion liquid-liquid extraction device that possesses a unique design for emulsion handling hardware in the settler to enable sufficient phase disengagement. The method produces unstable emulsions necessary for the extraction or stripping of ionic species. Such emulsion rapidly shutdown conventional and other prior art liquid-liquid extraction apparatus.

In one embodiment, this unique hardware consists of a U-shaped settler (FIGS. 7A-7B) fitted with honeycombs so as to provide a longer residence time for the unstable emulsion exiting the E-mixer to disengage into E-phase and aqueous phase.

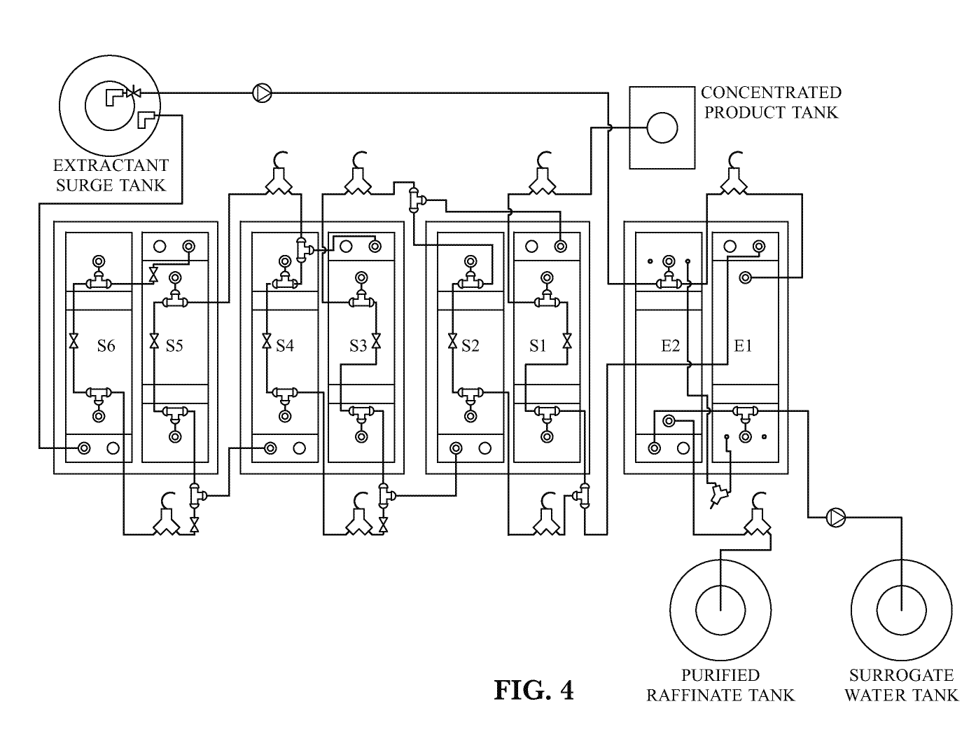

Referring to FIGS. 1 and 4, the detailed description of the invention is as follows. Farm water feed (also a type of process water, hereafter referred to as “process water” in the application) 100, containing anionic components (such as phosphate ions), is fed by gravity or by pump through valve 111 and line 112 to an optional process water feed preconcentration holding tank 113, which provides base hydrolysis to convert polyphosphate ions to orthophosphate ions. Then, the process water feed 100 is fed to one or more liquid-liquid extractors 121. The level of contamination, the degree of water treatment desired, and the desired ion concentrate in the products determine the number of such extractors deployed. A higher number of extraction stages leads to a lower concentration of phosphate in the resulting treated process water. Water purity needs to be less than 0.1 ppm phosphate/nitrate before it can be released back into environment without causing any pollution problem. As such, the LLX process of the present invention can include up to 15 to 20 extraction phases (preferably 2 to 10 extraction stages, more preferably 2 to 6 extraction stages) to achieve the desired low concentration of phosphate in the treated process water. Often, two extraction phases can be used if the initial phosphate concentration is low and/or the desired phosphate concentration in the process water does not need to be very low. Higher number of extraction stages is preferably used to reduce the phosphate concentration in the treated water to be in the range of about 50 ppb to 200 ppb.

The preferred arrangement of multiple extraction phases (extractors) is preferably co-current (FIG. 27), or counter-current or cross-current (FIGS. 1, 4, 5, 25 and 26). The process water 100 is contacted only for a short period of time in each extractor, 30 seconds to 30 minutes are effective, however, preferably only 30 to 200 seconds, and most preferably about 45 to 90 seconds, with the extraction phase (defined elsewhere in the application) supplied from tank 110 via pump and valve.

Referring now to FIGS. 1, 4, 25, 26 and 27, one embodiment includes two (2) extraction stages for phosphate co-extraction, and two (2) to six (6) stripping stages for phosphate stripping, extractant regeneration, and phosphate concentrate product generation. The overall process diagram using a combination of conventional and uniquely designed mixer-settler is shown in FIGS. 6-8. FIGS. 6-7B refer to the typical mixer-settler configurations for the extraction stages/operations (also called extractors).

The extractor E1 has a mixer 710 which receives the incoming water 702 via an aqueous line from the aqueous process water tank or process water feed preconcentration holding tank 113 (FIG. 1). In the E1-mixer, the process water is mixed with the extractant solution 701 (the extractant is loaded with carbonate base) from the extractant solution surge tank (co-current, see FIG. 27), or more preferably from the E2-settler via an extraction line and pump (counter-current, see FIGS. 1, 6, 25 & 26).

For the co-current configuration of the extraction stage, both the process water (“AD effluent” is a type of process water) and the E-phase are fed into the top of the mixer (the mixing chamber) of the extractor 1 (E1) (see FIG. 27). As shown by FIG. 27, during the extraction phase, the AD effluent (a type of the process water) and the extractant phase are introduced into the top of the mixer for E1, forming an unstable emulsion, in which some of the P- and/or N-based ionic species are removed from the process water into or onto the extractant phase, resulting in a first treated (or processed) process water and an ion-loaded extractant phase. Then the treated process water (aqueous phase) and the ion-loaded extractant phase (extractant phase) are disengaged and separated in the settler of E1. Thereafter, the treated process water and the loaded extractant phase flow to the mixer of E2 in two separate streams to undergo the second extraction stage: the treated process water and the loaded extractant phase are mixed to form a second unstable emulsion, in which at least a part of the remaining P- and/or N-based ionic species is removed from the process water into or onto the already ion-loaded extractant phase, resulting in the treated process water or processed water and the second ion-loaded extractant phase. The processed water then flow out to be collected in a treated water tank (not shown).

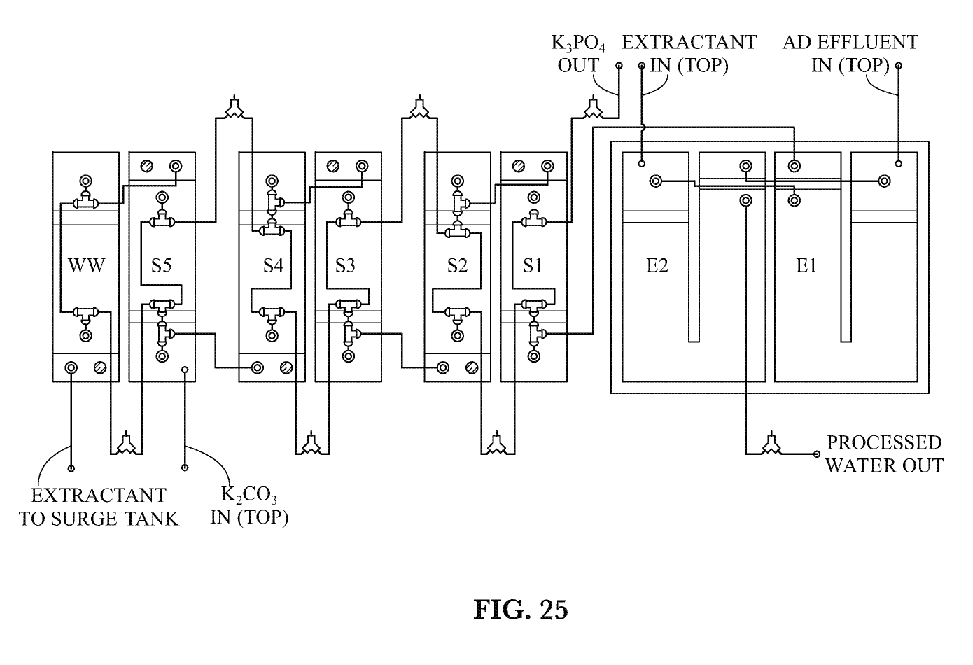

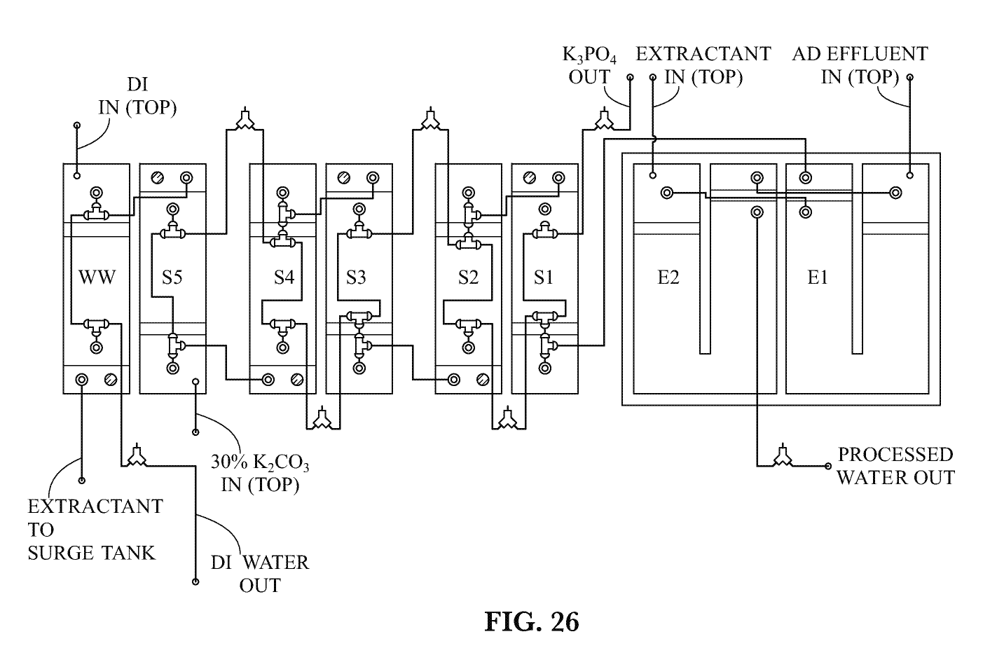

For the counter-current configuration, as shown in FIG. 1 (also see FIGS. 25 and 26), as illustrated below and elsewhere in more detail, the process water is fed from the process water feed tank into the mixer of E1, while the E-phase (extractant phase) is fed from E2 into the mixer of E1. That is, the regenerated and/or new E-phase goes to E2 first from the extractant surge tank (not shown in FIGS. 25 and 26), then proceed from E2 to E1, in a counter-current fashion to the flow of the process water, where the process water from the process water feed tank flows to E1 first and then to E2. This counter-current configuration is more desirable for higher extraction efficiency (higher amount of nutrients are extracted or removed), but it might not be as desirable for phase separation unless other conditions are adjusted to improve phase separation, such as increasing residence time or using G-force to separate phases (for more details about phase separation, see discussion below).

Preferably, an impeller 714, or other suitable mixing device, is used to mix the process water with the E-phase at a suitable speed in order to produce unstable emulsion, in which phosphate ions may be encapsulated in colloids by cationic oil soluble, active extractant (such as Aliquat 336) molecules. This capability of the LLX process was unexpected because highly charged ions, such as poly-phosphate, tend to be highly hydrated, and so they are highly resistant to being extracted into a hydrophobic liquid extractant media. While not wishing to be bound by theory, it is presently believed that such nanoscale ion species (phosphate/poly-phosphate) could be extracted by dissolution or by micro-colloid formation. Further, it is found that the LLX process is able to extract the organophosphate from inside of the bio-solids (or low solubility solids) of the farm water or process water (see Example 17).

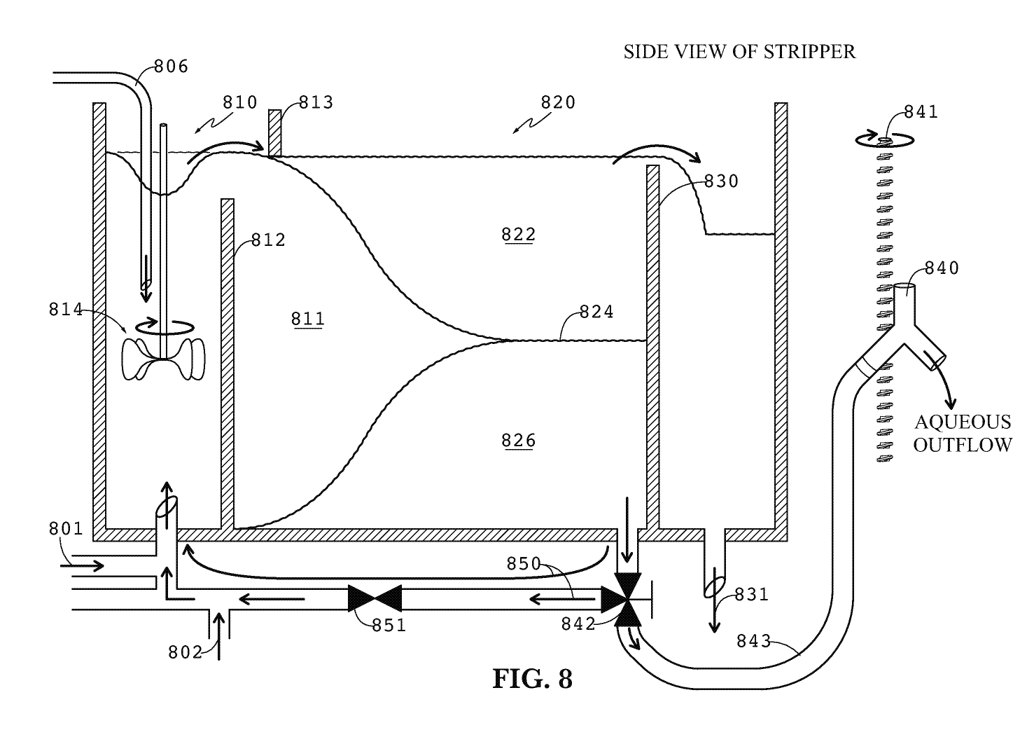

In some preferred embodiments, the mixer compartment includes a rotating mixer impeller, which has a tip with ridge grooves that create a suction, which pulls the process water 702 and the extractant phase 701 (E-phase) into the mixer compartment 710 where it mixes the process water 702 and the E-phase 701 thoroughly, and then dispel drops of the resulting mixture from the impeller tip. The mixture forms the newly formed unstable emulsion 711 in the mixer, which the mixing forces to flow over the top of the overflow weir 712 and under a buffer 713 (also called the underflow weir) into the settler compartment 720 of the extractor E1. The buffer 713 is typically positioned above and at a short distance away from the overflow weir 712 as shown in FIG. 8, so that it can guide the top of the flow of the emulsion 711 to enable the emulsion 711 to flow smoothly into the settler compartment 720. In the E1 settler compartment 720, the unstable emulsion 711 is allowed sufficient time to disengage into at least two phases (called “phase disengagement” or “phase separation”): the E-phase 722, which is allowed to separate into the top of the settler; and the aqueous phase 726 (the first treated process water), which is settled into the bottom, with an interface 725 clearly separating the two phases.

The settler compartment 720 is preferably constructed to provide a sufficient long residence time to allow for this phase disengagement, preferably within 50 minutes, more preferably within about 40 minutes. For faster phase disengagement, a centrifuge may replace the settler compartment, in which case the preferred residence time is about 5 seconds to 6 minutes or so. The impeller's speed is preferably in the range of about 700 to 1,800 RPM for 1 inch impeller diameter, more preferably in the range of about 700 to about 1300 RPM.

The solids or precipitates in the slurry or unstable emulsion 711 are given time to settle into the bottom of the settler, which can contain an optional auger (see FIG. 9) to prevent plugging of the E-settler 720. The settler compartment 720, thus, includes at least one E-phase overflow weir, and an optional auger. The overflow or underflow weir used in the extraction process is typically a standard weir, which is commonly used to separate one phase from another or to separate solid precipitation from the liquid.

At the end of the extractor settler compartment 720, there is an optional overflow weir 730 that facilitates the loaded extractant movement. In LLX, a weir might not be needed but is helpful and preferred, especially in case the emulsion does not coalesce into two types of the liquid within the residence time provided by the settler. The treated aqueous phase outflow movement is guided and adjusted by the Y-connector overflow off weir 740 (short as Y o/f or Y-connector) through an aqueous line outflow line 742. If the Y-connector's position is raised higher, the aqueous outflow rate is lowered, allowing more aqueous phase to be accumulated in the settler chamber. The position of the Y-connector 740 can be adjusted preferably by attaching the Y-connector to a screw stepper 741 at the back of the extractor (other configurations can also be used). The screw stepper 741 is formed of screws attaching to the back of the equipment in an ascending order, which provides a ladder configuration for adjusting the position or height of the Y-connector 740. Other means of adjusting the position of Y-connector 740 can also be used. The interface 725 between the two separate phases (two types of the liquid) is preferably very sharp and clear.

By adjusting the position of the Y-connector 740, the level of the aqueous phase 726 (the first treated process water, if in E1) is also adjusted accordingly. That is, when the Y-connector is lowered, the aqueous phase level is lowered; and because the level of aqueous phase determines the position of the interface, the interface position is also lowered as the result of lowering the Y-connector. Therefore, the Y-connector is used to adjust the position of the interface 725 to a suitable level so that the exiting E-phase does not carry off any aqueous phase with it, and the exiting aqueous phase does not carry off any E-phase with it. Preferably, the E/A interface 725 of the settler is set at a medium position in the settler 720, normally in the ⅓ to ⅔ range level of the total fluid depth of the settler.

Further, based on the level of impurities in the original process water (or farm water feed) and in the E-phase, a small band of stable emulsion (also called RAG layer) often develops over time along the interface, causing the interface to be unclear or not sharp. This rag layer may also be caused by the solid particulates from the process water, such as fibers or food wastes from animal feed. This rag layer can be reduced or eliminated through pre-LLX filtering or dilution processes, or by adjusting other parameters, such as E/A ratio, mixing speed or mixing style, and/or co-current configuration instead of cross-current configuration.

The Y-connector can also be used to adjust the level of the stable emulsion so that it does not contaminate either the exiting loaded E-phase or the exiting treated aqueous phase. When the band of the stable emulsion is developed into a level that might cause blockage and contamination issues, it is typically removed by draining the aqueous phase from the settler compartment.

In cases where more residence time is needed for phase disengagement from the unstable emulsion 711; the settler compartment configuration can be modified to provide more residence time, such as increasing the length of the settler compartment, or changing it to a U-shape by putting a divider 721 in the compartment as illustrated by FIGS. 7A-7B. FIGS. 7A-7B illustrate the U-shaped wraparound (space saving) means to increase the residence time in the settlers, where the divider 721 guides the flow of the unstable emulsion 711 around the divider 721, producing a lengthened U-shaped flow path for the emulsion 711 to break into separate phases.

The U-shaped configuration is typically used for the extractors, but it can also be used for the strippers. The residence time in the settlers can be further increased without increasing the space needed for the equipment by adding a honey comb device with 1 cm comb spacing to the settler compartment 720, where the mixture/emulsion 711 has to travel through all these comb spaces to exit the settler compartment 720. Other suitable configurations can also be used to enhance residence time. Enhanced residence time in these settlers is desirable to provide sufficient time for phase disengagement, and to prevent pluggage and backflow problems.

In addition to or as an alternative to increasing residence time, the unstable emulsion 711 can undergo a high G-force separation, such as centrifuge, hydrocyclone, pressure filters, and the like, to promote phase disengagement within a very short period of time or instantaneously (anytime from 10 seconds to 5-10 minutes).

Also preferably, one or more coalesce agents, such as polyethylene glycol, can be used to promote phase disengagement by spreading out the emulsion 711.

The “wraparound” means of the settler, the high G-force separation, and the coalesce agents can be used alone or in combination to promote the emulsion of 711 to separate into two phases: the upper extractant phase 722 loaded with phosphate/nitrate ions; and the lower aqueous phase 726 (the treated process water) that is treated and depleted of ions that removed onto the E-phase 722.

“Loading ions onto the E-phase” is used here to describe the phenomenon of extracting ions from the process water into the E-phase. In particular, the phosphate, and/or polyphosphate ions may be extracted in colloidal form encapsulated by cationic, oil soluble Aliquat 336 molecules. Such nanoscale species could be extracted by dissolving or micro-colloid formation. Either way, the science around such systems is not well defined, especially when involving complex media such as anaerobic digester water (AD process water). Nevertheless, the LLX process was shown to be capable of removing essentially all of the orthophosphate ions, poly-phosphate and/or bio-phosphate. This capability of the LLX process was unexpected because highly charged ions, especially poly-phosphate ions, tend to be highly hydrated, and so they are highly resistant to being extracted into a hydrophobic liquid extractant media.

The ion-loading or extraction of the extractant phase is influenced by the level of the active extractant and by the E/A ratio. The preferred level of the active extractant (Aliquat 336) is in the range of about 0.1% to about 20%, preferably in the range of about 0.6% to about 9.1%. The preferred E/A ratio is in the range of about 3:1 to about 1:3, preferably 1:2 for AD process water, or preferably 3:1 for the lagoon process water. During the extraction operation, the extractor E/A ratio is typically defined by the flow rates of the incoming extractant phase 701 and the incoming aqueous process water 702 (see FIG. 6). The actual E/A ratio inside of the extractor mixing chamber can differ in a varying degree from the target E/A ratio of 3:1 or 1:2. The difference is largely the result of natural variations in different parts of any mixing chamber, where “fresh” E-phase and “fresh” aqueous process water coming into the chamber and the mixed E-phase and aqueous process water leaving the chamber. Therefore, the variation is dependent on the flow rates of two phases with the variation being larger for the smaller flow rates.

After exiting the E1-settler, the aqueous phase 726 (the first treated process water) from E1-settler 720 flows via an aqueous line 742 to the mixer of extractor E2. Here, the extractant phase flows from the extractant surge tank if two extractors are used (counter-current, see FIG. 25), or from E1 (co-current, see FIG. 27). The first treated process water (the aqueous phase 726) and the E-phase are mixed in the E2 mixer, creating another unstable emulsion, which disengages more readily into the E-phase and the aqueous phase (the second treated process water). Generally, the phase separation at E2 is not much of an issue. The E-phase then flows to E1 in a counter-current fashion (from E2) to be loaded with ions from the process water (the aqueous phase), after which proceeds to S1 stripper to be stripped of P- and/or N-based ions. The treated process water proceeds to be further extracted in E3 if 3-4 extractors are used. Otherwise, the treated process water (also called “raffinate”) exits the LLX unit to be discharged back into the environment, or to be further treated if desired.

The ion loaded E-phase 722, on the other hand, either flows to another extractor, or to the stripping stage to be removed of ions extracted from the process water 702.

### Stripper Configuration to Maximize Stripping of the Phosphate Ions

The configuration of the stripper mixer-settler is similar to the extractor mixer-settler with a few differences: (1) the extractor (also called extraction operations/stages) requires longer or more uniquely designed settlers to provide a longer residence time for phase disengagement; and (2) the extractors typically do not use an internal recycle of the aqueous phase (the aqueous base solution(s), such as the first aqueous base solution and/or the second aqueous base solution), while strippers (also called stripping operations/stages) typically use internal recycles of the aqueous phase (described and defined below). FIG. 8 refers to the typical mixer-settler configurations for the stripper stages/operations (also called strippers).

In the preferred counter-current configuration, the ion loaded extractant phase 722 enters into the stripping stage or operation by first flowing through the nearest stripper S1 mixer 810 (the beginning stripper) as the incoming ion loaded extractant phase 801. The aqueous stripping phase 802 is fed into the stripping phase through the farthest stripper S6 in a counter-current configuration (if six strippers are used as shown in FIG. 4) or S2 (if two strippers are used as shown in FIG. 1). As such, in the S1 mixer 810, the inflow extractant phase 801 comes directly from the extraction stage, fully loaded with phosphate/nitrate ions. The aqueous stripping phase 802 comes into the S1 mixer 810 through the S2 stripper (if two strippers are used), which provides make-up carbonate and/or hydroxide ions to strip additional phosphate ions from the loaded E-phase.

The ion-loaded E-phase 801 is mixed with the aqueous stripping phase 802 and/or a base solution 806 (such as KOH) by an impeller 814, forming an unstable emulsion. The base solution, preferably 45% KOH, is added as needed to control or promote the pH of the stripper to be at and above 11, preferably at 13-14. The function of the base solution is illustrated by FIG. 3 and in “Process Chemistry for Phosphate Ionic product Production with Cocomitant Regeneration of Carbonate form of the Extractant Phase.” The configuration of the impeller 814 is the same or similar to that of the extractor impeller 714 in FIGS. 6-7B, which is described in the section of “Extractor Configuration to Maximize Extraction or Removal of Phosphate Ions from the Process water.”

In the stripper mixing chamber, the impeller's speed is preferably in the range of about 700 to 1,800 RPM for 1 inch impeller diameter, more preferably in the range of about 700 to about 1300 RPM.

The mixing forces the newly formed unstable emulsion 811 quickly over an optional but preferred overflow weir 812 and under a buffer or underflow weir 813 to the settler compartment 820. The unstable emulsion 811 then, quickly, disengages in the settler 820 into two phases, the stripped E-phase 822 with some residual ions and the loaded aqueous stripping phase 826. A preferably sharp interface 824 separates two phases, whose position or height can be adjusted by the height/position of the Y-connector 840 for the aqueous outflow. A band of stable emulsion layer can be developed during the operation due to the impurities in the E-phase and/or in the stripping solution. The preferred residence time is about 1 second to about 10 minutes, can extend up to 30 minutes, more preferably the stripping residence time is about 1 second to 90 seconds, or 4 to 8 minutes, depending on the type of process water. For the higher solid content AD process water, more stripping residence time might be needed.

The E-phase 822 with residual phosphate ions then proceeds to the S2 mixer to be further stripped of the remaining phosphate ions. Preferably, the E-phase 822 flows over an overflow weir 830, which is optional but preferred, to exit the settler 820 via an extractant line 831 at the bottom of the settler 820.

The loaded aqueous phase 826 exits the S1 settler 820 via an aqueous exit line 843 and an optional valve 842. The exiting aqueous phase 826 enters into two cycles: Part of the aqueous phase 826 is internally recycled back to the S1 mixer to be re-used to strip the loaded extractant phase, and part of the aqueous phase enters into the phosphate concentrate product tank 131. This internal recycle of aqueous flow increases the phosphate concentration of the phosphate product by maximizing the stripping or carrying capacity of the aqueous stripping solution. The internal recycling of the aqueous phase can be adjusted to provide a smoother operation by adjusting the levels of phases in the strippers.

In a preferred embodiment, the optional valve 842 is a two-way flow controller valve, which controls the flow of the aqueous raffinate 826 into the exiting aqueous line 843 to the Y-connector 840, and the flow of the aqueous raffinate 826 into the internal recirculation line 850. Alternatively, the valve 842 can be replaced with a valve 851 placed at the aqueous internal recirculation line 850, or the valves 842 and 851 can be used together. Through the aqueous exit line 843, the aqueous raffinate 826 goes through the Y-connector overflow off weir 840 to enter either another stripper or the product concentrate tank. Further, through the aqueous internal recirculation line 850 via the valve 851, the aqueous raffinate 826 is recycled back to the stripper mixer to strip more ions from the ion loaded E-phase, and thus increase the ion concentration in the aqueous raffinate and produce a higher concentration ionic product.

The E/A ratio in the stripping phase is in the range of 20:1 to 1:20, preferably in the range of 1:4 to 1:10, more preferably in the range of 1:1 to 1:4. While not wishing to be bound by theory, it is presently believed that the E/A ratio in the stripper does not need to be controlled as strictly as that of the extractor. The E/A ratio is adjusted in the stripper to ensure adequate stripping solution is in the mixer (1) to strip ions from the loaded extractant phase 801, (2) to enable easy mixing of aqueous phase and organic phase, (3) to ensure that the exiting extractant phase 822 and the exiting aqueous phase 826 are not contaminated with each other, (4) to facilitate better phase separation between the exiting phase 822 and the exiting aqueous phase 826, and (5) to get a more concentrated phosphate concentrate product.

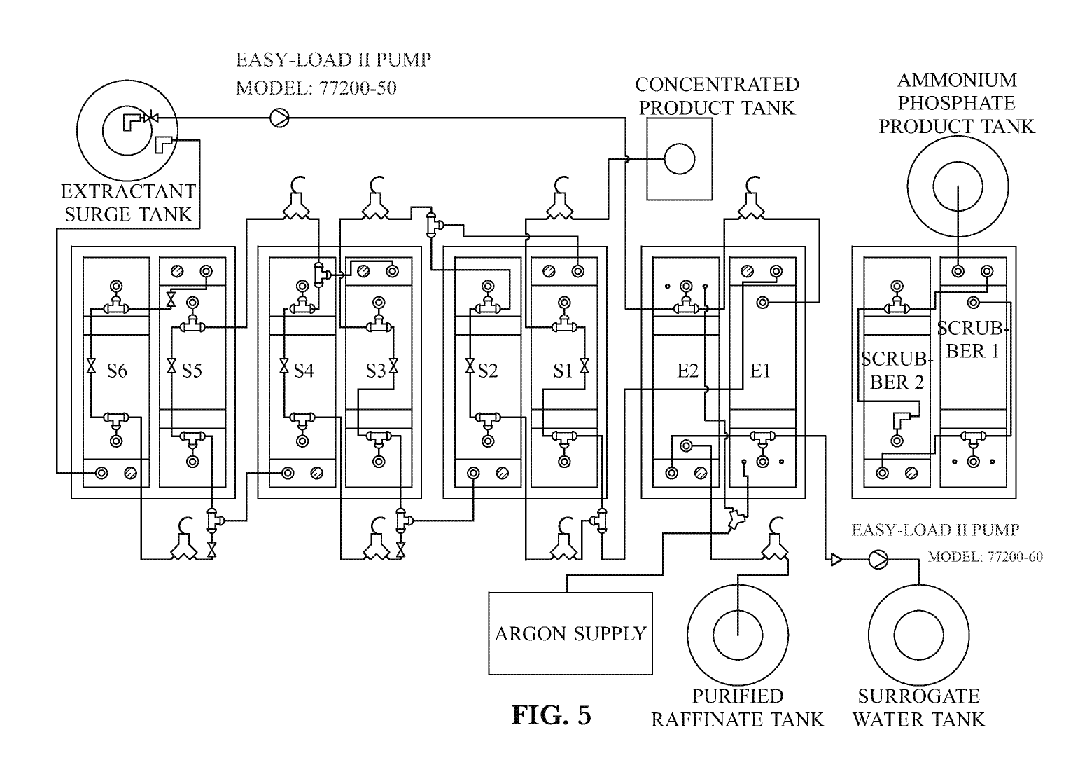

The E/A ratio can be adjusted by varying incoming stream flow rates (E-phase and process water) and aqueous internal recycle flow rate. The process water flow rates refer to the flow rates of the ion loaded E-phase 801 into the stripper and the flow rates of the aqueous stripping phase 802 into the stripper. The internal recycle flow rate refers the flow rate of the loaded aqueous stripping phase 826 in the internal recirculation 850 (or internal recycle). The inflow rate refers to the ratio of the flow rate of E-phase 801 to that of the aqueous phase 802. For example, in some embodiments of the present invention, at the beginning of the LLX process, the fresh aqueous stripping solution is added to the stripping mixing chamber to a preferred ⅔ of level of the chamber. During the operation, the “fresh” loaded extractant phase 801 is added to the top of the beginning stripper (S1), while the “fresh” aqueous stripping solution is added to the end stripper (S2 in FIG. 1; S6 in FIGS. 4-5) with a preferred flow rate of about 1 ml/min (counter-current configuration). The word “fresh” is used to describe the liquid being added from the outside of the stripper as opposed to that of the liquid recycling within the same stripper.

Preferably, the inflow ratio is about 100,000:1, with the flow rate of the aqueous phase 802 at a preferred rate of 1 ml/min. The inflow ratio in the range of about 1:1 to about 10:1 is effective; the preferred ratio is in the range of about 1,000:1 to about 10,000:1. The inflow ratio in the range of about 10,000:1 to 100,000:1 is most preferred. The higher inflow ratio is preferred because the higher inflow ratio can increase the ion concentration of the final phosphate recovery product. It was shown that the inflow ratio in the range of 10:1 to 100:1 was effective through our continuous flow run experiments in Example 19 below.

In a preferred embodiment, in which the E/A ratio is adjusted to avoid contamination in the exiting phases, the end stripper (S2, S3, S4, S5, or S6) contains a higher level of aqueous phase at a preferable ⅔ level, while the beginning stripper (S) contains a higher level of the E-phase at a preferable ⅔ level. The differential in the phase levels is maintained and desired so that when the end stripper provides aqueous phase to the stripper upstream (S5, S4, S3, S2, S1), the aqueous phase would not be contaminated by E-phase. Similarly, when the beginning stripper provides E-phase to the stripper downstream (S2, S3, S4, S5, S6 etc), the higher E-phase level ensures that there is little chance that the exiting E-phase will drag any of the aqueous phase through the overflow weir to the outlet.

The aqueous stripping phase goes from S6 to S5 to S4 to S3 to S2 and then to S1, becoming more and more concentrated with phosphate ions. Finally, after going through the S1 stripping stage and the internal recycling within the S1, the aqueous stripping phase becomes an aqueous raffinate concentrated with phosphate ions, and then exits the S1 settler to the phosphate/nitrate product concentrate tank, at which time, it is called phosphate product concentrate or phosphate concentrate product.

The loaded E-phase goes from S1 to S2 to S3 to S4 to S5 and to S6, in a preferred counter-current fashion, to be fully stripped of all phosphate/nitrate ions. The fully stripped E-phase went through S6 and exits its settler to be recycled as a regenerated E-phase to the E-phase surge tank, which provides the fresh or regenerated E-phase to the extraction stage. The regenerated E-phase can go through an optional DI water wash stage as described elsewhere in this application to remove water soluble entrained ions so it can be more efficient in extracting phosphate ions. Alternatively, the last stripper, such as S6, can be a water wash stage as shown in FIGS. 25 to 26 (Example 19).

The ion-loaded aqueous stripping solution then becomes concentrated ionic products, most likely a bi-product of phosphate and nitrate. This bi-product is usable without any further treatment or separation because both nitrate and phosphate are needed in the fertilizer so there is no need to separate them. In addition, through this stripping process, polyphosphates and organophosphates are hydrolyzed to form more orthophosphate, dibasic and orthophosphate, tribasic ionic forms of phosphate, which are much more desirable in some commercial applications.

The stripped extractant loads the carbonate and bicarbonate ions from the K₂CO₃ stripping solution, and thereby the E-phase becomes regenerated extractant phase, which is recycled back to be used in the extractor. All of the above steps can be performed in batches, but most preferably are performed under continuous flow conditions.

Process Chemistry for Phosphate Ionic Product Production with Concomitant Regeneration of Carbonate Form of the Extractant Phase

After mixing the E-phase with the process water, the E-phase removes ionic species, such as phosphate ions, from the process water and becomes an ion loaded E-phase. The chemical form of the phosphate ion loaded on the extractant phase is believed to be an ionic compound (R₄N⁺)₂PO₄⁼ and/or R₄N⁺HPO₄⁻ depending on the pH of the extraction stage.

In a preferred counter-current arrangement of the phosphate stripper operation, the “first” phosphate strip stage, S1, generates an aqueous raffinate that is the most concentrated in phosphate ion and represents the “phosphate product concentrate” or “phosphate concentrate product.” Depending on relative flow rates of the extractant phase and the carbonate/hydroxide strip feed solution, the phosphate ion concentrate product can be adjusted over a very wide range of approximately 2,000-650,000 mg PO₄⁼/L. Preferably, the phosphate product contains 7,000-100,000 mg/L for the case of stripping with K₂CO₃ and KOH.

The present invention provides sharp, fast and high yield phosphate ion recovery and stripping in stages S1-S2, preferably S1 to S4, and most preferably S1 to S6. This effective high yield stripping is possible through the addition of an aqueous base solution, which keeps the stripping mixtures at a pH of 11 or above, preferably at pH 13-14, the most preferably at pH 14 or above (the process referred to as the pH control). The pH of the stripping mixture refers the equilibrium pH of the unstable emulsion in the stripper. The stripping mixture refers to the unstable emulsion. The preferred aqueous base solution is selected from a group consisting of potassium hydroxide, sodium hydroxide, milk of lime, or other OH⁻ basic solutions, or a mixture thereof. More preferably, the aqueous base solution is KOH, most preferably 45% KOH.

The base solution is preferably added to the stripper when the equilibrium pH of the unstable emulsion drops below pH 11 or pH 13 through a pH monitoring system. The effect of the base solution in the stripping phase, and to a smaller extent in the extraction phase, can be seen in FIG. 3. FIG. 3 uses equations to summarize an important part of the nature of the process of the present invention using an aqueous base solution to maintain the pH in the stripper.

The reason for the necessity of maintaining the equilibrium pH of the unstable emulsion in the stripper (might also be referred to as “the pH in the stripper”) to be at least at pH 11 or above is explained below:

Based upon nonaqueous potentiometric pH titration data of the stripped extractant phase using the methyl orange indicator (see Example 6), it was found that the E-phase anion became HCO₃⁻ during the stripping process instead of remaining as the dianion CO₃⁼. While not wishing to be bound by theory, it is currently believed that the exponential effect of charge on ion exchange and hydration left the HCO₃⁻ (a mono-anion) loaded E-phase too weak to prevent the reloading of the highly charged HPO₄⁼ ion back onto the E-phase from the first stripper, causing a portion of the P-o-PO₄ to be carried over to the next stripper where it accumulates until the pH of the next stripper reduces to 9. This process continues from one stripper stage to another until it eventually spreads over most of the six strip stages used in Example 5 below. Therefore, only 1500 mg/L P—PO₄ was achieved from a 100 mg/L process water (Example 5) instead of a 5000 mg/L concentrate product desired for commercial viability.

In Example 5, a continuous flow LLX process operation was performed using 100 mg/L surrogate farm water feed (a type of the process water). In this example, only CO₃²⁻ (such as 30% K₂CO₃) was being fed into the stripper in a counter-current flow arrangement. According to the data from Example 5, the pH of the stripper aqueous phase product concentrate (strip raffinate) dropped to 8.5±0.5 during the operation. The stripper aqueous phase product concentration can also be called the phosphate product concentrate or concentrate product, or called aqueous strip raffinate or just raffinate. At the pH level of 8.5±0.5, the carbonate ion to bicarbonate ion concentration in the strip raffinate was about 1:1 molar ratio, indicating that H⁺ ions were being brought into the stripper from the extraction circuit with the phosphate ions (see Equation 1 in FIG. 3). The pH of the extractor mixer was consistently about 9 or 9.5, indicating the phosphate ions were in the form of HPO₄ before being extracted onto the E-phase (the left side of Equation 1 in FIG. 3). The pH of the extraction raffinate (the ion loaded E-phase) was consistently about 9, indicating that the extracted species of phosphate was most likely (R₄N)₂HPO₄.

Equation 1 in FIG. 3 illustrates that the P—PO₄ is stripped in the aqueous phase as the HPO₄⁻ dianion; it also shows that some of the excess carbonate ion is converted to bicarbonate ion. The pH of the raffinate drops with the ([CO₃²⁻]/[HCO₃⁻])ₛₜᵣᵢₚ ratio and not with the total concentrations of either of these species. Therefore, at pH 9, the less extractable HPO₄⁻ species becomes the dominant P—PO₄ species, and the highly extractable H₂PO₄²⁻ species a minor one. At the same time, the carbonate ion stripping strength lessens at the same pH range of 9 due to the formation of HCO₃⁻ species.

As such, it was determined that in order to retain the P—PO₄ in the first stripper so as to maximize the P—PO₄ concentration of the phosphate concentrate product, it was necessary to ensure that the E-phase is kept nearly complete in the CO₃²⁻ form in the extraction raffinate, which would be recycled as the carbonate loaded E-phase for the next extraction cycle.

The pH control is accomplished (see Examples 18 and 19) as follows: A small flow of aqueous 45% KOH is metered into the stripper mixer compartment (S1 mixer) at a rate to ensure that all bicarbonate and monobasic orthophosphate ions in the recovered phosphate concentrate product are neutralized, and thus, retained in the first strip stage. This pH control ensures that CO₃² species are loaded onto the E-phase, preventing any reloading and/or poor stripping of P—PO4 species by using the following reaction:

HCO₃⁻(pH˜9)+OH—→CO₃²⁻(pH 12-14)+H₂O (Reaction 1)

Reaction 1 with the addition of OH⁻ (as in 45% KOH) enables the completion of Equation 2 in FIG. 3, where CO₃²⁻ species are loaded onto the E-phase, generating (R₄N)₂CO₃, which can be recycled into the next extraction phase as indicated in FIG. 3. Other suitable base solutions can also be used.

Another preferred way of adding KOH or OH⁻ solution to the stripper is to fill the stripper to ⅔ full with K₂CO₃ solution, and then add the KOH solution to the stripper during the operation in a continuous flow. Once in a while, check for the CO₃²⁻ content; and if it is low, then add more K₂CO₃ or more KOH. K₂CO₃ is found not to be able to increase the pH of the mixer in the stripper to be above pH 11, so the KOH solution, or other suitable basic solution, is needed to maintain pH.

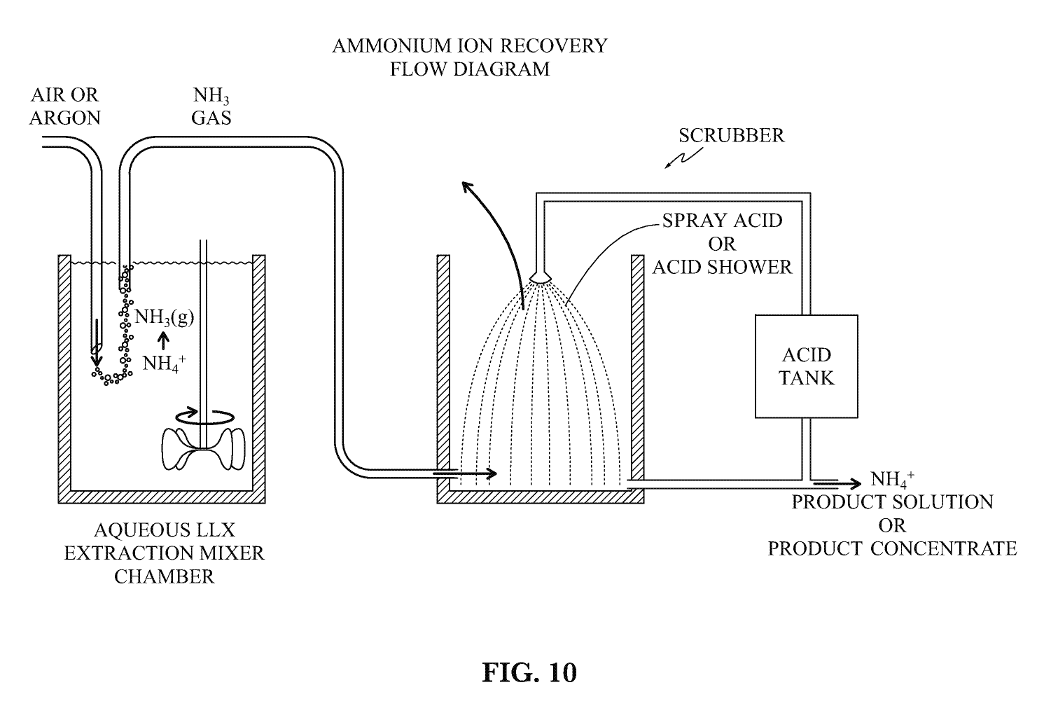

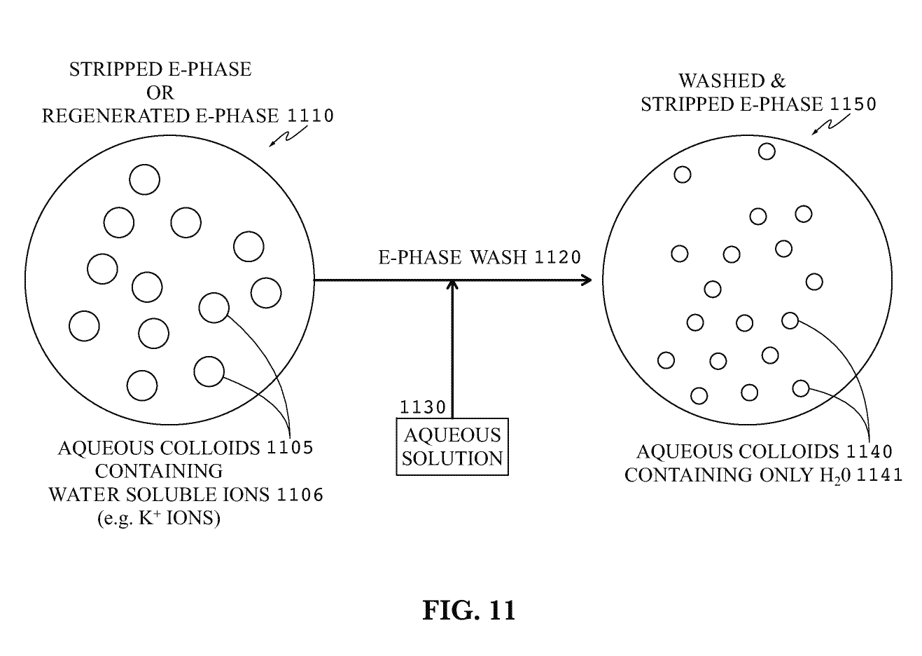

Please note that the NH₃ gas generated in Equation 1 of FIG. 3 can be harvested using acid scrubbers as illustrated in FIG. 10. Other suitable methods can also be used.

Accordingly, the aqueous raffinate flowing from the S1 stage, either continuously or intermittently, is the useable phosphate ion and/or nitrate product, for example concentrated solution and/or easily crystallized solids of K₂HPO₄, KNO₃, and/or KH₂PO₄ (as a hydrate or anhydrous form). These products are items of commerce used in numerous industries, especially agriculture industry.

In the most preferred embodiment, the stripper circuit only needs to use two strippers (see FIG. 1). One or more of the strippers (S1 and/or S2) includes KOH addition for pH control as described above, and the second (S2) to provide makeup CO₃²⁻ to S1 in a counter-current flow fashion to allow eventual full utilization of the K₂CO₃ aqueous stripper feed and to maximize the phosphate concentration in the phosphate concentrate product from S1. In other words, with pH control, as the ion loaded E-phase flows into the S1, most of the phosphate ions in the ion loaded E-phase are stripped from the E-phase in S1, using up most of the CO₃²⁻ ions in S1. The S1-stripped E-phase then flows into S2 to be stripped of any remaining phosphate ions. As such, few CO₃²⁻ ions in the stripping feed are used to strip phosphate in S2. The K₂CO₃ rich stripping aqueous solution from S2 flows to S1 in a counter-current fashion with regard to the flow of the S1-stripped E-phase. The K₂CO₃ stripping aqueous solution from S2 provides additional or supplemental CO₃²⁻ ions to S1 for continuous stripping of the incoming ion loaded E-phase.

In other words, if the feed of ion loaded extractant phase (E-phase) to S1 is in excess of the molar amount that can be handled by the chemical reactions 1 to 2 in FIG. 3, it causes a complete consumption of all aqueous carbonate in S1. Then S2 (the next stripper downstream) provides the additional carbonate through a counter-current flow of the aqueous stripping feed from S2 to S1. The extractant phase carries (R₄N)₂CO₃, R₄NHCO₃, (R₄N)₂HPO₄, and/or (R₄N)H₂PO₄ to the next stripper (S2 or S3 or S4) stages where the PO₄³⁻, HPO₄²⁻ and HCO₃⁻ extractant phase species are displaced (ion exchanged out) by the overwhelming high concentration of divalent CO₃⁼ ions, which are maintained in the divalent form by the KOH base solution at a pH 11 or above, preferably a pH 13 to 14. The carbonate ion concentration used is limited by the solubility of the carbonate salt and by the pH of the stripper stage.

Preferably, the stripping and/or the LLX process is performed in an ambient temperature, which in the range of about 20 to about 60° F. However, suitable temperature for the LLX process of the present invention can be in the range of about 0° F. to about 100° F., preferably in the range of 50 to 80° F., more preferably in the range of 60 to 70° F.

When using potassium carbonate as the stripping aqueous solution, the effective concentrate range is up to 60% K₂CO₃ at ambient temperatures; but preferably 12-40% K₂CO₃ so that a concentrated potassium phosphate salt is produced from the S1 stage. Other carbonate salts, such as sodium carbonate, can also be used. Preferably, the aqueous stripping solution is selected from a group consisting of aqueous carbonate solution; aqueous hydroxide solution; an aqueous solution of ionic bases selected from a group consisting of CO₃²⁻, HCO₃⁻, OH⁻, HS⁻ and S²⁻, wherein CO₃²⁻ and OH⁻ are most preferred; other bases with a pKa value of >11; and a mixture thereof. CO₃²⁻ is the most preferred because it is most capable of displacing the P- and/or N-based ionic species in the process water so long as it is being kept in the CO₃²⁻ form by the second aqueous base solution (by raising the pH to be at or above pH 11). HCO₃⁻ is preferred to remove N-based nutrient, or to remove P- and/or N-based nutrient in combination with OH⁻ group.

The base solution (also called the second aqueous base solution to distinguish to the first aqueous base solution as the stripping solution), such as KOH, when used as the pH adjuster or a part of the strip aqueous solution, the effective concentration range of hydroxide base solution should be sufficient to convert and maintain the carbonate in the stripper and in the E-phase. Preferably, the concentration of KOH is about 1% to 60% KOH at ambient temperature, with the most preferred concentration being 45%. Other suitable base solutions can also be used so long as their pKas are above 11. Preferably, the base solution is selected from a group consisting of potassium hydroxide, sodium hydroxide, milk of lime, or other OH⁻ basic solutions, or a mixture thereof.

### Water Treatment to Remove Ammonium Ions

Ammonium ions in the process water (aqueous phase) are not extractable by E-phase in the same way as described above. However, the ammonium ions can be captured during the LLX process by using the ammonia gas removing technologies, such as gas sparging and acid scrubbing, or air/stream ammonium removal. Eq. 1 in FIG. 3 shows that ammonium ions react with the carbonate ions in the E-phase to become the volatile gas ammonia (NH₃). According to FIG. 10, a stream of air or argon can be bubbled into the extraction mixer chamber (the gas sparging process), which pushes the NH₃ gas out of the chamber via an NH₃ gas line to the acid scrubbing tank. In the acid scrubber, a stream of acid is sent over the top of the scrub tank (scrubber) to shower into the scrubber tank as small droplets of acid solutions, while the ammonia gas air stream is fed into the bottom or the lower half of the scrub tank, which then moves upwards in the scrubber. As the acid droplets enter the upward moving ammonia air stream, the acid absorbs the ammonia instantly, leaving the remaining exiting air stream clean of ammonia. Then, the absorbed ammonia gas is converted into and collected as useful ammonium product concentrates, such as ammonium phosphate. The acid is recycled into the acid tank to be reused to remove additional ammonia gas. The resulting ammonium product concentrate can contain up to 100,000 ppm NH₄⁺ ions.

### Optional KOH Hydrolysis Process to Convert Poly-Phosphate and Bio-Phosphates to Orthophosphate

The KOH hydrolysis process is a process of using a high pH base solution, such as KOH, to hydrolyze poly-phosphates and bio-phosphates to orthophosphate (a type of mono-phosphate). The preferred base solutions have a high pKa, preferably at pH 11 or above, such as KOH solution. However, KOH pretreatment of the E-phase might not improve phase separation.

In this process, the feed solution or process water is pretreated with the preferred 40 mM KOH solution by mixing for a period of time sufficient to hydrolyze poly-phosphates and bio-phosphates in the process water. Preferably the mixture is stirred for 60 minutes or more at a mixing speed of 400 rpm or more. The mixing time and speed can be adjusted to avoid excess emulsion. Moreover, the mixing parameters are dependent upon the concentration of the poly-phosphate and bio-phosphate ions in the process water.

The KOH process is optional because the LLX process was shown to be capable of removing essentially all of the orthophosphate ions, poly-phosphate and/or bio-phosphate. This capability of the LLX process was unexpected because highly charged ions tend to be highly hydrated, and so they are highly resistant to being extracted into a hydrophobic liquid extractant media. While not wishing to be bound by theory, it is presently believed that such nanoscale ion species (phosphate/poly-phosphate) could be extracted by dissolving or micro-colloid formation.

However, the KOH process can be used to reduce the amount or concentration of the active extractant used in the LLX process so that the whole process can be more economical. For example, if the process water contains mostly orthophosphate, such as surrogate farm water or farm lagoon water, the level of the active extractant needed to extract the phosphate ions is much lower. Conversely, if the process water contains mostly polyphosphate and/or bio-phosphate, such as AD process water, a higher level of the active extractant is needed for an effective extraction of all these ions.

### Preferred Solutions Used in the LLX of the Present Invention

### 1. Preferred Solutions Used in the Extraction Stage:

The concentration of the active extractant (Aliquat 336) in the extractant phase composition varies depending on the type of agriculture process water and on the concentration of polyphosphate and bio-phosphate in the process water. For example, a more dilute or lower concentration of Aliquat 336 of about 6% is preferred for a farm lagoon water with approximately 100 ppm phosphate. On the other hand, a higher concentration of 9.1% Aliquat 336 is more preferred for an AD process water with a much higher concentration of phosphate, including a higher concentration of polyphosphate and bio-phosphate.

### The Preferred Extractant Phase Composition

| | Concentration | |
|---|---|---|
| Chemical | (% wt.) | Comments |
| Aliquat 336 | 0.6-9.0 | Extractant |
| (methyl tri(n-octyl)ammonium | | |
| ion, R₄N⁺) | | |
| 467 Solvent | 94.9-86.5 | Diluent |
| | | (aliphatic, non-odorous, |
| | | water immiscible) |
| Exxal 10 | 4.5 | Modifier |
| (Decyl Alcohol) | | |

Other preferred solution in the extraction stage is 8% K₂CO₃, which is used to carbonate the extraction phase and to reduce or eliminate certain impurities, such as Cl⁻ ions.

### 2. The Preferred Solutions in the Stripping Stage:

The first aqueous solution in the stripping stage is preferably 30% Potassium Carbonate (K₂CO₃) Aqueous Solution, which is fed to the Strippers to remove phosphate ions from the extractant phase by ion exchange.

The second aqueous base solution in the stripping stage is 45% Potassium Hydroxide (KOH) Aqueous Solution. It is fed to the Strippers to control the pH of the aqueous strip solution. KOH is used instead of NaOH to enhance the fertilizer value of the p-(o-PO₄) product concentrate.

### Inactivation of Pathogens and Reduction of Odor in the Process Water (Animal Manure)

There is a need for integrated approaches that can recover energy and nutrients, while minimizing health and environmental risks. Practical, cost-effective, and environmentally benign methods are needed, particularly for use in large farms, CAFOs, or manure management facilities.

The present method is able to recover P- and N-based nutrients from various animal manure process waters (one type of “process water”), inactivate biological pathogens in manure, and reduce the manure odor significantly in a highly effective and economical fashion. In other words, with one LLX process, the P- and N-based nutrients are recovered, the pathogens are inactivated, and the odor is reduced.

It is known that removal of polyphosphate from pathogen DNA might cause destruction of pathogens. However, the ability to extract polyphosphate from biological cell walls so as to result in a significant level of pathogen inactivation is highly unexpected. It is known that these poly-phosphate and bio-phosphate ions are generally negatively charged ions and highly water soluble, and as such, they are very difficult to remove from water and are especially resistant to being extracted into a hydrophobic media.

Additionally, the elevated pH levels in the present LLX method may be partially responsible for the inactivation of some pathogens. However, some pathogens might be more resistant to the pH elevation.

Our results show pathogen inactivation levels of 95% and 99.1% after first and third extractions, respectively. It is theorized that the pathogen inactivation may be a function of process parameters such as temperature, process water to extractant ratio, extractant strength, and mixing conditions.

There are numerous types of pathogens in animal manure:

### Bacteria:

Listeria monocytogenes: Cattle, sheep and other livestock are carriers and shed listeria. Fresh vegetables fertilized with animal manure are thought to be significant sources of contamination for humans.

E. coli O157 Cattle are thought to be the primary reservoir of E. coli O157 The amount of E. coli O157 shed in the manure is estimated to be between 3-50,000 cfu/gram of feces. Note that the E. coli O157 infective dose for humans is about 10 cfu—the lowest of the common human food-borne pathogens.

Salmonella spp.: Up to 75% of dairies are positive on fecal culture for salmonella. Over 50% of the cattle have been found to be shedding on some dairies. A small percentage of cattle are colonized carriers that continually shed salmonella in their feces.

Mycobacterium paratuberculosis: It is the causative organism for Johne's Disease in cattle. Infected cows may shed the pathogen in feces for months to years before developing clinical signs. At the peak of shedding, the infected cow may shed a million bacteria/gram of manure. Two thimbles full of manure from an infected cow are enough to infect a calf. Crops that had fresh manure applied as fertilizer are a feed risk to young stock. This bacterium can live in the environment for up to one year.

Protozoans: Cryptosporidia parvum, Giardia spp.

These protozoans are shed by wildlife, livestock and humans. The primary concern is water contamination from livestock manure. Dairy calves between 7-21 days old are the main shedders for Crypto on dairies. Beef calves are also the main concern for beef cattle; however, they shed at a slightly older age than dairy calves, 2-4 months old. Both of these organisms survive for a long time in manure. Lagoons are usually not contaminated with Cryptosporidia unless flushing systems are used to remove the manure from beneath pens of young dairy calves.

### Viruses: Bovine Virus Diarrhea Virus, Coronavirus, Foot and Mouth Disease Virus

### EXAMPLES

The following examples illustrate various aspects of the invention and are not intended to limit the scope of the invention in any way.

### Example 1

This example examined the extraction capacity or efficiency of the E-phase using the E/A ratio of 2/1. The surrogate farm water (a type of the process water) and the E-phase were prepared as follows:

Prepared a 1-L aqueous surrogate farm water (process water) using the following process:
1. To 1 liter distilled water (DI water), added 51 mg of NH₄H₂PO₄ (mono-basic phosphate salt) and 51 mg of (NH₄)₂HPO₄ (di-basic phosphate salt) in the hood.
2. Mixed well until all phosphate salts were dissolved.

The extractant solution (E-phase) was prepared using the following formulation:

TABLE 1A
Extractant Formulation

| | Concentration | |
|---|---|---|
| Chemical | (wt %) | Comments |
| Aliquat 336 | 9 .1 | Extractant |
| (Methyl tri(n-octyl)ammonium | | |
| ion, R₄N⁺) | | |
| Exxal 10 | 4.7 | Modifier |
| (Isodecyl Alcohol) | | |
| Calumet | 86.2 | Diluent |
| (467 solvent) | | (Aliphatic, non-odorous, |
| | | water immiscible) |

The E-phase so prepared was then carbonated with 8% K₂CO₃ using the following process. The extractant solution was fully acid stripped of Cl⁻ and then carbonate loaded using 1-25 wt % K₂CO₃ or Na₂CO₃ before being added to the LLX system and process. The process of carbonating the E-phase achieved both acid stripping and carbonation at the same time.
1. In a 5-L flask, added 700 ml E-phase with 3500 ml 8% K₂CO₃ in a 5-L flask together, mixed with a stirrer for about 2 minutes.
2. Let the mixture sit for 20 minutes to allow the emulsion to separate into E-phase and the treated process phase (the aqueous phase), then disposed the aqueous phase.
3. Repeated washing E-phase with 8% K₂CO₃ four times.

Extraction Procedure:

1. Mixed 80 ml of E-phase with 40 ml of aqueous phosphate surrogate process water in a 300 ml beaker equipped with a magnetic stirrer for about 2 minutes.
2. Transferred the mixture to a separation funnel and allowed phases to disengage with observation at t₅₀ and t₉₀.
3. Transferred and stored the aqueous layer.
4. Repeated steps 1-3 above without replacing the E-phase for the number of repeated loading of surrogate process water as specified in Table 3.
5. Filtered all aqueous layer samples using a 0.2 μm nylon syringe filter due to sample turbidity. After the repeated loading #5, the aqueous layer samples were left over the weekend, it was found that the turbid aqueous layer cleared up very well, leaving a paper-thin milky layer at the top.
7. Tested for phosphate concentration on the aqueous filtrate using the method as outlined in the HACH kit Row Orange (0-1 mg/L) test procedure. The phosphate concentration was generally considered as none detectable (ND) using this procedure if the concentration is below 0.10 ppm.

### Results and Discussion:

The E-phase was observed to be clear and light in color throughout the testing process. The data from Table 3 show that phase disengagement times for E/A ratios at 2/1 or above were reasonable. Further, these data can be used to determine settling time, flow rates, and the size of the extractor mixer and settler.

TABLE 1B
E-phase Capacity Testing of Example 1

| | | | | Phos- | |
|---|---|---|---|---|---|
| | | | | phate | |
| | | | | concen- | |
| Repeated | | | | tration | |
| loading # | t_{50%} | t_{90%} | Comments | (mg/L) | pH |
| 1 | 1 min | 1 min 30 sec | Hazy aqueous | ND* | 10 ± 0.5 |
| | | | phase; | | |
| | | | V _{aq} ≈ 40 ml | | |
| 2 | 2 min 30 sec | 3 min | Hazy aqueous | ND | 8.5 ± 0.5 |
| | | | phase; | | |
| | | | V _{aq} ≈ 40 ml | | |
| 3 | 3 min | 3 min 30 sec | Hazy aqueous | ND | 8.5 ± 0.5 |
| | | | phase; | | |
| | | | V _{aq} ≈ 40 ml | | |
| 4 | 3 min | 3 min 30 sec | Hazy aqueous | ND | 8.5 ± 0.5 |
| | | | phase; | | |
| | | | V _{aq} ≈ 40 ml | | |
| 5 | 3 min | 3 min 30 sec | Hazy aqueous | ND | 8.5 ± 0.5 |
| | | | phase; | | |
| | | | V _{aq} ≈ 40 ml | | |
| 6 | 3 min | 3 min 30 sec | Hazy aqueous | ND | 8.5 ± 0.5 |
| | | | phase; | | |
| | | | V _{aq} ≈ 40 ml | | |
| 7 | 3 min | 3 min 30 sec | Hazy aqueous | ND | 8.5± 0.5 |
| | | | phase; | | |
| | | | V _{aq} ≈ 40 ml | | |
| 8 | 3 min | 3 min 30 sec | Hazy aqueous | ND | 8.5 ± 0.5 |
| | | | phase; | | |
| | | | V _{aq} ≈ 40 ml | | |
| 9 | 3 min | 3 min 30 sec | Hazy aqueous | ND | 8.5 ± 0.5 |
| | | | phase; | | |
| | | | V _{aq} ≈ 40 ml | | |
| 10 | 3 min | 3 min 30 sec | Hazy aqueous | ND | 8.5 ± 0.5 |
| | | | phase; | | |
| | | | V _{aq} ≈ 40 ml | | |
| 11 | 3 min | 3 min 30 sec | Hazy aqueous | ND | 8.5 ± 0.5 |
| | | | phase; | | |
| | | | V _{aq} ≈ 40 ml | | |
| 12 | 3 min | 3 min 30 sec | Hazy aqueous | ND | 8.5 ± 0.5 |
| | | | phase; | | |
| | | | V _{aq} ≈ 40 ml | | |
| 13 | 3 min | 3 min 30 sec | Hazy aqueous | ND | 8.5 ± 0.5 |
| | | | phase; | | |
| | | | V _{aq} ≈ 40 ml | | |
| 14 | 3 min | 3 min 30 sec | Hazy aqueous | ND | 8.5 ± 0.5 |
| | | | phase; | | |
| | | | V _{aq} ≈ 40 ml | | |
| 15 | 3 min 10 sec | 3 min 42 sec | Hazy aqueous | ND | 8.5 ± 0.5 |
| | | | phase; | | |
| | | | V _{aq} ≈ 40 ml | | |
| 16 | 3 min 10 sec | 3 min 42 sec | Hazy aqueous | ND | 8.5 ± 0.5 |
| | | | phase; | | |
| | | | V _{aq} ≈ 40 ml | | |
| 17 | 3 min 10 sec | 3 min 42 sec | Hazy aqueous | ND | 8.5 ± 0.5 |
| | | | phase; | | |
| | | | V _{aq} ≈ 40 ml | | |

*The phosphate concentration was generally considered as ND using this procedure if the concentration is below 0.10 ppm.

### Example 2

This example evaluated the stripping procedure for the phosphate loaded extractant phase using 8 wt % K₂CO₃ as the aqueous stripping solution.
1. Transferred 1 L of 8.0 wt % K₂CO₃ solution to a 1 L Nalgene bottle. Shook it carefully so that the final solution was clear and colorless. This solution was used as the aqueous stripping solution (also called the aqueous stripping phase).
2. Used a graduate cylinder to transfer 40.0 ml phosphate loaded extractant phase (PO₄-loaded E-phase) from Example 3 to a 300 ml graduated beaker equipped with a magnetic stir disc. Please note that the stir bar was not used because it did not create a sufficient shear force.
3. Transferred 120 ml of aqueous stripping phase from step 1 above to the 300 ml beaker from step 2, and mixed thoroughly for about 2 minutes, at which time a complete blending of two phases was observed.
4. Transferred the mixture into a separatory funnel, and waited for complete phase disengagement. Recorded the estimated times taken for both 50% (t₅₀) and 90% (t₉₀) aqueous phase (raffinate or treated process water) recovery.
5. After phase disengagement was complete, transferred and stored the aqueous raffinate phase in an appropriate container.
6. Transferred the E-phase from the separatory funnel to the 300 ml beaker and repeated step 3 to step 5 for a total of five times so that the same E-phase can be in contact with fresh stripping phase for a total of six times. The aqueous raffinate sample from each contact was analyzed.
7. Recorded the aqueous raffinate sample volume (or weight), pH, visual turbidity and color. In addition, analyzed the sample for “PO₄” and density (according to the weight of the sample to ±0.001 g of 100.0 μl of aqueous phase). PO₄ concentration was analyzed using the orthophosphate HACH testing kit.

TABLE 2
Stripping Analysis for Example 2

| | | | | Phosphate | | | Sample |
|---|---|---|---|---|---|---|---|
| Load | | | | concentration | | Density | Weight |
| # | t₅₀ | t₉₀ | Comment | (mg/L) | pH | (g/ml) | (g) |
| 1 | 30 sec | 50 sec | E-phase: clear; AQ-phase: | 4.0 | 12.0 ± 0.5 | 1.143 | 0.1143 |
| | | | slightly hazy; Volume of | | | | |
| | | | AQ phase—119.0 ml | | | | |
| 2 | 30 sec | 50 sec | E-phase: clear; AQ-phase: | n/a* | 12.0 ± 0.5 | 1.165 | 0.1165 |
| | | | slightly hazy; Volume of | | | | |
| | | | AQ—119.5 ml | | | | |
| 3 | 30 sec | 40 sec | E-phase: clear; AQ-phase: | n/a | 12.0 ± 0.5 | 1.105 | 0.1105 |
| | | | slightly hazy; Volume AQ | | | | |
| | | | phase—120.0 ml | | | | |
| 4 | 30 sec | 40 sec | E-phase: clear, slightly | n/a | 12.0 ± 0.5 | 0.895 | 0.0895 |
| | | | yellow; AQ-phase—slightly | | | | |
| | | | hazy, colorless; Vol _{aq} = | | | | |
| | | | 119.5 ml | | | | |
| 5 | 30 sec | 40 sec | E-phase: clear, slightly | n/a | 12.0 ± 0.5 | 1.220 | 0.1220 |
| | | | yellow; AQ-phase—slightly | | | | |
| | | | hazy, colorless; Vol _{aq} = | | | | |
| | | | 119.5 ml | | | | |
| 6 | 30 sec | 40 sec | E-phase: clear, slightly | n/a | 12.0 ± 0.5 | 1.185 | 0.1185 |
| | | | yellow; AQ-phase—slightly | | | | |
| | | | hazy, colorless; Vol _{aq} = | | | | |
| | | | 119.5 ml | | | | |

*n/a means no reading for phosphate concentration.

Table 3 shows that phase disengagement time using 8 wt % K₂CO₃ as the stripping solution was pretty short, usually within 1 minute. However, no phosphate reading can be obtained for any of the aqueous raffinate samples. The results suggest that the phosphate analytical testing method needed to be re-examined. Alternatively, the results suggest that 8 wt % K₂CO₃ might not be strong enough to strip phosphate anions from the loaded E-phase.

### Example 3

This example batch evaluated the LLX process of the present invention using the carbonate loaded E-phase according to the composition listed in Table 1A and two different stripping solutions. Two stripping solutions used were 8 wt % K₂CO₃ and 30 wt K₂CO₃.

Prepared 1 L of phosphate/nitrate surrogate farm water (nitrate enhanced process water—a type of the process water) by using the following procedure:
1. Added the following ingredients to a 1-L beaker, and then brought the volume to 1-L with DI water: 0.0665 g NH₄H₂PO₄, 0782 g (NH₄)₂HPO₄, and 0.0127 g NH₄NO₃.
2. Mixed for about 10 minutes using a magnetic stir disc to ensure that all chemicals are fully dissolved in water. The sample solution (the process water) had a pH of 6±0.5, which meant that there was no need to use any acid to reduce its pH. However, if its pH was above 6.0, 6.0 N HCl acid solution or its equivalent should be used to reduce its pH to 6.0 prior to testing for its phosphate and nitrate levels.
3. Testing the phosphate and nitrate levels in the sample by using various different Orion AQUA fast IV kits.

Prepared 1 L E-phase according to the formula in Table 1A, and then carbonate loaded the E-phase according to the following procedure (this is a scale-up version of Example 1 carbonation process):
1. Transferred 1 L E-phase to a 2 L separatory funnel.
2. Added 500 ml of 8 wt % K₂CO₃ to the E-Phase in the separatory funnel.
3. Shook the flask for about 2 minutes while venting.
4. Placed the funnel on a ring stand to estimate phase disengagement.
5. Transferred the lower aqueous layer into a tared beaker. Recorded net weight, density and pH of the collected aqueous layer.
6. Repeated steps 2-5 for five more times. Observed whether or not there were any changes to the aqueous raffinates with increasing number of contacts with the E-phase.
7. Stored the carbonated E-phase.

Once the E-phase was carbonated, the 1-stage extraction of the surrogate farm water (the process water) was performed using an E/A ratio of 2/1:
1. Mixed 300.0 ml of E-phase with 150.0 ml of the process water for 120 seconds using a stir bar. Recorded the time for about 50% aqueous phase (process water) recovery MO, and for 90% aqueous phase (or the treated process water) recovery (t₉₀).
2. Observation:
   a. t₅₀ was 13 minutes 38 seconds. Observed 3 phases: the top phase was clearly slightly yellow E-phase, the middle phase was cloudy, and the bottom phase was partially clear.
   b. t₉₀ was about 17 hours. Observed 2 separate phases: the top layer was the clear light yellow E-phase, and the bottom layer was clear aqueous phase.
   c. The extracted aqueous phase volume was 49.5 ml; weight was 48.85 g.
   d. The resulting phosphate loaded E-phase had a volume of 94 ml, weight of 73.49 g.
   e. Checked for phosphate concentration using three different Orieon Aqua fast IV methods mentioned below.

Next, performed a one-stage stripping of the phosphate loaded E-phase from the extraction process using an 8 wt % K₂CO₃ solution (the aqueous stripping phase 1). The E/A ratio in this stripping process was 1/3.
1. Measured 20.0 ml phosphate loaded E-Phase and 60.0 ml of 8% potassium carbonate solution.
2. Blended two phases for 120 seconds using a stir bar on a magnetic stir plate. Recorded the time for 50% and 90% aqueous phase recovery. Observation:
   a. t₅₀ was 26 min 10 sec.; three phases were observed at this stage: a clear light yellow E-phase; a clear colorless aqueous phase; and hazy emulsion.
   b. t₉₀ was 2 hours 45 min; two phases were observed: a clear and light yellow E-phase, and a clear and colorless aqueous phase.
   c. PO₄ stripped aqueous phase (with 8% K₂CO₃) was labeled as the stripped aqueous phase 1. PO₄ stripped E-phase had a volume of 20.0 ml and a weight of 16.10 g.
3. Used the ortho-phosphate Hachkit (model PO-19) to determine the phosphate concentration in the resulting PO₄ stripped aqueous phase, and compared it to the unextracted/unstrapped feed solution. Determined the pH of the solution using pH papers.

Next, performed a 1-stage stripping with E/A ratio of 1/3 using the phosphate loaded E-phase with a 30 wt % K₂CO₃ solution (the stripping aqueous phase 2). The E/A ratio in this stripping process was 1/3.
1. Measured 20.0 ml phosphate loaded E-Phase and 60.0 ml of 30 wt % potassium carbonate solution.
2. Blended two phases for 120 seconds using a stir bar on a magnetic stir plate. Recorded the time for 50% and 90% aqueous phase recovery.
   a. t₅₀=3 min 14 sec.; three phases were observed at this stage: a clear light yellow E-phase; a partially clear aqueous phase (bottom); and a hazy emulsion.
   b. t₉₀=6 min 50 sec; two phases were observed: a clear and light yellow E-phase, and a mostly clear with slight haze aqueous phase.
   c. Obtained a PO₄ loaded aqueous phase 2 (with 30 wt % K₂CO₃) and a PO₄ stripped E-phase. The aqueous phase had a volume of 58.0 ml with a weight of 73.57 g. The PO₄ stripped E-phase had a volume of 19.0 ml with a weight of 15.05 g.
3. Used the ortho-phosphate Hachkit (model PO-19) to determine the phosphate concentration in the resulting PO₄ stripped aqueous phase 2, and compared it to the unextracted/unstripped process water. Determined the pH of the solution using pH papers.

TABLE 3A
Extraction and Stripping Results/Observation

| Sample | t₅₀ | t₉₀ | Observation | pH* |
|---|---|---|---|---|
| Extraction of the | 6 min | 11 min | Aqueous phase— | 9.0 ± 0.5 |
| NO₃—PO₄ enhanced | 30 sec | 45 sec | hazy; E-phase— | |
| surrogate process | | | hazy. | |
| water | | | | |
| Stripping of the | 30 sec | 60 sec | Aqueous phase— | 14.0 |
| ion-loaded E-phase | | | hazy; E-phase— | |
| from the NO₃—PO₄ | | | hazy. | |
| enhanced surrogate | | | | |
| process water using | | | | |
| 30 wt % K₂CO₃ | | | | |

*Tested the pH of the aqueous phases from the extraction process and the stripping process.

The aqueous phases from the extraction and stripping processes were then tested for the phosphate and nitrate levels using three different Orion AQUA fast IV methods: Fast IV kit ID#017 with a detection range of 0.75-8.0 mg/L; Fast IV kit ID#012 with a detection range of 0.15-1.5 mg/L; Fast IV kit ID#34 with 0.10-3.0 mg/L. All testing methods used the following procedure:

The aqueous phase sample was transferred to a test tube, and diluted with DI water according to dilution factors listed in Table 3B. Then its pH was reduced to 6.0 with 6N HCl.

TABLE 3B
Phosphate and Nitrate Testing

| | [PO₄] | [NO₃—N] | [NH₃—N] |
|---|---|---|---|
| Run # | (ppm) | (ppm) | (ppm) |
| Fast IV kit ID# | 017 | 012 | 34 |
| Detection range | 0.75-8.0 | 0.15-1.5 | 0.10-3.0 |

The extracted aqueous phase of the enhanced surrogate process water

| | | | |
|---|---|---|---|
| 1 | BLDL* | BLDL* | 1.221 |
| 2 | BLDL* | BLDL* | 1.129 |
| 3 | BLDL* | BLDL* | 1.154 |
| Dilution factor | 4 x | 4 x | 20 x |

The aqueous phase of the loaded stripping solution

| | | | |
|---|---|---|---|
| 1 | 3.417 | 0.225 | 0.017 |
| 2 | 3.410 | 0.210 | 0.000 |
| 3 | 3.286 | 0.228 | 0.000 |
| Dilution factor | 2 x | 2 x | 2 x |

*BLDL referred to below the lower detection limit of the method.

The results in Table 3A show that the phase disengagement using E/A ratio of 2/1 was very good. The phosphate testing method still presented a challenge because the tested values of the phosphate were much lower than the actual phosphate value of the stock surrogate process water. The lower tested phosphate level might be an indication that further stripping of the loaded E-phase was needed. That is, there might be much less phosphate in the loaded stripping aqueous phase than that of the loaded E-phase or that of the surrogate process water. However, it is interesting to note that as the samples became less diluted (with a lower dilution factor for the loaded stripping phase), the methods were able to present higher concentrations of the phosphate and nitrate, indicating that the phosphate testing methods needed to be further evaluated.

### Example 4

This example explored using the stripping process of the present invention to continuously carbonate the E-phase with 8 wt % K₂CO₃. The stripper process was set up according to FIG. 4 after disconnecting the extractor units. The extractant solution must be fully acid stripped of Cl⁻ and then carbonate loaded using 1-25 wt % K₂CO₃ or Na₂CO₃ before being added to the LLX system and process. The process of carbonating the E-phase accomplishes both acid stripping and carbonation at the same time.

The E-phase was prepared according to the formula of Table 1A in Example 1. The system was prepared according to FIG. 4 except the extractor units were disconnected so that the stripper units can be used independently.

The continuous carbonation of the E-phase was performed as follows:
1. Added 8 wt % of K2CO3 to all the strippers until they were ⅔ full. Then started the impeller of each stripper at a speed of about 1,000 ppm as the E-phase flow reached the stripper. Set the internal recycling of each stripper to medium to a maximum flow rate to enable the carbonate to reach the mixers. Set all Y-connectors at the maximum height.
2. Observed overflowing of S1, S3 and S5 after running the system for a couple hours. Adjusted the following parameters to correct the overflowing problem: Balanced the impeller levels, raised the impeller speed to 1300 rpm, adjusted Y-connectors (as shown in FIG. 6), and raised the flow rate to 20 ml/min. (Note: When the flow rate was raised to 30 ml/min, a thick emulsion band was found in S6 settler. The flow rate was then reduced to 20 ml/min.)
3. Checked the pH of solutions in the stripper mixers to ensure the pH was around 11-12. When S2 pH was found to be about 7, removed Y-connector to allow for more aqueous 8% K₂CO₃ to flow into the mixer, which raised pH of S2 to 11. Other stripper's pH can also be adjusted similarly.
4. Checked and re-checked the impeller speeds. The impeller speeds of all strippers should be within the range of 1100 to 1600 rpm to enable smooth running of the system.
5. Turned off the unit. Let everything settle.
6. Emptied the extractant solution. Removed Y connector overflow weirs and pumped 8 wt % K₂CO₃ at 30 ml/min into the system to allow the aqueous solution to move the extractant phase in the stripper to the extractant phase surge tank.
7. Drained the remaining aqueous solution. Used syringes to get liquid out of the tygon tubing. Re-attached the extractor units to the stripper units.

This example showed that the stripper unit of the LLX process can be used to provide a large scale, continuous carbonation of E-phase with 8 wt % K₂CO₃.

### Example 5

This example evaluated various parameters of the continuous flow LLX process using the E/A ratio of 2/1. Solutions were the carbonated E-phase from Example 4, the process water (the NO₃—PO₄ enhanced surrogate farm water) was prepared according to the formula and process of Example 3. The system was set up according to FIGS. 5 and 6. That is, this example continued using the stripper system of Example 4, the scrubber units and the extractor units. The process configuration in FIGS. 5-6 was constructed using clear chemical resistant PVC (CPVC) for the mixer-settler tanks. The mixer tanks had an internal mixer volume of about 185.2 cm³; the internal settler volume was about 435.4 cm³. Clear Tygon tubing (0.25″ I.D.) was used for the piping. Cole-Parmer Instrument Company Master-flex L/S Peristaltic pumps and Dayton AC-DC series motor mixers were used.

The process was started up, operated, and shut down in the following manner.

At start-up, the system was charged with the aqueous solutions first, and each mixer settler of the process was charged up to approximately 50%-75% of its respective volume. The stripping units of the system were initially charged with 30 wt % potassium carbonate (K₂CO₃). Charging the system in this manner caused the extractant overflow receiving compartments to be partially fill-up. After this phase of start-up was complete, the system was ready for the extractant solution.

The extractant solution must be fully acid stripped of Cl⁻ and then carbonate loaded (1-25% K₂CO₃, preferably 15% K₂CO₃), before being added to the LLX process. Other types of carbonate solutions can be used, such as Na₂CO₃. The processes of acid stripping and carbonate loading can be done in one carbonation process because the carbonate ions will replace and strip chloride ions in the extractant solution. In this example, the 8 wt % K₂CO₃ was used.

Although the introduction of extractant solution is best achieved at the pilot and commercial scale levels using pumps, at the bench/lab scale such as this example, the introduction was quickly achieved in this example by manually pouring the extractant solution into the mixer-settlers to fill up ⅔ of their chambers. After charging the liquid-liquid extraction circuit with a sufficient volume of the extractant solution, enough extractant solution needed to be left in the surge tank so that the process needs were met during the normal operation. The total volume of the extractant solution surge tank should be designed large enough so that it did not overflow during the operation of the liquid-liquid extraction process and can be charged with the extractant solution when the system is shut down between operations. The steady-state volume of the extractant solution in the surge tank was then monitored visually or electronically with level switches. This was done periodically so that the extractant solution surge tank volume can be adjusted as needed to maintain a sufficient amount or volume of the extractant solution to provide steady operation over extended periods, for example days, weeks, months and possible years. The stirrers for the mixers were then powered up, adjusted and maintained at steady-state by the following procedures.

All of the mixers were set between 700-1900 rotations per minute (rpm). The mixers needed at least 15 minutes to warm up, preferably 30 minutes. During this time the mixers were monitored and adjusted, such as decreasing the rotation rate in order to avoid excessive mixing. Excessive mixing was very undesirable. It can lead to problems such as spatter as well as the formation of fine emulsions that may be stable or that require longer phase coalescence time in the settlers. Although any type of stirring can be used if it is sufficient enough to mix the solution, medium to low viscosity immiscible fluids, disk or fin type stirrer pumps are preferred. The preferred stirrers are designed to pull the two fluids, aqueous and extractant solution, into the mixing compartment from the upstream mixer settlers. The shearing blades of the mixers generate micro droplets that create a very high interfacial surface area that is critical to fast contaminant extraction and strip kinetics. Higher mixing speeds accommodate a shorter residence time of the fluid in the mixer and compensated for extractant/aqueous ratios other than 1:1. Excessive mixing is acceptable but is less preferred if the resultant emulsion formed requires slow mixing for longer periods of time to disengage and break into separate phases due to exceedingly fine droplet size. In this example, a slotted disc stirrer was used.

Mixing conditions preferred by the invention is about 1 to 30 minutes, preferably 1 to 15 minutes, and most preferably 45 seconds to 90 seconds. The total hydraulic fluid residence time in the mixer and the settler necessary for this process should be 10 times that amount or approximately 15 minutes. Overall, the residence time and mixing shear should be appropriate for phase separation, and they might be dependent upon the equipment size, and flow rates of the feed solution and the extraction phase.

After this initial loading of strip solutions and the warm up time for the mixers were both complete, the system was now ready for the charging of the surrogate farm water (the process water) and the extractant phase feed streams (E-phase). The process water flow rate and the E-phase flow rate were normally set to 10 ml/min and 20 ml/min at the start-up. Then the flow rates were adjusted to be either higher or lower during the operation so long as the E/A ratio for the extraction stage was maintained at 2/1. For example, if the flow rate of the process water was 10 ml/min, then the flow rate of the E-phase was 20 ml/min, resulting in an E/A ratio of 2/1. Occasionally, the flow rates were set at lower rates at the start-up to avoid excessive emulsion formation. Preferably, the system can be increased to 20 ml/min and 40 ml/min aqueous flow rate and E-phase flow rates respectively, while maintaining the E/A ratio of 2/1 for the extractant stage. The lowest flow rates for the E-phase and the process water were 6 ml/min and 3 ml/min respectively. The flow rates were adjusted to avoid issues such as overflow, pluggage, and slow phase disengagement. The extractant surge tank for this process was a 4 L clear chemical resistant PVC tank.

The extractant phase contacted the process water first during the anion or ion extraction stage and then had anion/ion stripped with potassium carbonate (30 wt % K₂CO₃). The extractant phases flow scheme is also illustrated in FIG. 5.

Once the extractant had enough time to cycle through the system at least once, approximately 80% of the extractant phase stayed within the system and the remaining 20% stayed in the surge tank. Occasionally the system must be put in idle mode (standby) until certain control issues can be adjusted, any chemical additions can be added, or any maintenance issue can be addressed. When this was done, all of the feed pumps were shut off and the mixers were allowed to continue to circulate the process fluids. For example, the process was in standby for the following reasons: extractant feed levels were running too low, giving time for emulsions in the E1 and E2 settlers to break, leakage in the tubing, stripper overflows, etc. Once the process was said to have reached steady-state, about 2-8 hrs, data readings can be collected and sampling can now take place.

Ammonium Ion Removal:

About 3-5 hours after the start-up, an acid solution such as 25 wt % phosphoric acid was added to the mixer and settler in scrubber 1. Then, the tygon tubing from E1 and E2 mixers was attached to Scrubber 1 mixer. Argon gas was turned on to create bubbles in E1 and E2 to absorb the ammonia gas, which was transferred to the scrubber unit to be recovered as ammonium ions or as phosphonic acid.

For the samples taken from the E1 and E2 mixers/settlers, pHs were found to be in the range of 9-10, mostly in the range of 9.5±0.5; the impeller speeds were set in the range of about 1,000 to about 2,100 rpm. For the samples taken from the S1-S6 mixers/settlers, pHs were found to be in the range of 11-13 mostly; the impeller speeds were set in the range of 1100 to 1800 mostly; and the E/A ratios were found to be within the range of 3/1 to 1/20. Sometimes, when the pH of one stripper fell to 7, the Y-connector weirs were adjusted to let in more aqueous stripping solution to raise the pH of that stripper. Other adjustments can also be made to increase the pH of the stripper: increasing internal recycling, increasing rpm of the impeller, reducing or increasing flow rates of the aqueous feed/stripping solution or E-phase; and increasing heights of one or more Y-connector weirs.

During the operation, it is desirable to keep the interface in the settler (see FIG. 6) to be at or higher than ⅓ of the height from the bottom of the settler, but at or lower than ⅓ of height from the top of the settler. Therefore, the interface should be within the middle third portion of the settler height. The interface height usually corresponded to the height of the Y-connector weir. So the interface height was adjusted by adjusting the height of the Y-connector overflow weir (also called Y-connector o/f weir or y weir or Y-connector weir).

Two types of emulsions were observed at the settler of the extractor (see FIG. 6): a big layer of initial emulsion located close to the mixer, which broke into three phases—the top E-phase, the middle interface or a thin middle emulsion layer, and a bottom aqueous phase. So the interface might also contain a small or thin band of emulsion. While not wishing to be bound by theory, it is presently understood that the initial emulsion near the extractor mixer was composed mostly of unstable emulsion colloids, while the later small emulsion band at the interface near the extractor overflow weir was composed of more stable emulsion. The unstable emulsion near the mixer was believed to enable the extraction of ions, such as phosphate anions, from the process water to the organic E-phase. However, the stable emulsion band near the overflow weir at the interface was mostly referred to as the RAG layer, which was currently believed to be composed of mostly E-impurities. Usually, the stable emulsion band took a long time to accumulate, such as 30 hrs of running or more. After the emulsion band started to grow, it might be desirable to remove the emulsion by letting the emulsion flow out along with the exiting E-phase. This was accomplished by lowering the overflow weir and/or raising the interface height.

At one run, a clear E-phase was formed in the E1 settler, but it did not reach the overflow weir. Therefore, no loaded E-phase can flow over the weir to be transferred to the stripper. The E1 overflow weir was lowered so as to allow the separated loaded E-phase to flow over it to get to the stripping stage or to the E2 stage.

At the end of this test about 20-33 liters of the NO₃—PO₄ enhanced surrogate farm water (the process water) had been used over the course of approximately 94-95 hours.

During the process of this example, E1 settler was often filled with emulsions, which just appeared to start breaking into separate phases. In E2 settler, the emulsion disappeared, and there was a large layer of E-phase and a small layer of the aqueous phase (the treated process water). The results and observation suggest that (1) the extractor E/A ratio should be increased from 2/1 to 3/1 to avoid or reduce stable emulsion problems; (2) a longer residence time in the extractor settler; and (3) minimizing excessive mixing shear.

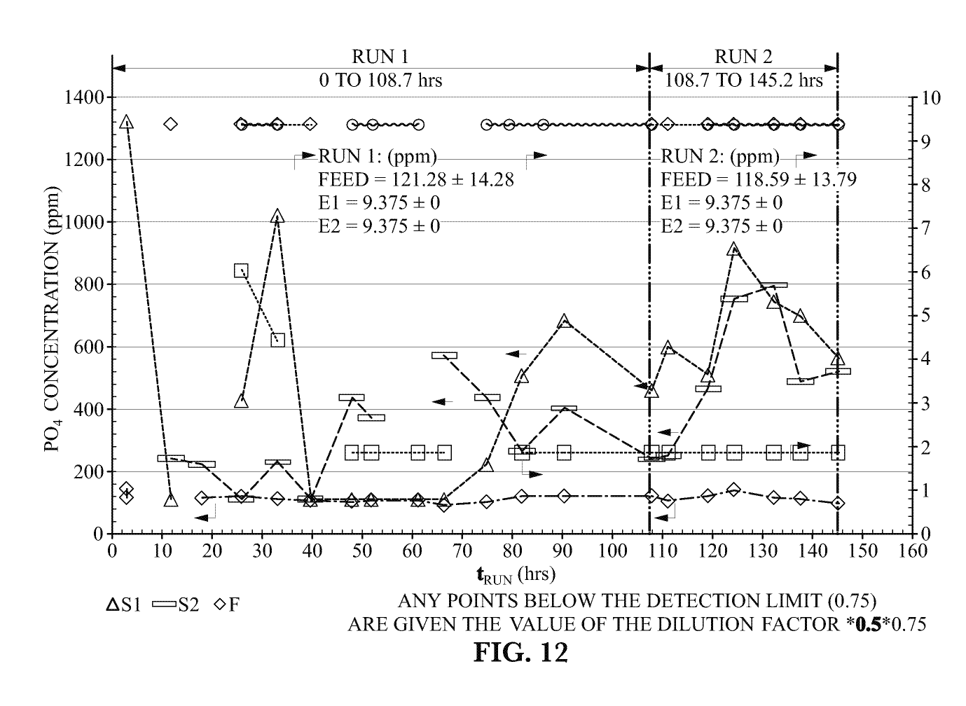

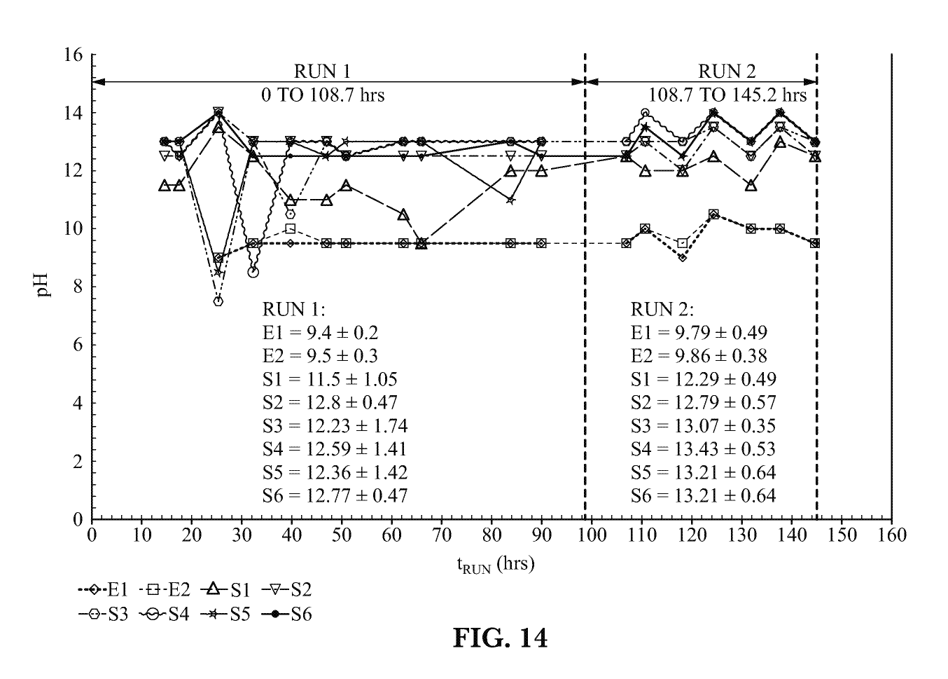

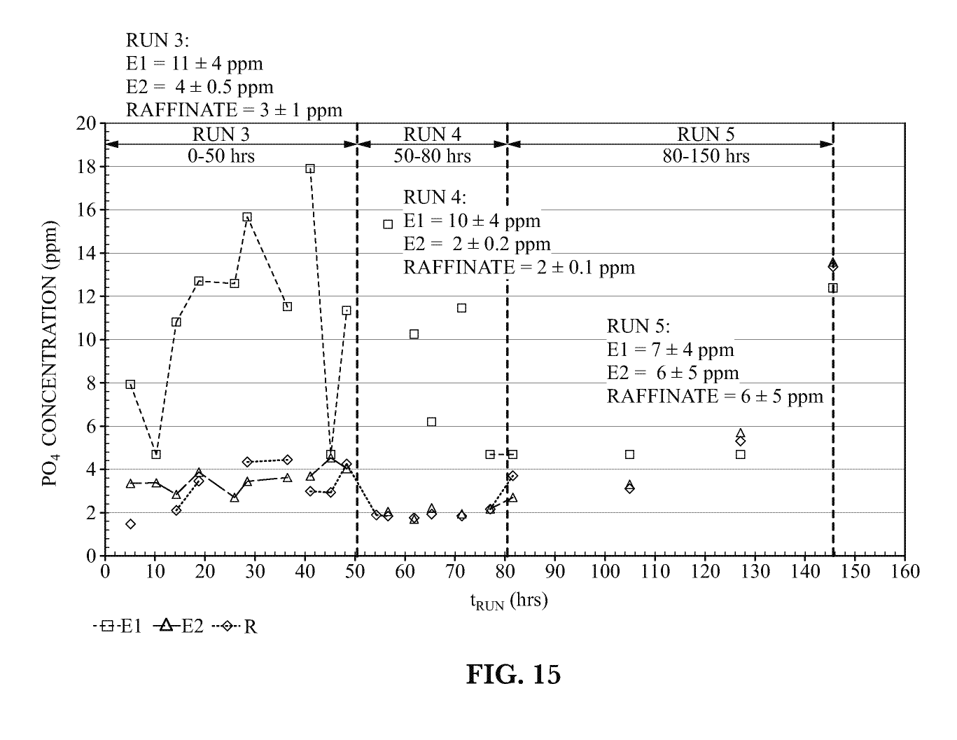

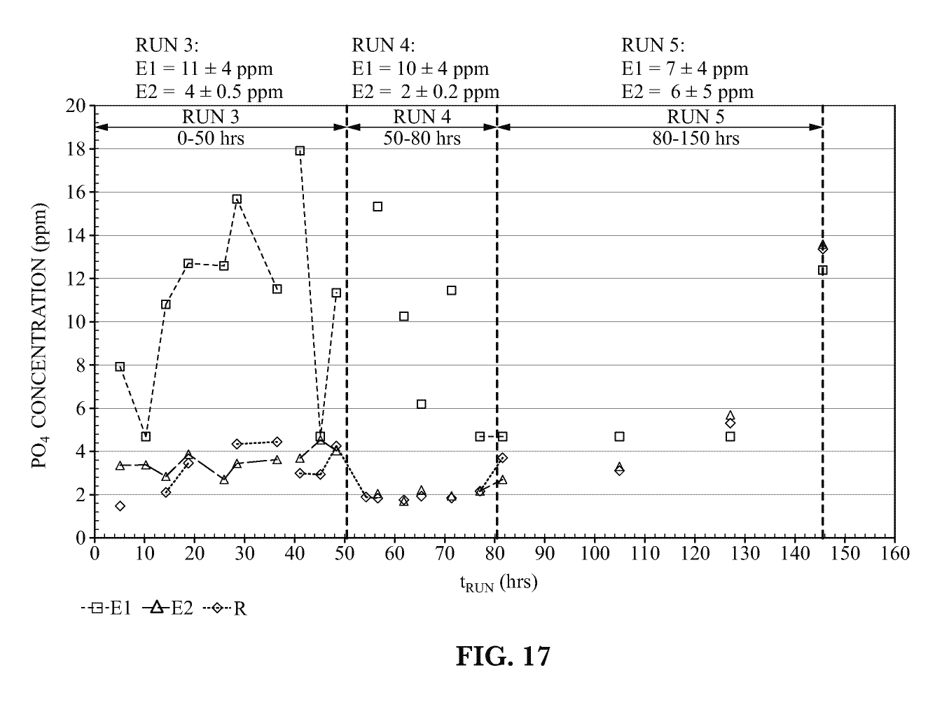

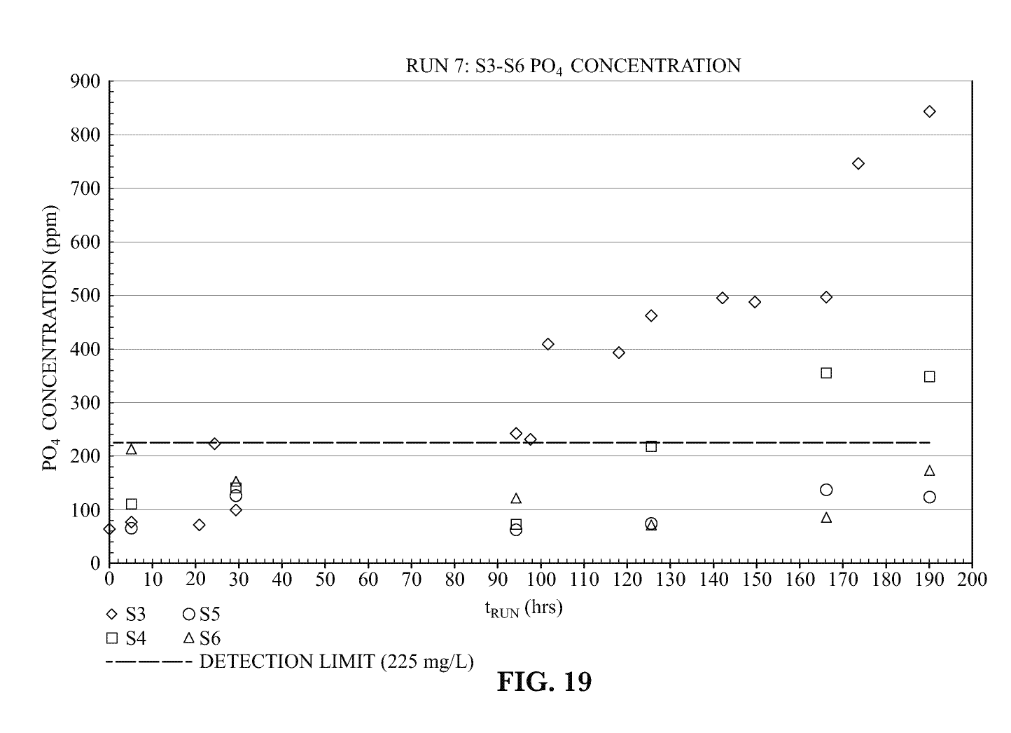

The process was separated into seven separate continuous flow runs, Runs 1-7. During these runs, samples were taken from the process water, the raffinate (the treated aqueous solution), E1, E2, S1, S2, S3, S4, S5, and S6 were tested for phosphate level. The phosphate testing used the procedure listed in Example 12. The phosphate concentration data were collected in FIGS. 12-13 and 15-19. FIG. 14 shows the pH profiles of the extractors and strippers over time for Runs 1 and 2.

The aqueous process water was the surrogate process water with 112 ppm PO₄ or P(o-PO₄) (total orthophosphate). The results from FIGS. 12-13 and 15-19 demonstrate that phosphate removals from the aqueous process water remained very high throughout all seven runs, varying from about 90% to about 99%. Two extraction stages were needed because only about 82% phosphate extraction was found by the E1 extractor only.

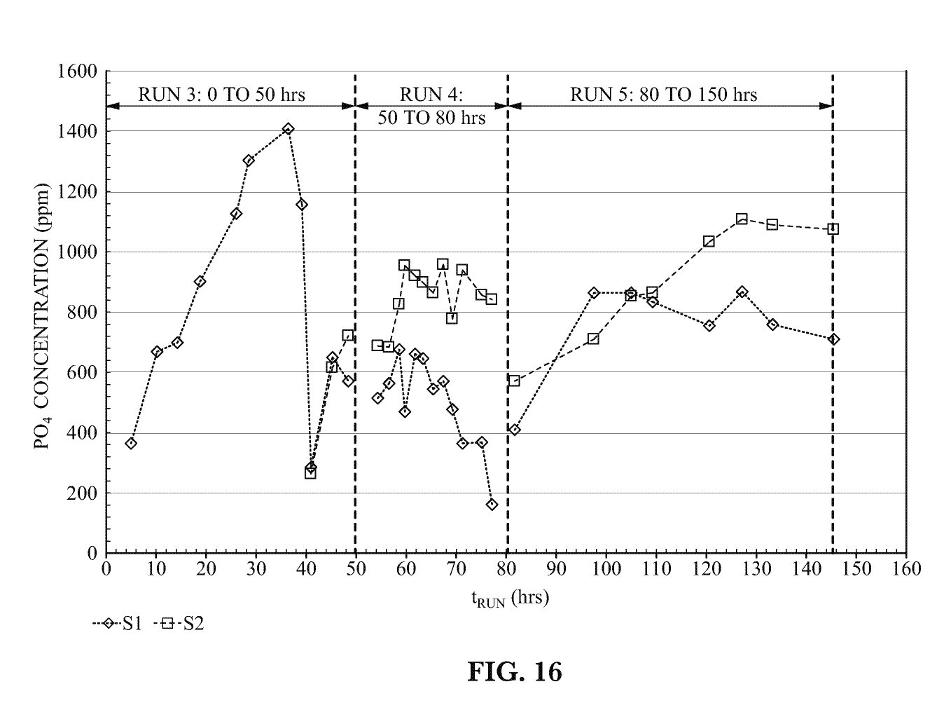

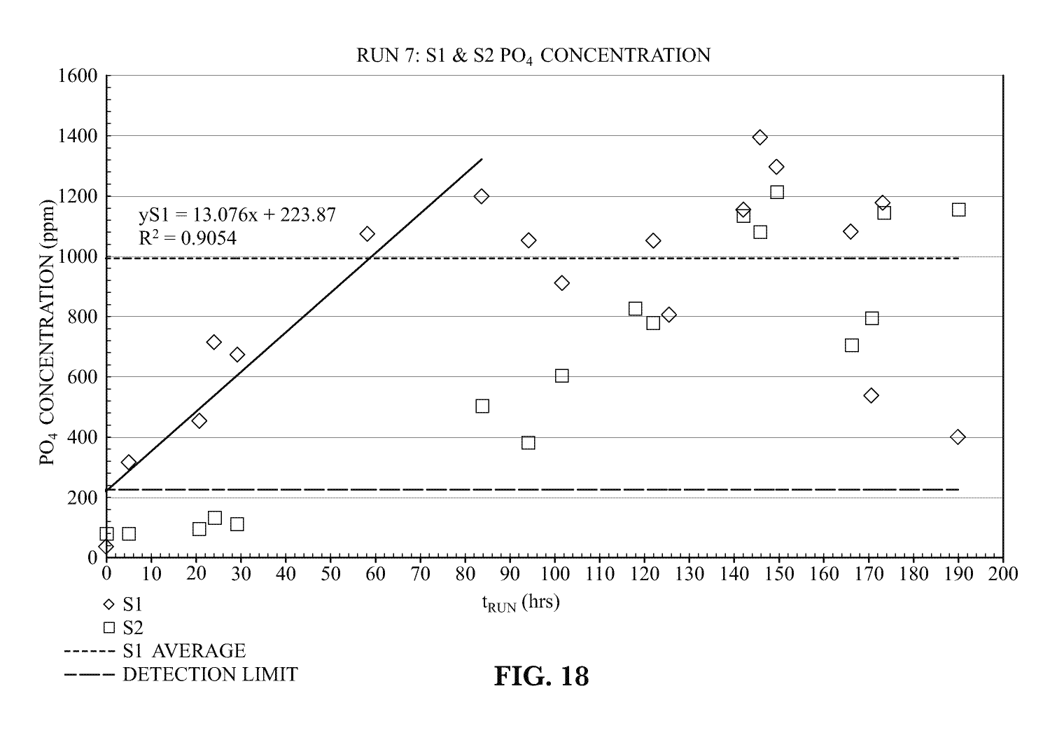

The maximum phosphate concentration in the recovered phosphate concentrate product was 1400 mg/L for the conditions tested (see FIGS. 16 and 18). However, the maximum phosphate concentration in the product was achieved in Runs 3 and 7, while during the rest of time in Runs 1, 2, 4, 5, and 6, the phosphate concentrations varied mostly between 1,000 mg/L and 1,200 mg/L. The P—PO₄ values was continuously found to be low in the extraction raffinate, and the stripper units were accumulating phosphate anions initially and then leveling out at a certain level. The evidence indicates that phosphate anions might be migrating across the strippers because the phosphate concentration in the loaded stripping solution leveled off at 1400 mg/L or remained mostly at 1,000 mg/L (ppm). Although this level of the phosphate concentration is adequate for some applications, it might not be sufficient for other applications. Therefore, it is desirable to find what prevents further accumulation of the P—PO₄ in the raffinate in various stripping stages.

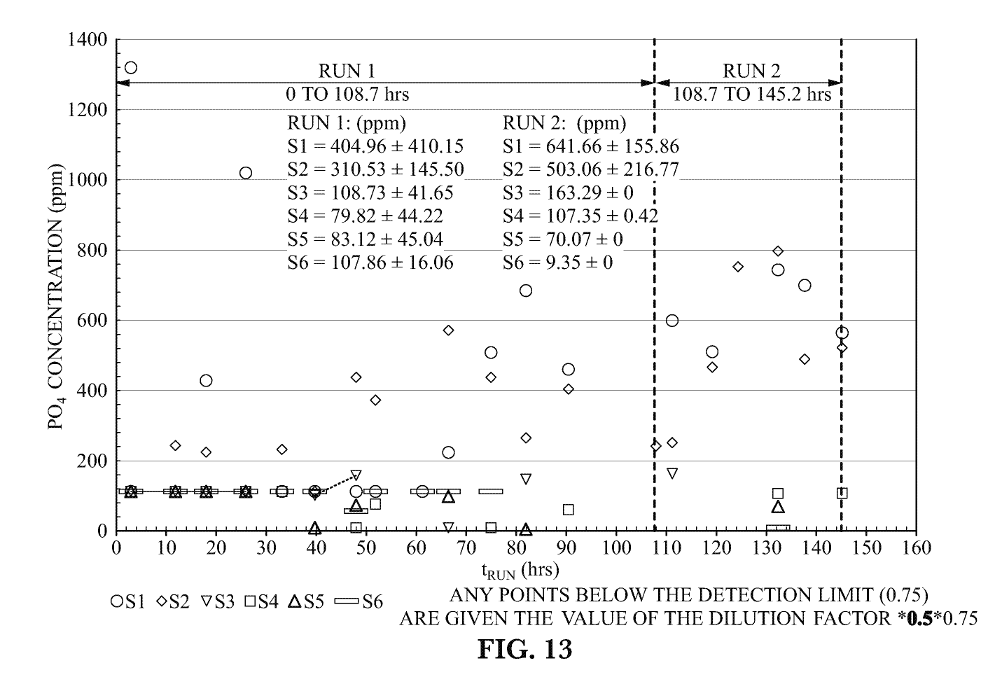

The cause for this phosphate anion migration from stripper to stripper was believed to be due to competitive ion exchange and pH variance in the strippers. Therefore, analysis of the pH values collected during the LLX process was done by constructing pH profiles of extractors and strippers over time for Runs 1 and 2. FIG. 14 showed that for Runs 1-2, the pH for the extractors was in the range of 9.5 to 10.0; while the pH for the strippers was in the range of 11.5 to 13.4. Sometimes, S1 pH dropped to as low as 11.5 while pH of other strip stages remained higher at 12.3 to 13.4. Comparing the pH profile to the phosphate concentration data in FIGS. 12 to 13, it was found that as the pH dropped in S1, the phosphate values also dropped correspondingly. Therefore, the results suggested that controlling or increasing the pH of the stripping stage can resolve this migration problem and allow the phosphate concentration in the final product to be increased.

Nitrate ion (NO₃⁻) extraction was high; however, there were analytical issues related to detecting the nitrate ion in the 30 wt % K₂CO₃ stripping solution using the slow assay method available. Therefore, the nitrate ion concentration results were qualitative at this example. Nevertheless, about 9 ppm nitrate ion was found to be removed from the surrogate process water. It was believed by increasing the pH in the stripper, the concentration of the nitrate might increase in the final product, which would make the testing of nitrate ions easier. Further, the results suggest that a more dilute extractant formulation could be used to make stripping easier. In this example, the more dilute E-phase might also shorten the E-phase settling time in the extractor settler substantially, and thus increase the processability and the throughput rate of the present LLX method.

### Example 6

This example examined various extractant formulations and their effects on the phosphate removal of the NO₃—PO₄ enhanced surrogate farm water (the process water). The process water was prepared according to the formulation and the procedure of Example 3. Using the Stat-Ease software, a SDT (Statistically Designed Test) run sheet was prepared to evaluate the compositions of the E-phases. Two factors were used: one was the Aliquat percentage in weight, and the other was the E/A ratio over the range of 1/1 to 3/1.

The three E-phase formulations were tested: 9.1 wt % Aliquat (Sample A), 5.01 wt % Aliquat (Sample B), and 0.91 wt % Aliquat (Sample C). The formulations were washed with 8 wt % K₂CO₃ a couple times to put the E-phase into the carbonate ion form while simultaneously remove the chloride ion impurities originally presented in the Aliquat. Excess and/or entrained potassium carbonate was rinsed away from the carbonate-loaded E-phase by using DI water. At the end of the washing process, the mixture was centrifuged to separate the aqueous phase (the treated process water) from the washed E-phase. Then, the washed E-phase was titrated for the total carbonate ion concentration in the washed E-phase using the standard acid and methyl orange indicator. The indicator would also be used in later examples to ensure that the recycled E-phase from the surge tank contained the same composition as the freshly prepared E-phase.

The procedure for using the methyl orange indicator is listed below:
1. Added 50.00 ml of 0.1 N NaCl solution to a beaker via a graduate cylinder.
2. Added 25.00 ml of the carbonated E-phase to the beaker.
3. Filled a burette with 0.1 N HCl solution (pH about 1.0±0.5).
4. Placed a pH electrode at the bottom of the beaker so that it was submerged in the aqueous phase.
5. Used a stir bar to mix the solution in the beaker while adding several drops of methyl orange indicator.
6. Performed the titration and recorded the data.

The titration results can also be used to calculate the concentration of Aliquat in the E-phase. In this example, the methyl orange indicator testing results show that the weight percentage of Aliquat 336 for Sample A was 6.31 wt % instead of 9.1 wt % as previously expected. A further evaluation on the composition of the E-phase showed that the concentrations of the three solutions were 6.31 wt % Aliquat, 1.99 wt % Aliquat, and 0.631 wt % Aliquat 336.

### Example 6A

This example continued to evaluate the various extractant formulations and their effects on the phosphate removal of the nitrate-phosphate ions (NO₃—PO₄) enhanced surrogate farm water (the process water). Based on the results from Example 6, the Aliquat 336 weight percentages were set in the range of 0.631 wt % to 6.31 wt %. The process water was prepared according to the formulation and the procedure of Example 3. Using the Stat-Ease™ software, a randomized SDT run sheet was prepared and executed to evaluate the composition of each E-phase. Two factors were evaluated: one was the Aliquat percentage in weight, and the other was the E/A ratio ranging from 1/1 to 3/1. The three Aliquat percentages were used: 0.631 wt %, 1.99 wt %, and 6.31 wt %.

Aliquat 336 was obtained from GFS chemical, item #3383. Solvent 467 was obtained from Superior, Inc. with a Master Product Code #011006. Calumet 400-500, Calumet LVP 100, and Calumet 420-460 from Calumet Specialty Products Partners, LP can also be used in place of Solvent 467.

TABLE 6A-1
E-phase Formulation Study

| | Aliquat | 467 | Exxal | Log (wt % |
|---|---|---|---|---|
| | 336 | Solvent | 10 | Aliquat |
| | (wt %) | (wt %) | (wt %) | 336) |
| Sample A | 6.31 | 89.19 | 4.5 | 0.800 |
| Sample B | 1.99 | 93.51 | 4.5 | 0.300 |
| Sample C | 0.631 | 94.869 | 4.5 | −0.199 |

Then, the E-phase formulation refinement testing was performed according to the parameters listed in Table 6A-2. The batch extraction procedure was carried out according to the procedure listed in Example 11. The testing included a total of 11 runs. A 10 ml of aqueous phase from each run sample, including the process water, was taken and analyzed for phosphate content. Each sample was clarified using a Serum Acrodisc 37 mm syringe filter with GF/0.2 micron Super Membrane. The sample was then diluted accordingly with DI water: the process water was diluted 50× (diluting 0.5 ml to 15 ml with DI water); the other samples were diluted 12.5× (diluting 2 ml to 25 ml total with DI water). To the diluted sample, about 25 ml of 6 N HCl was added to bring the pH to 7 for the diluted sample. The resulting sample was tested for phosphate content using Thermo Scientific Orion AQUA fast IV AC4095 method, ID code 017 (see Example 3). The phosphate content for each sample was retested in a few days by another person.

The results from Table 6A-2 show that the extraction runs with Sample A (0.631 wt % Aliquat) consistently produced aqueous raffinate samples with the highest phosphate content. In addition, for different E/A ratios (1/1 and 3/1), the phosphate contents in the aqueous raffinate samples from Sample A—process water did not vary significantly, according to the first set of phosphate concentration data. However, when the E/A ratio increased, the respective phase disengagement time (t₅₀ and t₉₀) increased significantly, from 10 seconds to 1.20 minutes. Still, the time needed for phase disengagement using E/A ratio of 3/1 was still very short, much less than the allowed 30 minutes. Therefore, the next example should probably start with an E/A ratio of 2/1, and then if necessary, the E/A ratio can be adjusted to 3/1.

TABLE 6A-2
SDT Run Sheet for E-phase Formulation Testing

| | | Factor 2 | | | | | | | | [PO4]_{aqueous} |
|---|---|---|---|---|---|---|---|---|---|---|
| Run | Factor 1 | _{(log (Aliquat} | | | | | | Volₜₒₜₐₗ | [PO4]_{aqueous} | * |
| # | _{(E/A )} | _{wt %%))} | t₅₀ | | t₉₀ | | pH _{Raffinate} | (ml) | (mg/L) | (mg/L) |
| 1 | 2 | 0.300 | | | 10 | sec | 10.0 ± 0.5 | 100 | 0.836, 1.005, | 4.875 |
| | | | | | | | | | 0.640 | |
| 2 | 3 | 0.800 | | | 1.20 | min | 10.0 ± 0.5 | 130 | 1.196, 1.036 | 7.325 |
| 3 | 3 | 0.800 | | | 1.20 | min | 10.0 ± 0.5 | 130 | 0.534, 0.820 | 14.638 |
| 4 | 2 | 0.300 | 1.06 | min | | | 10.0 ± 0.5 | 100 | 0.410, 0.292 | 9.713 |
| 5 | 1 | −0.199 | | | 53 | sec | 10.0 ± 0.5 | 70 | 0.732, 0.969 | N/A |
| 6 | 3 | −0.199 | | | 61 | sec | 10.0 ± 0.5 | 130 | 0.432, 0.344 | 3.988 |
| 7 | 1 | −0.199 | | | 10 | sec | 10.0 ± 0.5 | 70 | 0.858, 1.051 | N/A |
| 8 | 1 | 0.800 | | | 10 | sec | 10.0 ± 0.5 | 70 | 0.695, 1.475 | 13.138 |
| 9 | 2 | 0.300 | | | 60 | sec | 10.0 ± 0.5 | 100 | 0.296, 0.869 | 5.750 |
| 10 | 1 | 0.800 | 7 | sec | 10 | sec | 10.0 ± 0.5 | 70 | 0.979, 1.099 | 13.900 |

| | | | | | | | | |
|---|---|---|---|---|---|---|---|---|
| 11 | 3 | −0.199 | 50 | sec | 10.0 ± 0.5 | 130 | 0.128, 0.168 | 2.700 |

| | | | | | | | | |
|---|---|---|---|---|---|---|---|---|
| Feed | — | — | — | — | — | — | 6.067; 7.310 | — |
| soln | | | | | | | | |

* The samples were retested for phosphate contents using the same method by another person.

### Example 6B

The example evaluated the effect of using E/A ratio of 3/1 and an E-phase with 0.631 wt % Aliquat 336. The enhanced surrogate farm water (the process water) was prepared according to the formulation and procedure of Example 3. The batch extraction process was also performed according to Example 3 with a mixing speed of 220 rpm. The process was repeated three times, resulting in three batch samples.

The t₅₀ was about 45 seconds to 62 seconds; t₉₀ was about 89 to 105 seconds. The total separation was achieved in 4.5 minutes to 30 minutes. The pHs of the aqueous raffinate samples were the same, 10.0±0.5. The total volume was about 130 ml. The phosphate level for each batch sample was tested using the Orion AQUA fast IV Id 017. The phosphate concentrations of the resulting aqueous raffinate sample ranged from 5.454 ppm to 6.684 ppm after about 1.25× to about 1.47× dilution. The phosphate concentration for the process water was about 1.875 to 2.029 ppm after 50× dilution.

The results from this example show that the E-phase containing 0.631 wt % Aliquat 336 can extract a significant amount of phosphate from the process water using an E/A ratio of 3/1.

### Example 7

This example evaluated the effect and the parameters of a continuous flow liquid to liquid extraction and stripping (LLX) process using an E-phase with 0.631 wt % Aliquat 336. In the first run, the E/A ratio was initially set at 2/1, but later was raised to 3/1. Then the process was repeated at a E/A ratio of 3/1 while maintaining the other process parameters.

The enhanced surrogate farm water (the process water) was prepared according to the formulation and the procedure of Example 3. 5 gallons of the E-phase with 0.631 wt % Aliquat 336 was prepared according to the formulation in Table 6A-1. The E-phase was then carbonated with 8 wt % K₂CO₃ using the stripping portion of the LLX equipment and process, according to the procedure of Example 4. The carbonated E-phase was washed with DI water using an E/A ratio of 2/1 to get rid of entrained water soluble ions. The water washing process was performed according to the batch extraction process of Example 3: The E-phase and DI water were mixed for 120 seconds, and the mixture was let sit to allow for phase disengagement. The washing was repeated twice for the same E-phase.

The methyl orange indicator test was performed on the un-carbonated E-phase, carbonated but unwashed E-phase, and carbonated washed E-phase. The results show that the composition of E-phase remained the same through the different treatments.

The pH electrodes and controllers were calibrated by using a conventional commercial pH buffer solution and Oaktron pH meters.

Prepared the continuous flow multi-stage mixer-settler based LLX unit for start-up, and set up the impellers in the mixers. Turned on impeller, and allowed the equipment to warm up for 10 minutes. Checked all tubing connections, and then turned on the pumps. Set the initial flow rates of the E-phase and the process water to 6.0 ml/min and 3.0 ml/min respectively. Accordingly, the initial E/A ratio for the extractors was about 2/1.

The continuous flow LLX process was operated according to Example 5 except (1) adding 45 wt % KOH to the stripper units to maintain the pH of the stripper units; (2) using “triple long” U shape extractor settler (E settler) to introduce a longer residence time in the E settlers; (3) introducing coalescing agents to the E settlers to promote phase disengagement; and (4) minimizing excessive mixing shear (excessive rpm) in the mixer. In the settler department of the extractor, a higher shear such as centrifuge, hydroxyclones, pressure filters and the likes were preferred to promote a faster phase disengagement. Coalescing agents included defoaming agents such as silicone glycol etc., and the like.

The purpose of adding KOH solution was to increase the concentration of the ortho-phosphate products and to increase the stripping efficiency of the process (see FIG. 3). A pH control system was installed on the system (the LLX unit) to track changes in pH and to maintain a relatively constant pH in the stripper through the regulated delivery of KOH. The pH control system consisted of an electrode, which measured the pH of the strip solution, and a pH controller that activated a pump to add KOH solution to the stripper based on the variation in pH.

To shorten the time needed to start-up and reach steady state, stopped the flow rate of the process water and used 1% NaHCO₃ solution to charge the extractors: the 1% NaHCO₃ solution was added to E2 mixer and settler until the compartments were ½ full of the aqueous phase. A 1% NaHCO₃ solution was used to dissolve and get rid of organic impurities in E-phase, which prevents or at least minimizes the concentration of such impurities. It was also used to reduce the permanent emulsion (“CRUD”) layer at the later portion of the E-settler (see FIG. 6). After running for about 50 minutes, the E2 extractant settler trough was overflowing. Reduced the flow rates and the impeller speeds, and then changed the E/A ratios to 3/1 from 2/1 by changing the flow rates of the E-phase and the process water to 9.0 ml/min and 3.0 ml/min respectively. The system was running smoothly thereafter, and only minor adjustments were needed, such as increasing the impeller speeds in the S1 mixer.

For the first run, in which the E/A ratio in the extractors was raised from 2/1 to 3/1, the following were the results: The E/A ratio in S2 was 1/4, and the E/A ratio for S1 was 1/3. The pH for E1 and E2 was in the range of 5-6. The pH for the strippers was about 13. The impeller speeds were in the range of 1100 to about 1800.

The LLX process was repeated for a run of about seven hours using the same E-phase with an E/A ratio of 3/1. The system was shut down for 1 hour to allow the emulsion in E1 mixer and settler to break. After 1 hour, the white emulsion broke by 50%. Otherwise, the system was running smoothly. After running for a couple hours, the internal recycling lines were opened on the six strippers to allow more aqueous solution into the mixers. The E/A ratio in S2 was 1/4, and the E/A ratio for S1 was 1/3. The pH for E1 and E2 was in the range of 6-9. The pH for the strippers was about 13. The impeller speeds were in the range of 1100 to about 1800. Data confirmed the NO₃⁻ and NO₂⁻ removal.

The data from two runs of this example show that the combination of E-phase with 0.631 wt % Aliquat and the 3/1 E/A ratio produced a good process condition for the present invention. A longer residence time using the optional “triple long” U-shaped E settlers appeared to improve phase disengagement. Although the feed rates were still very slow, but still acceptable for commercial uses because farms typically produce small or moderate water flow rates. Higher flow rates are more desirable because the faster the flow, the lower the process cost estimate for 1,000 gal water purified using this device. It was thought that the slow phase breakage in this example was caused by suspended particles, such as feed straws, which can be filtered out easily. Pre-coagulation and flocculation of these particles would make them much easier to be separated out.

### Example 8

This example evaluated the effect and the parameters of the optimum test conditions found in the previous designed experiments (Example 7) by using a continuous flow LLX process. The apparatus of Example 5 (FIGS. 4-5) was used. In addition to what was described in Example 6, the settlers of the extractors in this example were changed to a U-shape with an enlarged internal volume of about 2240 cm³ to allow for more settling time (see FIGS. 7-8). Two extractors were used in a counter-current fashion: E1 and E2. The “U” shape of the settler forces two gentle 90° turns in the flow pattern of the emulsion as it breaks into two separate phases, promoting phase disengagement. This design also shortens the length of the equipment and reduces the space needed for the equipment.

An E-phase with 0.631 wt % Aliquat was prepared according to the formula listed in FIG. 6A-1 and was carbonated with carbonate ions (CO₃²⁻) according to the procedure in Example 4. Carbonation in the present invention refers to the process of treating a liquid with carbonate ions, CO₃²⁻, which is a strongly basic anion. The carbonated E-phase was titrated using the methyl orange indicator method specified in Example 6. From the titration results, it was determined that the extraction phase required further carbonation treatment because the pH of the E-phase was low, about pH 8.5. At this pH, the E-phase was composed of about 50% carbonate ions and about 50% bicarbonate ions. The pH should be around pH 13 or greater to ensure that the E-phase was 100% carbonate (CO₃²⁻) loaded.

The E-phase was further treated with 45 wt % KOH solution by using the stripping units of the continuous flow LLX process after un-attaching temporarily the loaded feed unit from the extractor units. The 45 wt % KOH solution was added to the settlers until they were about ⅔ full. Then, the E-phase was introduced into the process at 20 ml/min flow rate, which later was increased to 30 ml/min. The actual flow rate of the E-phase can be varied depending on the system capability and the residual P and N requirements for the purified water. The pHs of the strippers were then checked to ensure that the pH did not fall below 13.0. If the pH dropped below that level, more 45 wt % KOH was added to the stripper mixers at a 2 ml/min flow rate. However, other flow rates can also be used.

After the E-phase had been through all six strippers, a sample of the E-phase was collected for the nonaqueous titration method using the methyl orange indicator so as to ensure the E-phase was sufficiently carbonated. Foaming was observed in the S2-S5 settlers due to the high mixer speeds. Foaming is a condition typically occurred in newly start-up LLX systems, usually at the laboratory scale, as the mixers warm up. At the commercial scale, the foaming can be prevented or reduced by using constant rpm mixers. The mixer speeds were reduced from 2200-2500 rpm to the most preferred 900-1100 rpm rate, and the system ran well thereafter with only minor adjustments needed. The 2200-2500 rpm stir rate can still be used for highly ion concentrated aqueous phases in the strippers because of the “salting out” effect well known to those skilled in the art of such immiscible liquid blends.

After all of the E-phase ran through the system, each stripper was drained and then optionally cleaned with DI water. After the KOH treatment, the pH of the E-phase was ≧14.

Next, the NO₃—PO₄ enhanced surrogate farm water solution (the process water) was prepared according to the procedure listed in Example 3. However the composition of the surrogate farm water differed from that of previous examples slightly to ensure 50 mg PO₄³⁻ came from NH₄H₂PO₄, 50 mg PO₄³⁻ came from (NH₄)₂HPO₄, and 9 mg of NO₃⁻ came from NH₄NO₃: 0.0123 g NH₄NO₃, 0.0604 g NH₄H₂PO₄, and 0.0694 g (NH₄)₂HPO₄. Therefore, the surrogate farm water (the process water) should contain 100 mg phosphate anions and 9 mg nitrate ions per liter. This process water was re-prepared in a larger scale (16 L instead of 1 L) during the continuous flow bench scale LLX runs. The pH of the process water was about 5.5 due to the buffering effect of the phosphate ions.

The continuous flow LLX operating process was the same as that of Example 7 with the E/A ratio for the extractors being about 3/1. This E/A ratio was based on the flow rates of the E-phase and the process water. During the operation, when the flow rate of the extractant phase was changed according to Table 8, the flow rate of the process water was also changed in response to maintain the 3/1 E/A ratio. For example, when the flow rate of E-phase increased to 30 ml/min from 18 ml/min, the flow rate of the process water increased to 10 ml/min from 6 ml/min, maintaining the 3/1 E/A ratio. The flow rates were adjusted to enable the system to run more consistently and/or more cost efficiently, such as when an overflow was observed.

During the operation, the actual E/A ratio data were obtained from samples near the center of the mixer chambers for the extractors and the strippers. The samples were put into a graduated beaker and let sit for a period of time to settle into separate phases. Alternatively, the samples were centrifuged to accelerate phase disengagement. The height of each phase (E-phase or the aqueous phase) was measured, and an actual E/A ratio was obtained from that measurement. The actual measurements of E/A ratio based on samples collected from E1 or E2 mixer tanks differed from the flow rate E/A ratio of 3/1 (see Table 8). This precision difference was created by variations naturally existing in different areas of a mixer tank due to impeller speed and continuous flow rates among other relevant factors.

The operating parameters for the LLX process were listed in Table 8. According to Table 8, the total run time was about 157.9 hours. The process water (NO₃—PO₄ surrogate farm water) flow rate was operated in the range of 6 to 32 ml/min; while the E-phase flow rate into the system was in the range of 18 to 96 ml/min correspondingly so as to maintain the 3/1 E/A ratio. The optimal flow rates for the process water and the E-phase were 16 ml/min and 48 ml/min respectively.

The stripper E/A ratio was in the range of 2/1 to 1/16. The stripper E/A ratio can be in the range of 20/1 to 1/20 depending on the mixing speed and the size of the mixing chamber. The more preferred range should be 1/4 to 1/10. It should be noted that the stripping chambers were initially filled to about ⅔ full with 30 wt % K2CO3 at the start-up. During the operation, fresh 30 wt % K₂CO₃ (the stripping solution) or 45 wt % KOH (another stripping solution) was flowed into the end stripper, which in this example was S6. Then about 1 ml/min of fresh 30 wt % K₂CO₃ was allowed into the other strippers in the upstream, such as S5, S4, S3, S2, and S1 in this sequence. The end stripper is the stripper that is farthest away from the extractors. For example, S2 in FIG. 1 is the end stripper because it is the farthest away from the extractors and the S1 stripper is the closest stripper to the extractors. The fresh loaded E-phase entered the closest stripper, S1 stripper. The E/A ratio in the stripper mixing chamber can vary over a very wide range while still being very effective. Primarily, the E/A ratio was maintained by two factors: (1) the fresh inflows of the stripping solution and the loaded E-phase, and (2) the internal recirculation rates of the aqueous phase (mostly stripping solution(s)) in each stripper (see FIG. 6). The internal recirculation rates were kept mostly at 20 ml/min, but were changed periodically as needed, for example to enhance P and N levels in the product and/or when longer mixer residence times were needed.

Optimally, the S1 settler should have the E-phase occupying the top ⅔ of its chamber with the aqueous phase occupying the bottom ⅓ to maximize the settling time of the E-phase to ensure that the E-phase going into S2 does not contain any aqueous phase. Similarly, S6 settler (or any end-stripper settler) should optimally have the E-phase occupying the top ⅓ of its chamber with the aqueous phase occupying the bottom ⅔. In this case, filling the first end stripper settler with mostly the aqueous phase would ensure that the exiting aqueous phase would not accidentally contain any E-phase. In addition, the aqueous exit weirs can be adjusted to control the height or level of each phase during the operation.

The LLX process behaved well throughout the approximately 160 hour run time, even at higher flow rates of 96 ml/min for the E-phase. Only minor adjustments with impeller speeds and the heights of Y-connectors (used for aqueous overflow weirs) were needed. Sometimes during the run, even though the system behaved well, the aqueous phase volume in the stripper settler might be too low; the adjustments can be done to increase the aqueous phase volume. In settlers, the phases mostly looked clear. Occasionally, a white emulsion developed in E1 mixer, but with some adjustments to the impeller speed, the emulsion disappeared and became separated in the settler. A visible interface was observed between the E-phase and the aqueous phase in the settlers of both extractors and strippers. This represents a very good operation condition, and also indicates that the system can accommodate a higher flow rate because sharp interfaces during the continuous flow operation are not necessary as long as the emulsion break into separate phases prior to exiting the settlers.

However, the data from Table 8 show that as the LLX process continued, the pH in the extractors lowered from pH of 10 to pH of about 7. This demonstrates that more of the 45 wt % KOH solution was needed to add to the initial stripper (S1) to maintain the pH of the E-phase. The addition of KOH was able to increase pH of the extractor to about 9. Since KOH was able to retain the carbonation in the recycled E-phase (see FIG. 3), the strippers might not need any fresh in-flow of 30 wt % K₂CO₃ during the operation after the strippers were filled with 30 wt % K₂CO₃ at start-up. Preferably, K₂CO₃ is added to the last stripper to ensure that the exiting E-phase is sufficiently carbonated with carbonate ions to enable the extraction circuit function properly. The 45 wt % KOH solution can be the fresh in-flow of the aqueous phase to ensure the CO₃²⁻ ions stay as CO₃²⁻ in the extraction and stripping stages.

In addition, it was found (see Table 8) that during runs 12-13, white emulsion was developed after the high flow rate trial period using 96 ml/min flow rate for the E-phase and 32 ml/min flow rate for the aqueous phase. The white emulsion might be caused by the fact that the tubing was not designed to handle such a high flow rate. After draining off the E-phase blockage, the process behaved well even at 72 ml/min flow rate for the E-phase.

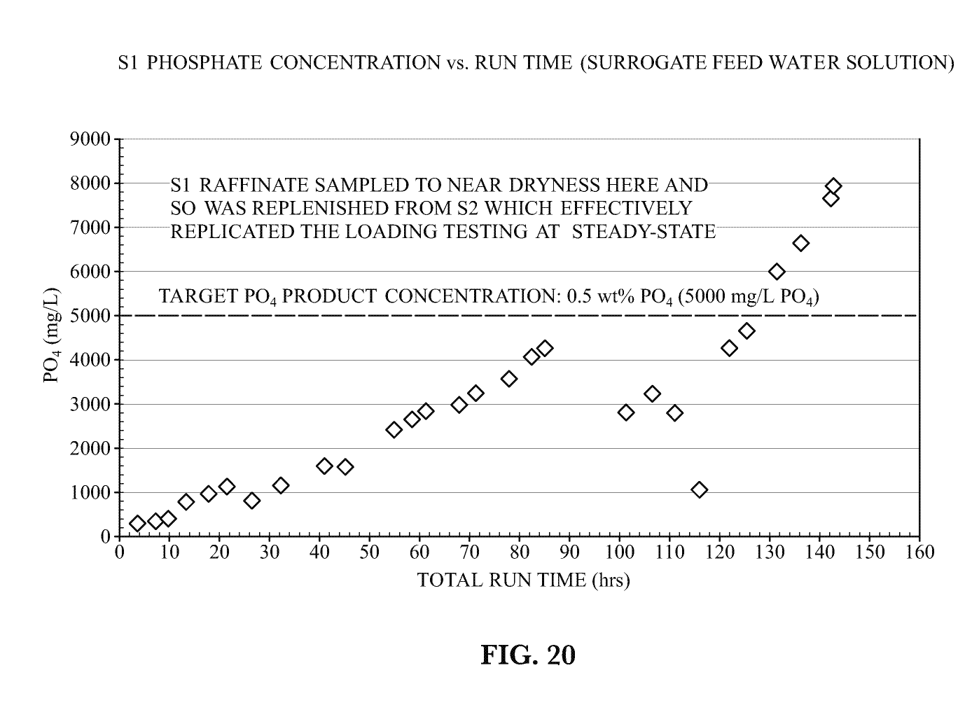

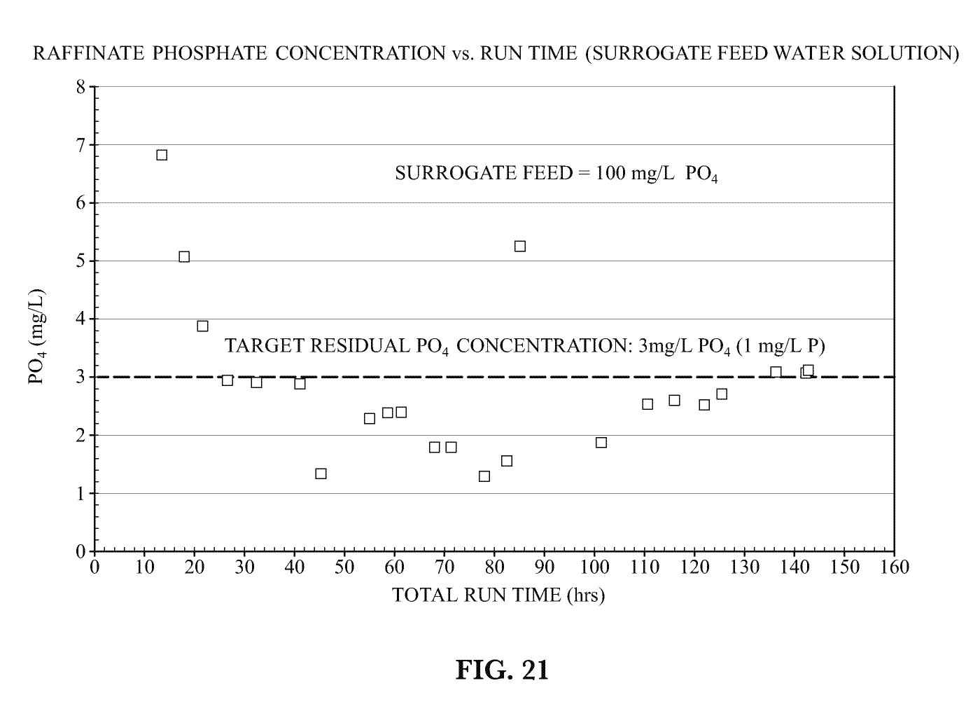

The samples were collected at each mixer along with the process water and the aqueous raffinate (exiting aqueous phase) for phosphate and nitrate analysis. The phosphate levels were analyzed using Thermo Scientific Orion AQUAfast IV® AC4095 Ampoules Program ID #017 (see example 11A for procedures). Then, the nitrate and phosphate levels were analyzed using an IC-ECD system (Dionex LC 20 with EG40 Eluent Generator, AS3500 Autosampler with 200 μl sample). The phosphate results were incorporated into FIGS. 20-21

FIG. 20 shows that an 8,000 ppm phosphate (P—PO₄) product concentrate from the aqueous raffinate sample was achieved and was still accumulating at the run time of 144 hours. A slight decline in the rate of phosphate product accumulation between 100-120 hours was believed to be caused by the replenishment of the strippers to replace the loss of the raffinate due to sampling. Thereafter, smaller samples were taken to enable a greater accumulation of P—PO₄ before replenishment was needed. Therefore, conservatively speaking, this LLX process can achieve at least 5,000 mg/L P—PO₄ concentrate product from a surrogate process water with 100 ppm P—PO₄.

FIG. 21 illustrates that the LLX process of the present invention was able to achieve a high yield of P—PO₄ removal at continuous flow conditions. The residual P—PO₄ in the treated aqueous phase (“purified” or “treated” water) was maintained in the 1-3 ppm range, demonstrating that 97% to 99% P—PO₄ was removed from the surrogate process water (or the process water). It took about 22 hours for the system to reach steady-state operation in terms of the P—PO₄ level in the aqueous raffinate given the low flow rates used in the example. The single 5.3 ppm P—PO₄ value at the 88 hour mark may be an experimental and/or sampling variation. Replication and longer run time would be expected to provide the data precision that would be needed to assess changes at these refinement levels.

In conclusion, FIGS. 20-21 show that the LLX process of the present invention achieved >90% extraction of phosphate values from the surrogate process water (the surrogate farm process water), providing that the E-phase to the process water flow ratio (E/A) was about 3/1 or above. While not wishing to be bound by theory, it is presently believed that E/A ratio of at least 3/1 can reduce or avoid stable emulsion formation. Example 19 demonstrated that a 6-fold throughput rate was achievable for the extractors at continuous flow conditions. This flow rate was dependent on the phase disengagement rate of the E1 and E2 settlers. More importantly, using the pH control system with 45 wt % KOH solution, an 8,000 ml/L (0.8%) phosphate (P—PO₄) product concentrate was achieved at the run time of 144 hours (see FIG. 20).

Data from this example also indicate that two strippers are required to efficiently strip the P—PO₄ ions from the loaded extractant phase. The stripper sample results showed that substantially all P—PO₄ was in the S1 and S2 strippers, and S3 to S6 strippers had almost no P—PO₄. As the result, the LLX process flow scheme was updated in FIG. 1 to include two extractors and two strippers as the preferred structure. The first stripper (S1) includes KOH addition for pH control as described above, and the second stripper (S2) provides make up CO₃²⁻ in a counter-current flow to S1 to allow the eventual full utilization of the K₂CO₃ solution to the process. This way, it would economically maximize the concentration of P—PO₄ in the P—PO₄ concentrate product from S1. The cost of the entire LLX process can be reduced by keeping the amount of K₂CO₃ in-flow rate to S2 minimized (consumption rate of this K₂CO₃ raw material).

In some instances, if the focus is to increase the P—PO₄ concentration in the final P—PO₄ product, a higher number of strippers can be used to produce a P—PO₄ concentrate product with a higher phosphate concentration. Therefore, the process can use about 5-6 strippers to produce a very concentrated product.

Further, the results also suggest that KOH pretreatment of carbonated E-phase is an optional step because KOH addition to the stripper can replace the KOH pretreatment.

TABLE 8
LLX Test Results for Example 8

| | Aqueous | Extract- | | | | | | | | | |
|---|---|---|---|---|---|---|---|---|---|---|---|
| | Process | ant | | | | | | | | | |
| | water* | * | | | | | | | | | |
| | Flow | Flow | | Extractors | | | Strippers | | | | |
| | Rate | Rate | 45% | E/A** | E/A | | E/A | | | Time | |
| Run# | (ml/min) | (ml/min) | KOH | (Expected | (actual) | pH | (actual) | pH | Rpm | (Hours)* | Notes |
| 1 | 18 to 90 | 6 to 30 | n/a | 3/1 | — | — | — | — | — | 9.7 | Basic LLX process and |
| | | | | | | | | | | | flow rate evaluation |
| 2 | 18 | 6 | n/a | 3/1 | — | 10 ± 0.5 | — | 14.0 ± 0.5 | 700-1700 | 8.7 | E-phase was started at |
| | | | | | | | | | | (18.4) | 80 ml/min to charge the |
| | | | | | | | | | | | system. |
| 3 | 18 to 30 | 6 to 10 | n/a | 3/1 | — | 10 ± 0.5 | 1/1 to | 14.0 ± 0.5 | 700-1700 | 6.4 | E-phase was decreasing |
| | | | | | | | 1/4 | | | (24.8) | in extractor at one time, |
| | | | | | | | | | | | reduced aqueous flow |
| | | | | | | | | | | | rate, and then the E- |
| | | | | | | | | | | | phase flow rate |
| 4 | 18 to 30 | 6 to 10 | n/a | 3/1 | — | 10 ± 0.5 | — | 14.0 ± 0.5 | 800-1700 | 9.0 | Flow rates were |
| | | | | | | | | | | (33.8) | increased, and then |
| | | | | | | | | | | | reduced to maintain |
| | | | | | | | | | | | appropriate e-phase |
| | | | | | | | | | | | levels in the extractors. |
| 5 | 18 | 6 | n/a | 3/1 | 3/1 (E1) | 9.5 ± 0.5 | 1/1 to | 14.0 ± 0.5 | 1000-1800 | 9.2 | A white emulsion in E1, |
| | | | | | ½ (E2) | | 1/2 | | | (43) | but adjustment to |
| | | | | | | | | | | | impeller speed resolved |
| | | | | | | | | | | | the problem. |
| 6 | 18 | 6 | n/a | 3/1 | 3/1 (E1) | 9 to 9.5 | 1/1 to | 14.0 ± 0.5 | 1000-1800 | 8.2 | Same as run 5 |
| | | | | | ½ (E2) | | 2/1 | | | (51.2) | |
| 7 | 18 | 6 | n/a | 3/1 | 3/1 (E1) | 9.0 ± 0.5 | 1/1 to | 14.0 ± 0.5 | 1100-1800 | 9.1 | S1 pH reduced slightly |
| | | | | | ½ (E2) | | 2/1 | | | (60.3) | to 13.5 after 8.5 hrs of |
| | | | | | | | | | | | running. Observed a |
| | | | | | | | | | | | drop in the extractant |
| | | | | | | | | | | | surge tank, increased |
| | | | | | | | | | | | impeller speed. |
| 8 | 6 to 24 | 2 to 8 | n/a | 3/1 | 3/1 (E1) | 8.5 to 9.0 | 2/1 to | 13.0-14.0 | 1200-1700 | 9.7 | 30 wt % K₂CO₃ was |
| | | | | | ½ (E2) | | 1/2 | | | (71.0) | added the stripper |
| | | | | | | | | | | | periodically. Increased |
| | | | | | | | | | | | AQ Y o/f weir height to |
| | | | | | | | | | | | increase the aqueous |
| | | | | | | | | | | | level in the settler. |
| 9 | 18 to 30 | 6 to 10 | n/a | 3/1 | 3/1 to 5/1 | 6.0 to 9.0 | 2/1 to | 13.0-14.0 | 1300-1700 | 9.3 | pH dropped slightly in |
| | | | | | | | 1/1 | | | (80.3) | E1 for only 1-2 hrs. |
| 10 | 24 to 30 | 6 to 10 | n/a | 3/1 | 4/1 to 5/1 | 9.0 to 9.5 | 1/7 to | 13.5 to | 1400-1750 | 8.5 | The process behaved |
| | | | | | | | 1/10 | 14.0 | | (88.8) | well with higher flow |
| | | | | | | | | | | | rates |
| 11 | 18 to 36 | 6 to 12 | n/a | 3/1 | 5/1 | 9.0 | 5.1/1 to | 13.0 to | 1300-1800 | 8.2 | Added 30% K₂CO₃, |
| | | | | | | | 0.5/5 | 14.0 | | (98.0) | plan to increase flow |
| | | | | | | | | | | | rate by 50% |
| 12 | 18 to 96 | 6 to 32 | 47 ml + | 3/1 | — | 7.5-9.0 | — | 13.0 to | 1200-1800 | 7.8 | The process behaved |
| | | | 2 ml/ | | | | | 14.0 | | (105.8) | well with higher flow |
| | | | min | | | | | | | | rates. White emulsion |
| | | | | | | | | | | | developed after the high |
| | | | | | | | | | | | flow rate trial period. |
| 13 | 48 to 30 | 16 to 10 | 2 ml/ | 3/1 | 0.6/1 to | 9.0 | 0.4/6.2 | 14.0 | 1200-1800 | 8.5 | White emulsion in the |
| | | | min after | | 3.2/2 | | to | | | (114.3) | extractor mixers and |
| | | | 4 hrs | | | | 0.6/5.0 | | | | low aqueous level in |
| | | | | | | | | | | | the strippers. Reduced |
| | | | | | | | | | | | the flow rates. Removed |
| | | | | | | | | | | | stripper AQ o/f weirs to |
| | | | | | | | | | | | drain E-phase blockage. |
| | | | | | | | | | | | Fresh 30% K₂CO₃ |
| | | | | | | | | | | | added. System behaved |
| | | | | | | | | | | | well after all that. |
| 14 | 18 | 6 | 2 ml/ | 3/1 | 1/1 to 4/1 | 8.0 to 9.0 | 0.4/4.4 | 14.0 | 1300-1800 | 9.0 | The process behaved |
| | | | min | | | | to | | | (123.3) | well. Observed the E1- |
| | | | after | | | | 0.4/6.2 | | | | settler was full of E- |
| | | | 1 hr | | | | | | | | phase at the end of the |
| | | | | | | | | | | | run, so no aqueous |
| | | | | | | | | | | | sample was obtained |
| | | | | | | | | | | | for E1 settler. |
| 15 | 18 to 48 | 6 to 16 | 2 ml/ | 3/1 | 1.2/5 to | 7.0-9.0 | 0.4/4.6 | 14.024 | 1200-1700 | 11.5 | The process behaved |
| | | | min after | | 1.0/4.8 | | to | | | (124.3) | well. Raised the AQ |
| | | | 7 hrs | | | | 1.6/5 | | | | o/f weirs so that no |
| | | | | | | | | | | | stage to stage aqueous |
| | | | | | | | | | | | transfer can occur. |
| 16 | 48 | 16 | n/a | 3/1 | 4.8/1.2 to | 7.0-9.0 | 0.2/5.2 | 14.0 | 1100-1800 | 11.3 | The process behaved |
| | | | | | 5.2/1.2 | | to | | | (135.6) | well. Visible interface |
| | | | | | | | 0.4/5.0 | | | | between E-phase and |
| | | | | | | | | | | | aqueous phase. |
| 17 | 48 to 60 | 16 to 20 | 2 ml/ | 3/1 | 4.8/1 to | 7.0-9.0 | 0.4/4.8 | 14.0 | 1100-1800 | 11.2 | The process behaved |
| | | | min after | | 5.0/1.2 | | to | | | (146.8) | well. E-phase in the |
| | | | 4 hrs | | | | 0.4/5.2 | | | | stripper looked a little |
| | | | | | | | | | | | hazy, but the E-phase |
| | | | | | | | | | | | in the extractor looked |
| | | | | | | | | | | | clear. |
| 18 | 60 to 72, | 20 to 24 | n/a | 3/1 | 4.6/1.0 to | 7.0-9.0 | 0.3/4.8 | 14.0 | 1000-1750 | 11.1 | The process behaved |
| | back to | | | | 5.2/1.6 | | to | | | (157.9) | well. 8 hrs into the run, |
| | 60 | | | | | | 0.4/4.8 | | | | a very thin layer of E- |
| | | | | | | | | | | | phase was in S1 and S2 |
| | | | | | | | | | | | settler. Reduced flow |
| | | | | | | | | | | | rates to increase the E- |
| | | | | | | | | | | | phase transfer to S1 |
| | | | | | | | | | | | and S2. |

*The flow rates of E-phase and the Aqueous Process water were adjusted together so that the expected E/A ratio remained the same throughout the run.
**E/A ratios (expected) were based on the flow rates of the E-phase and the process water.
***The duration in hours listed in the parenthesis referred to the total duration starting with run 1.

### Example 9

This example evaluated the effect of KOH hydrolysis on converting polyphosphate to orthophosphate in the Anaerobic Digestion (AD) process water (also called “AD process water” or “AD purge process water” or “process water”) and on the LLX process efficiency using the E-phase containing 0.631 wt % Aliquat 336 (also called 0.631% E-phase). Chicken Manure AD process water sample was obtained from the Optional Energy Partners, Inc. (OEP) (called Chicken OEP AD process water or process water).

20 ml of the Chicken OEP AD process water was mixed with 68.36 μl 45 wt % KOH solution (40 mM KOH in 20 ml sample). The mixture was stirred for 60 minutes using a magnetic stir disc at a speed of 400 rpm. After stopping the stirring, a sample was obtained as the “Chicken OEP AD/40 mM KOH Hydrolysis Filtrate.”

The filtrate from the KOH hydrolysis was used to test the efficiency of extracting KOH hydrolyzed AD process water using the 0.631% E-phase at the E/A ratio of 3/1. The 0.631% E-Phase was the KOH pretreated carbonate loaded E-phase obtained from Example 7. The 60 ml E-phase and 20 ml Process water were contacted twice using the procedure listed in Example 3. The two phases readily disengaged in less than one minute after each contact. An aqueous raffinate sample was collected after each contact with the E-phase.

All samples were clarified using a 0.2 μl syringe filter prior to testing for the phosphate level. Two test methods were used: one was an IC-ECD method, and another one was the Thermo Scientific Orion AQUAfast IV® AC4095 Ampoules program ID #017 method. The IC-ECD method is consisted of Dionex LC 20 with EG40 Eluent Generator, AS3500 Autosampler with 50 μl sample loop, GP40 gradient pump, ED 40 electrochemical detector, and Chromeleon 6.7 software. The column used was Dionex Ionpac AS11 Analytical (4×250 mm), SN 017755. The method used 1.00 ml/min flow rate, KOH gradient elution and 25 μl injection volume.

The results are shown in Table 9. The same experiment was performed using Swine AD purge process water.

Table 9 shows that after mixing with 40 mM KOH solution, the Chicken OEP AD process water showed more than 3 times of phosphate concentration than that of the process water without KOH. Therefore, the results suggest that KOH solution or other similar base would be able to hydrolyze the poly/bio-phosphates bound in the Chicken OEP AD process water. Accordingly, a pre-hydrolysis process step could increase recovery yield of P—PO₄ from AD process water, and correspondingly reduce the amount of P—PO₄ lost to the process waters (the treated water).

TABLE 9
OEP Chicken Process water—Phosphate Results

| | PO₄ concentration | PO₄ concentration |
|---|---|---|
| | (mg/L) − IC | (mg/L) − Thermo |
| Sample* | Analysis | Orion Analysis |
| Chicken OEP AD process water | 430 | 319 |
| Chicken OEP AD/40 mM KOH | 1450 | 1158 |
| Hydrolysis Filtrate | | |
| Aqueous Raffinate—1^{st} | — | 1027 |
| E-phase contact | | |
| Aqueous Raffinate—2^{nd} | — | 1146.6 |
| E-phase contact | | |

The results in Table 9 show that using the more dilute 0.631% E-phase formulation (0.631% Aliquat 336), greater than 90% of the phosphate values remained in the aqueous phase (aqueous raffinate). The same results were found for the Swine AD process water. It was believed that the 0.631 wt % active extractant concentration (Aliquat 336) was not high enough to extract the high levels of phosphate ions in the process water. The AD process water generally contains about 10 times more phosphate ions than that of the surrogate farm process water (also called “farm water” or “process water”). The P—PO₄ extraction yield could be increased by increasing the active extractant content and/or the E/A ratio in the extractor operation.

In addition, due to the slow breaking emulsion that developed during testing, it took approximately two days to have phase disengagement for approximately 50% of the initial volume (t₅₀). Although the phase disengagement was sped up later, the result suggests that hydrocyclones, centrifuges, or other similar devices, should be used for optimal phase disengagement. Alternatively, an E-phase with a higher concentration of the active extractant component might speed up the phase disengagement.

### Example 10

This example examined the effect of using a higher active extractant E-phase formulation (9.1 wt % Aliquat 336) in a batch LLX testing process of Example 3. Dairy OEP AD process water was used (a type of the process water). E-Phase was prepared using 9.1 wt % Aliquat 336, 4.5 wt % Exxal 10, and 86.4 wt % 467 solvent. Then, according to the procedures listed in Example 8, the E-phase was carbonate loaded with 8 wt % K₂CO₃, washed with DI water, and then treated with 45 wt % KOH solution.

The batch LLX process was performed according to the procedure of Example 3 except an E/A ratio of 3:1 (same as 3/1) was used. During the process, phase disengagement was evaluated using t₅₀ and t₉₀. The phase disengagement time was no more than 11 minutes for t₉₀, about 2 minutes for t₅₀ for the first contact with the E-phase. The total phosphate concentration was tested using (1) the HACH DR/4000 Molybdovanadate method #10127 with acid persulfate digestion, and (2) the IC-ECD system of Example 9. The acid persulfate digestion step solubilized the polyphosphates present in the process water samples by oxidation and hydrolysis, and then converted the polyphosphates to orthophosphates. Sufficient sample dilution was also required to prevent excessive color or prevention of light scattering precipitates.

The phosphate levels of the aqueous raffinate after the first contact with E-phase were about 1-3 mg/L, and the loaded E-phases showed >98% total phosphate extracted. This result shows that using a higher active extractant concentration (9.1 wt % Aliquat 336), the batch LLX process achieved a higher extraction rate (>90%) of the P—PO₄ values in the Dairy AD process water. Therefore, the optimal active extractant concentration in the E-phase is between about 0.6 wt % and 9.1 wt %.

In addition, the higher extraction results suggest that the base catalyzed pre-hydrolysis process listed in Example 9 was not necessary because the E-phase can extract all forms of phosphate if it used a higher concentration of active extractant. Further, the LLX process used KOH solution to maintain its high stripping pH of about 11-14, and thus, the stripping of these extracted species resulted in their hydrolysis to orthophosphate ion.

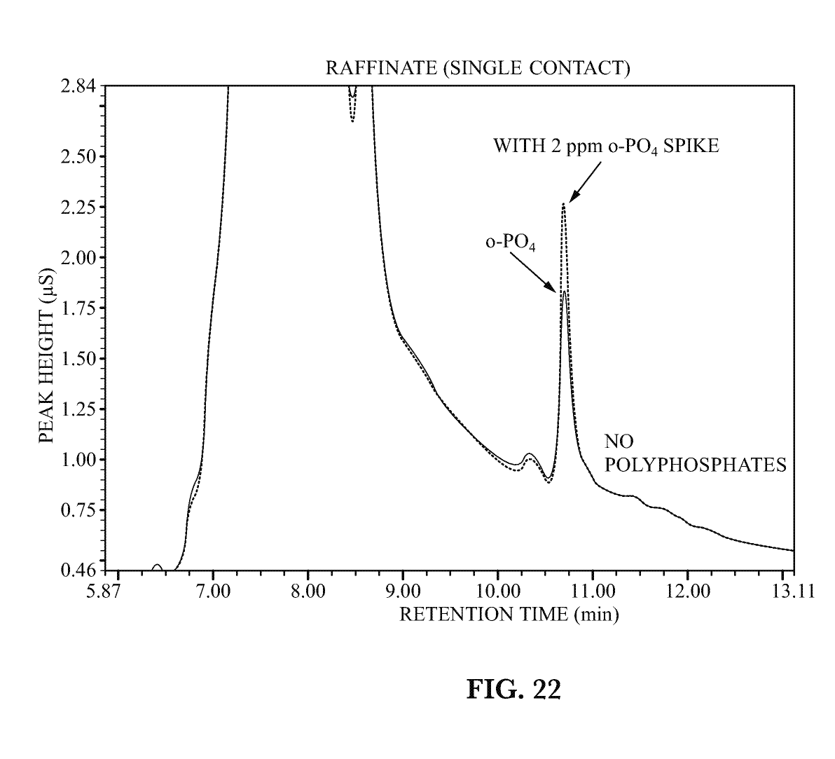

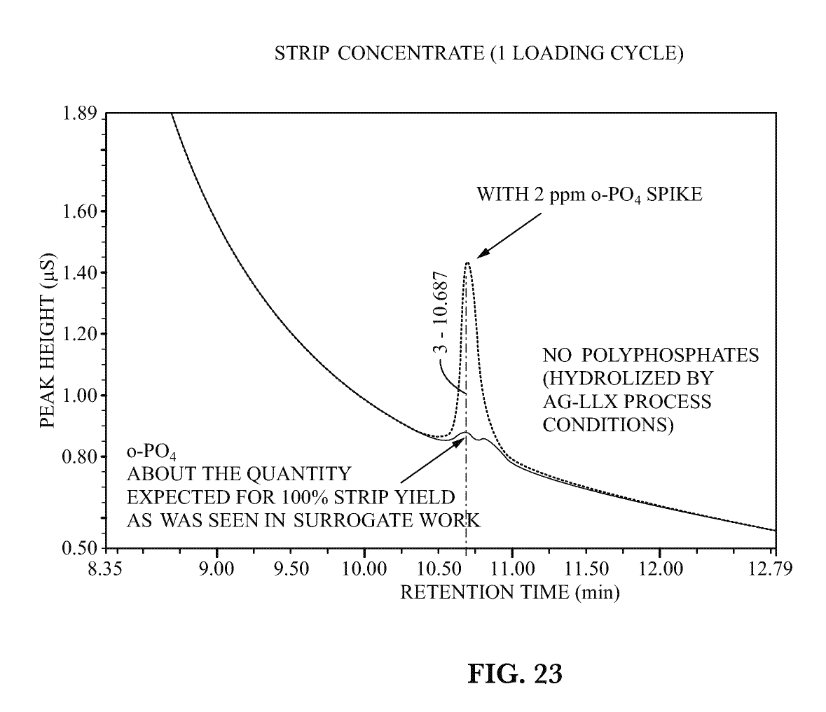

More importantly, the IC analysis results (FIGS. 22-23) show that all polyphosphates were efficiently removed by the 9.1% active extractant E-phase formulation. Although the amounts of the phosphate shown in FIGS. 22-23 were low, it was due to the dilution in the extraction and stripping and due to the fact that the process was only done one time. It was expected that as the LLX process was continuously run for a longer time, the extracted orthophosphate values in the strip solution would increase.

TABLE 10
Dairy OEP Anaerobic Digestion (AD) Process Water Extraction Test
Results using E-phase with 9.1% Aliquat 336
Farm Water LLX (Ag-LLX)
Extraction Test Results (IC Analysis data)

| | PO₄ Concentration | Fraction of Total |
|---|---|---|
| | (mg/L total | Phosphates |
| Sample Description | phosphate) | Extracted |
| Dairy OEP AD Feed* | 401. | NA |
| (LRB#: 52878-74-11) | | |
| Dairy OEP AD | 5.6 | 98.6% |
| 1^{st} E-phase Contact Raffinate* | | |
| (LRB#: 52966-40-05) | | |
| Dairy OEP AD | N.D.** | >99% |
| 2^{st} E-phase Contact Raffinate* | | |
| (LRB#: 52966-40-06) | | |

### Example 11

This example evaluated the key parameters and ranges necessary for a successful removal of phosphate ions (and/or nitrate ions) from Anaerobic Digester (AD) process water under continuous flow LLX process conditions.

The AD purge process water (process water) was obtained through Optional Energy Partners, Inc. (OEP) from Green Meadow Dairy in Elsie, Mich., a farm with a herd of 3200 dairy cows.

An approximately 12-hour continuous flow bench-scale LLX testing using the process water was successfully completed. The bench scale LLX testing used the apparatus as illustrated in FIGS. 4, 6, and 8 (see Examples 5 to 8 for details). In this example, honeycomb coalescence media of about 1 cm spacing was placed into the extractor settler (see the parameter listing below). This testing effectively captured more than 90% of the orthophosphate, P-(o-PO₄) nutrient values in the process water.

The testing conditions were as follows:

Reagents used were as follows:
Extractant Phase Composition: 9.1% Aliquat 336, 86.4% 467 Solvent, 4.5% Exxal 10 (Without KOH Pretreatment)
Dairy OEP AD Process water composition: 619. mg/L P—PO₄³⁻ (IC Analysis)
30% K₂CO₃ Solution (Aqueous strip solution)
45% KOH Solution (For pH control in S1 and S2)
   Operating Parameters were as follows:
OEP Dairy AD Process water Flow Rate: 6 mL/min
Extractant Phase Flow Rate: 18 mL/min
Extractor mixer E/A ratios (measured):
   (E/A)_{E1 extractor} (range over the run period)=1/4→2/3
   (E/A)_{E2 extractor} (range over the run period)=4/1→4/1 (i.e., very steady)
Stripper E/A Ratio (measured): 1/8→1/24 (operated in continuous internal recycle mode)
Extractor settlers were the triple-long “U” shaped units (˜1 L each) and filled with honeycomb coalescence media of ˜1 cm spacing.

During the testing process, pH control was accomplished using 45% KOH additions to the S1 mixer at a flow rate of 2 ml/min using a manual on/off operation whenever the pH dropped below pH 14.0. The pH of the aqueous strip solutions varied from 11.0 to 14.0.

In addition, during the testing process, flooding of the E1 settler was observed due to fluid back up caused by pluggage. The presence of a third “mud-like” dense phase was found to be the source of the pluggage. This dense phase effectively reduced the AD process water throughput rate during the testing. Later testing showed that the “mud-like” dense phase consisted of finely milled farm feed waste in flat needle straw shapes. Therefore, a solid-liquid filtration treatment process was recommended for the Dairy Process water to remove such waste materials prior to the LLX process.

TABLE 11
OEP Dairy Anaerobic Digestion (AD) Process Water
Range Finding Testing IC Results.
Farm Water LLX
Continuous Flow Testing Results
(IC data)

| | PO₄ Concentration |
|---|---|
| Sample Description | (mg/L o-PO₄) |
| Dairy OEP AD Feed | 619 |
| (LRB#: 52878-81-14) | |
| E2 Extractor Raffinate | <2.5*** |
| (LRB#: 52878-81-16; | |
| Total Run Time: −7 hours | |
| E2 Extractor Raffinate | <2.5*** |
| (LRB#: 52878-81-17; | |
| Total Run Time: ~10 hours | |
| E2 Extractor Raffinate | <2.5*** |
| (LRB#: 52878-81-18; | |
| Total Run Time: ~10.5 hours | |
| E2 Extractor Raffinate | <2.5*** |
| (LRB#: 52878-81-19; | |
| Total Run Time: ~12 hours | |

***No peaks were detected in the 5× dilutions of the E2 Raffinate samples. The instrument detection limit for phosphate is 0.5 mg/L and 5× dilution yields a method detection limit of 2.5 mg/L for these samples

The two extractors achieved greater than 90% extraction of P—PO₄ (total) values (see Table 11). However, the extraction efficiency was dependent on the E/A flow ratio being at least 3:1 so that the stable emulsion formation as shown in FIG. 6 can be avoided. The stable emulsion (also called RAG layer) was believed to consist of organic impurities. However, the reason for the stable emulsion is not yet understood, though it may be possible to reduce or eliminate this stable emulsion layer by adjusting these parameters: (1) modifier level; (2) active extractant concentration; (3) an increase in process temperature; and (4) higher pH (so as to work near the systems isoelectric point).

Additional run time is required to determine more precisely the number of strippers required to efficiently strip the PO4 values from the extractant phase and achieve a concentrated phosphate product.

### Example 12

This example determined the target operating parameters of the batch (feasibility) LLX testing process using actual clarified, fresh- and aged-barn and lagoon water (a type of the process water)

Optional Energy Partners, Inc. (OEP) provided dairy flush clarified barn process water (also called Dairy flush water feed) and the Sow lagoon water samples. Based on IC analysis results in Table 12, the phosphate concentrations in the process water were found to be pretty low, about 20 to 50 mg/L. The IC analysis process was performed according the procedure listed in Example 9. Please note that all samples were syringe clarified using a 0.2 μm filter prior to IC analysis. Accordingly, extractant phase with 0.631 wt % Aliquat 336 from Example 8 was used. The E-phase was carbonate loaded, DI water washed, and 45% KOH pre-treated.

The IC analysis results indicate that most of the phosphate in the process water or that the process water was already hydrolyzed into orthophosphate, and that it contained very little polyphosphate. Therefore, the phosphate level can be and was analyzed using ORION AQUAfast method ID 017 from then on in this example.

The batch LLX test process was performed using these AD process water samples at an E/A ratio of 3:1: 20 ml of the process water and 60 ml of E-phase was mixed in a flask with a stirrer for about 120 minutes. The mixture was let sit to allow phase disengagement; t50 and t₉₀ were recorded. It was found that for most of the samples, t₉₀ was no more than 1 minute. The extraction was performed twice for the same AD process water sample to simulate the two extraction stages of the continuous flow LLX process.

For Dairy flush water feed as the process water, the two stage batch LLX process achieved greater than 80% extraction of PO₄ values using the E/A ratio of 3:1 (Table 24A). The E-phase loading IC analysis results for the Dairy flush water feed are provided in Table 12A. For Sow Lagoon water feed, the two stage batch LLX process achieved greater than 60% extraction of PO₄ values using the E/A ratio of 3:1 (Table 12B). The E-phase loading IC analysis results for the Sow lagoon water feed are provided in Table 12B.

TABLE 12
Summary of Clarified Dairy Barn Flush and Sow Lagoon
Process waters Supplied from Optional Energy Partners (OEP).

| | | Physical | Solid-Liquid | PO₄ |
|---|---|---|---|---|
| Feed Water | | LLX | Separation | Concentration* |
| Type | Source | Behavior** | Required | (mg/L PO₄) |
| Dairy Barn | OEP | Fast Phase | NO | 20 |
| Flush Water* | | Disengagement | | |
| (LRB#: | | | | |
| 52879-109) | | | | |
| Swine | OEP | Fast Phase | NO | 50 |
| Lagoon Water* | | Disengagement | | |
| (LRB#: | | | | |
| 52879-109) | | | | |

*Note:
PO₄ concentrations were lower in barn flush water than that of the Process water.
**Used 0.6% Extractant formulation.
*Samples were syringe clarified at 0.2 um prior to IC analysis.

TABLE 12A
OEP Dairy Barn Flush Process water Extraction Test Results: 0.6%
Aliquat 336 E-phase, E/A ratio of 3:1
Farm Water LLX
(IC data)

| | PO₄ Concentration |
|---|---|
| Sample Description | (mg/L o-PO₄) |
| Dairy Flush Water Feed | 16 |
| (LRB#: 52879-109) | |
| Dairy Flush Water | N.D.* |
| 1^{st} E-phase Contact Raffinate | |
| (LRB#: 52879-101) | |
| Dairy Flush Water Feed | N.D.* |
| 2^{nc} E-phase Contact Raffinate | |
| (LRB#: 52879-102) | |

*N.D. Non-detect
*Estimated detection limit is 3-6 mg/L PO₄. Samples were syringe clarified at 0.2 μm prior to IC analysis.

TABLE 12B
OEP Sow Lagoon Process water Extraction
Test Results: 0.6% Aliquat 336; E/A ratio of 3:1
Farm Water AG-LLX
(IC data)

| | PO₄ Concentration |
|---|---|
| Sample Description | (mg/L o-PO₄) |
| Sow Lagoon Water Feed | 50 |
| (LRB#: 52879-109) | |
| Sow Lagoon Water | 20 |
| 1^{st} E-phase Contact Raffinate | |
| (LRB#: 52879-105) | |
| Sow Lagoon Water | 19 |
| 2^{nd} E-phase Contact Raffinate | |
| (LRB#: 52879-106) | |

*Estimated detection limit is 2-5 mg/L PO₄ (Estimated 1-2σ). Samples were syringe clarified at 0.2 μm prior to IC analysis.

### Example 13

This example characterized several AD process waters (one type of nutrient rich process water) from several farms and several types of operating digesters with several analytical tests. These tests included the Hach total phosphate colorimetric method, the Hach orthophosphate colorimetric method, the Hach ammonia colorimetric method, total solids, volatile solids, and pH tests. AD samples were gathered from covered pit digesters, plug-flow digesters, tank digesters, and uncovered lagoons.

The primary source for the AD process water samples was a dairy farm in Circleville Ohio, which has a covered-pit type anaerobic digester. Other samples obtained include digested food waste and manure from the local farm facility in Wooster, Ohio; pit lagoon samples from a dairy farm in New Weston, Ohio, and a dairy farm in Botkins, Ohio; and plug flow digester process water from a dairy farm in Haviland, Ohio. Analytical results of these samples are listed in Table 13.

### Procedure for Measuring Total Suspended Solids (TSS):

1. Turned the drying oven on. VWR Scientific/1330 FSM Drying Oven (Serial Number: 0100198) was used in this process.
2. Set it to 114° C., which typically will yield the desired 105° C. temperature inside the oven.
3. Placed empty crucibles in a desiccator and placed the uncovered desiccator in the oven for initial drying.
4. Kept the crucibles in the oven for one hour.
5. Removed the crucibles from the oven and put the cover back on the desiccator.
6. Allowed the crucibles to cool to room temperature in the desiccator
7. Weighed the empty crucibles and recorded the masses.
8. Loaded each crucible with ˜5 mL of sample.
9. Weighed the crucibles containing the sample (Chicken Manure usually, also abbreviated as “CM”) and record the masses.
10. Calculated the weight of the wet CM (sample) by subtracting the weight of the empty crucible from the weight of the crucible containing the sample.
11. Placed the crucibles filled with sample back in the 105° C. drying oven and allow to dry overnight.
12. The next day, removed the crucibles from the drying oven and allowed to cool to room temperature inside the covered desiccator.
13. Weighed the dry crucibles with the dry CM (sample) and record their masses. Calculate the weight of the dried mass by subtracting the weight of the dry crucible from the weight of the dry crucible with the dry CM from step 12.
14. Calculated the percent total solids by using this equation: % TS=(weight of dry CM or sample)/(weight of wet CM/sample) and record the results

### Procedure for Measuring Volatile Suspended Solids (VSS)

1. Preheated the muffle furnace to 550° C. Thermolyne 30400 Muffle Furnace (Battelle X58023) was used.
2. Used the same crucibles and samples used for TSS (see above) for VSS,
3. Placed crucibles in the 550° C. muffle furnace.
4. After 30 minutes, removed the crucibles and placed them in a desiccator.
5. Allowed the crucibles to cool to room temperature inside the desiccator.
6. Weighed the dried crucibles and recorded the masses.
7. Calculated the mass of the volatile solids (weight of volatile CM) by subtracting the weight of the dried crucible from step 6 from the weight of the dried crucible with dry sample.
8. Calculated the percent volatile solids by using the following equation: % VSS=(weight of volatile CM)/(weight of wet CM). The weight of wet CM is obtained during the procedure for measuring TSS.

### Procedure for Measuring Phosphorus

1. Turned on the Hach heating Reactor (Hach COD Reactor, Product No. 4560000) and preheated to 150° C.
2. Placed the plastic shield in front of the reactor.
3. Turned on the Hach DR/5000 (Hach Dr/5000 Direct Reading Spectrophotometer, Product No. DR5000-03) and allowed self-test to run while lid is closed.
4. Pressed STORED PROGRAMS on the DR/5000.
5. Pressed 542 and then START on the Hach DR/5000.
6. Sample preparation
   i. Diluted the sample appropriately to obtain a phosphate reading between 1.0 and 100 mg/L.
   ii. If sample was untreated AD process water, diluted 5× with DI water.
   iii. If AD process water sample had been treated with extractant, then no dilution was necessary.
   iv. If sample was untreated AD process water, diluted 100× with DI water.
   v. If AD process water sample had been treated with extractant, diluted by at least 5× with DI water.
   vi. Measured pH of the sample; test requires a neutral sample pH. If sample was basic, add concentrated sulfuric acid drop wise until neutralized. Made sure the sample was continuously mixing while being measured with a pH probe.
7. Removed the caps from Total Phosphate Test 'N Tube Vials (1 blank, 2 vials per sample for total phosphorus analysis) (Product No. 2767245).
8. Transferred 5.0 mL of deionized water to a Total Phosphate Test 'N Tube Vial using a 5 mL pipette. This was the “Blank”.
9. In the remaining vials, used a 5 mL pipette to transfer 5.0 mL of prepared sample into each Total Phosphate Test 'N Tube Vial. These were the “Samples”.
10. Used a small, dry glass funnel to add the contents of one Potassium Persulfate Powder Pillow for Phosphonate to each vial.
11. Capped and inverted the vials to dissolve the powder pillow.
12. Placed the vials in the Hach COD Reactor and heated for 30 minutes at 150° C.
13. Carefully removed the vials from the Hach COD Reactor and placed them in a test tube rack to cool to room temperature (took about 20 minutes).
14. If visible solid particulates were present in vials, samples must be syringe filtered as follows:
   i. Opened a new syringe (BD 10 mL latex free syringe, Product No. 309604).
   ii. Pulled out the plunger completely.
   iii. Screwed a 0.45 μm nylon syringe filter (Thermo Scientific Nylon syringe Filter) on the end of syringe.
   iv. Poured contents of one vial into the syringe trying to transfer as many solid particulates as possible.
   v. Placed the empty vial back into a test tube rack.
   vi. Replaced the syringe plunger and carefully push the filtered sample back in the same vial.
   vii. If any solids were still observed in vial, repeated steps ii-vi.
15. Transferred 2.0 mL of 1.54 N sodium hydroxide to each vial with a 5 mL pipette.
16. Capped and inverted vials to mix.
17. Added 0.5 mL of Molybdovanadate Reagent to each vial using a polyethylene dropper.
18. Capped and inverted the vials to mix.
19. Placed the vials in the test tube holder for 7 minutes.
20. Cleaned the outside of each vial with a Kim Wipe.
21. After the 7 minute reaction time, placed the blank in the Hach DR/5000 16 mm cell holder with the Hach logo facing the front of the instrument.
22. Closed the cover on the DR/5000.
23. Pressed ZERO; removed the blank.
24. Placed the sample in the Hach DR/5000 16 mm cell holder with the Hach logo facing the front of the instrument.
25. Closed the cover on the DR/5000.
26. DR/5000 automatically read sample results in mg/L PO₄; removed vial and repeated Steps 24-25 for each sample.
27. Recorded measurements.

### Procedure for Measuring Orthophosphate

1. Turned on the Hach DR/5000 (Hach DR/5000 Direct Reading Spectrophotometer, Product No. DR5000-03) and allowed self-test to run while lid is closed
2. Pressed STORED PROGRAMS on the DR/5000
3. Pressed 490 and then START on the Hach DR/5000
4. Sample preparation
   i. If the sample was untreated process water, diluted 100× with DI water
   ii. If the process water (farm or AD) sample had been treated with extractant, then diluted 10× with DI water
   iii. Measured pH of the sample; test required a sample pH between 2 and 10. If the sample was basic, added the concentrated sulfuric acid drop wise until optimum range was reached. If the sample was acidic, add the concentrated potassium hydroxide drop wise until optimum range was reached. Made sure the sample was continuously mixing while being measured with a pH probe.
5. Filled a sample cell with 10 mL of the sample. This was referred to as the “Blank.”
6. Filled the remaining cells with 10 mL of the diluted samples, allowing for duplicated tests. These were referred to as “samples.”
7. Added the contents of one PhosVer 3 Powder Pillow to the blank and the samples.
8. Capped and shook the blank and the samples to dissolve the powder for 30 seconds.
9. Pressed the clock icon, clicked the first wait timer, pressed START and a two minute reaction period would begin.
10. After the timer beeps, placed the blank into the 1-inch square cell holder
11. Closed the cover on the DR/5000
12. Pressed ZERO; removed blank from the cell holder
13. Placed one of the samples into the cell holder
14. Closed the cover on the DR/5000
15. DR/5000 automatically read sample results in mg/L PO₄
16. Removed the sample cell and repeated Steps 13-15 for the remaining samples.
17. Record measurements.

### Procedure for Measuring Ammonia

1. Turned on the Hach DR/5000 (Hach Dr/5000 Direct Reading Spectrophotometer, Product No. DR5000-03) and allowed self-test to run while lid is closed
2. Pressed STORED PROGRAMS on the DR/5000
3. Pressed 385 and then START on the Hach DR/5000
4. Filled a sample cell with 10 mL of deionized water. This was referred to as the “Blank.”
5. Diluted all samples (all types of process water) with DI water to a dilution factor of 10,000×.
6. Filled the remaining cells with 10 mL of diluted samples. These were referred to as “samples.”
7. Added the contents of one Ammonia Salicylate Reagent Powder Pillow to the blank and the samples.
8. Capped and shook the blank and the samples to dissolve the powder.
9. Pressed the clock icon, clicked the first wait timer, pressed START and a three minute reaction period would begin.
10. Once the timer beeped, added the contents of one Ammonia Cyanurate Reagent Powder Pillow to the blank and the samples
11. Capped and shook the blank and the samples to dissolve the powder.
12. Pressed the clock icon, clicked the second wait timer, pressed START and a 15 minute reaction period would begin.
13. After the timer beeped, placed the blank into the 1-inch square cell holder
14. Closed the cover on the DR/5000
15. Pressed ZERO; removed the blank from the cell holder
16. Placed one of the samples into the cell holder
17. Closed the cover on the DR/5000
18. DR/5000 automatically read sample results in mg/L NH₃—N
19. Removed the sample cell and repeated Steps 16-18 for the remaining samples.
20. Recorded measurements.

TABLE 13
Characterization of Process water Samples from Ohio Dairies

| Sample Description | | | Solids | | | Nutrients | | | | | |
|---|---|---|---|---|---|---|---|---|---|---|---|
| Type of | | | | Total | Total | Total | Ortho P | Ammonia | | | |
| Process | Type of | | | Volatile | COD | Phosphate | (PO4) | (NH3—N) | | Dissolved | ORP |
| water | Digester | Sample Type | TS % | Solids % | (mg/L) | (PO4) mg/L | mg/L | mg/L | pH | O % | (mV) |
| Food | Tank | AD Process water | 6.6% | 3.6% | NA | 61.4 | 30.7 | 2000 | 7.76 | NA | NA |
| Dairy | Tank | AD Process water | 4.0% | 2.8% | NA | 0 | 43.0 | 2100 | 7.76 | NA | NA |
| Manure | | | | | | | | | | | |
| Food | Tank | AD Process water | | | NA | 3320 | | | | | |
| Dairy | Covered | Primary Lagoon AD Process | 0.8% | 0.4% | NA | 159.5 | 180.5 | 1700 | 8.03 | NA | NA |
| Manure | Lagoon | water-filtered 1 mm (collected | | | | | | | | | |
| | | Aug. 22, 2011) | | | | | | | | | |
| | | Primary Lagoon AD Process | NA | NA | | 441.5 | | | | | |
| | | water-filtered 1 mm (collected | | | | | | | | | |
| | | Aug. 1, 2011) | | | | | | | | | |
| | | Primary Lagoon AD Process | NA | NA | | 112.5 | | | | | |
| | | water-filtered 1 mm (collected | | | | | | | | | |
| | | Aug. 1, 2011) | | | | | | | | | |
| | | Primary Lagoon AD Process | NA | NA | NA | 437.5 | 1025 | 1200 | 8.21 | NA | NA |
| | | water-filtered 1 mm (collected | | | | | | | | | |
| | | Aug. 1, 2011) | | | | | | | | | |
| | | Primary Lagoon AD Process | NA | NA | NA | 114.5 | NA | NA | 7.44 | NA | NA |
| | | water-filtered 1mm (collected | | | | | | | | | |
| | | Aug. 1, 2011) | | | | | | | | | |
| | | Primary Lagoon AD Process | 0.6% | 0.3% | NA | 132.8 | 122.0 | NA | | NA | NA |
| | | water-filtered 1 mm (collected | | | | | | | | | |
| | | Aug. 1, 2011) | | | | | | | | | |
| | | Primary Lagoon AD Process | NA | NA | NA | 128 | 122.5 | 1150 | 8.23 | NA | NA |
| | | water-filtered 1mm (collected | | | | | | | | | |
| | | Aug. 1, 2011) | | | | | | | | | |
| | | Primary Lagoon AD Process | | | | 33.2 | 26.5 | | | | |
| | | water-filtered (collected | | | | | | | | | |
| | | Jun. 27, 2011) | | | | | | | | | |
| | | Primary Lagoon AD Process | 0.5% | 0.2% | 2556 | 76.8 | 141.8 | 1450 | 7.86 | NA | NA |
| | | water-unfiltered (collected | | | | | | | | | |
| | | Jun. 27, 2011) | | | | | | | | | |
| | | Primary Lagoon AD Process | 0.4% | 0.2% | 2156 | 9.2 | 51.4 | 1500 | 7.80 | NA | NA |
| | | water-filtered (collected | | | | | | | | | |
| | | Jun. 27, 2011) | | | | | | | | | |
| | | Flush (collected Jun. 15, 2011) | 1.3% | 0.8% | 11490 | NA | NA | NA | 8.11 | NA | NA |
| | | Press-Liquor (collected | 1.3% | 0.9% | 11610 | NA | NA | NA | 7.55 | NA | NA |
| | | Jun. 15, 2011) | | | | | | | | | |
| | | Secondary Lagoon (collected | 0.9% | 0.5% | 6360 | NA | NA | NA | 7.82 | NA | NA |
| | | Jun. 15, 2011) | | | | | | | | | |
| | | Tertiary Lagoon (collected | 0.8% | 0.4% | 5460 | NA | NA | NA | 8.02 | NA | NA |
| | | Jun. 15, 2011) | | | | | | | | | |
| | | Offscreen (collected | 13.9% | 13.0% | NA | NA | NA | NA | NA | NA | NA |
| | | Jun. 15, 2011) | | | | | | | | | |
| | | Press-Cake (collected | 30.5% | 29.2% | NA | NA | NA | NA | NA | NA | NA |
| | | Jun. 15, 2011) | | | | | | | | | |
| Dairy | Pit | Lagoon Process water | 3.6 | 2.4 | NA | 800 | 792.5 | 3850 | 7.00 | NA | NA |
| Manure | Lagoon | (collected Aug. 23, 2011) | | | | | | | | | |
| Dairy | Pit | Lagoon Process water | 1.7 | 0.8 | NA | 380.5 | 402.5 | 2400 | 8.01 | NA | NA |
| Manure | Lagoon | (collected Aug. 23, 2011) | | | | | | | | | |
| Dairy | Plug | AD Process water-not filtered | 4.3 | 3.0 | NA | 1155 | 1400 | 1950 | 7.75 | 5.6 | −372.5 |
| Manure | Flow | (collected Aug. 27, 2011) | | | | | | | | | |
| | | AD Process water—1 mm | 3.3 | 2.1 | NA | 1095 | 935 | 2100 | 7.94 | 6.5 | −374.3 |
| | | filtered (collected | | | | | | | | | |
| | | Aug. 27, 2011) | | | | | | | | | |

As shown by Table 13, the phosphorus concentration of the collected process water samples varied from 35 mg/L TP to 1600 mg/L TP due to changing conditions at the farm. Samples taken in late August and throughout September exhibited higher TP values because of the lower water level in the digester. Samples taken with the bilge pump and hose also exhibited higher TP values, presumably because the hose sampled from farther down the sampling tube than the cup and pole method.

### Example 14

This example evaluated the effect of increased Exxal 10 modifier, lower pH, and higher temperature through a series of simple phase disengagement tests.

A sample of AD process water (or “process water”) from a dairy farm in Circleville, Ohio was centrifuged (cold, near 5° C.) for 5 minutes without prior filtration. About 5 mm of light brown solids were observed at the bottom of the centrifuge tube after centrifugation.

For this test, 25 mL of the AD process water and 150 mL of extractant (9.1% Aliquat concentration, see Example 10) were combined in a 200-mL beaker with a disc magnetic stirrer. The liquids were stirred for 2 minutes at approximately 520 rpm (measured prior to addition of liquids). After 30 minutes, the aqueous phase was removed and allowed to settle in a graduated cylinder overnight. Three distinct phases formed: extractant, stable emulsion (or rag layer), and aqueous. All three phases were mixed continuously by a magnetic stir bar while 2.5-mL portions were placed in glass test tubes.

Three samples were treated with 0.25 mL, 0.50 mL, and 1.0 mL Exxal 10. They were stirred with pipettes and allowed to sit.

Three samples had pH adjusted by diluting 1.0 mL of 70% H₂SO₄ with 8.0 mL deionized (DI) water in a glass test tube and adding to the samples. The amounts added were 55 μL, 75 μL and 80 μL to adjust pH from 9.5 to 7, 6, and 5, respectively. These samples were stirred with pipettes and allowed to rest.

A water bath was made with a hot plate, stir disk, beaker, water, and thermometer. One sample each was held in the bath at temperatures of 30° C., 40° C., and 50° C. It was stirred with a pipette and allowed to sit.

It was found that increased modifier concentration has a negative impact on phase disengagement since it creates a stable emulsion. While not wishing to be bound by theory, it is presently believed that increased amount of modifier enabled the solid impurity particulates and water content to disperse into the E-phase. Whether this rag layer is desirable or not desirable would depend on its effect on the operation of the LLX process, such as whether it would enable the separation of the target solutes from the aqueous phase.

Increasing temperature and decreasing pH were found to cause quicker phase disengagement, but did not help to break the emulsion in the intermediate rag layer. Warming the mixed liquid phases typically lowers viscosities, which in turns enables faster microscopic separation of liquid phases and from the dispersed solid particulates. In the present example, the increased temperature did not enable the rag layer to be transformed into a liquid form, indicating that the solids in the rag layer were not likely to be soluble salt crystals, some slow forming extractable products, or similar products. It is presently believed that these particulars in the rag layer were likely to be insoluble materials, such as biopolymers and/or clay particulates from the anaerobic digester process and/or animal/food wastes. Such insoluble materials are likely to have a density and water content that are in-between that of E-phase and that of the aqueous phase. Such interface can be reduced or handled through mechanical means of skimming, pumping, floating, and other similar methods. Further, through these processes, the rag phase can be taken care of and the E-phase can be recovered from the rage phase and recycled back to the LLX of the present invention.

### Example 15

This example evaluated the performance levels of various compositions of extractant. Extractant performance was determined by separation effectiveness and the amount of phosphorus left in the aqueous solution after mixing it with the AD process water.

The extractant compositions prepared were as follows:

4.5 wt % Aliquat, 2.25 wt % Modifier, 93.25 wt % Solvent

4.5 wt % Aliquat, 4.5 wt % Modifier, 91 wt % Solvent

6.8 wt % Aliquat, 2.25 wt % Modifier, 90.95 wt % Solvent

6.8 wt % Aliquat, 4.5 wt % Modifier, 88.7 wt % Solvent

9.1 wt % Aliquat, 2.25 wt % Modifier, 88.65 wt % Solvent

9.1 wt % Aliquat, 4.5 wt % Modifier, 86.4 wt % Solvent

The extractant was prepared with Aliquat 336 from Cognis Corp., Exxal 10 alcohol from Exxon-Mobil, and 467 Solvent from Superior Chemicals. Six-hundred milliliters of each extractant composition was made in one liter containers.

After combining and mixing the components for each extractant batch, they went through a series of contacts or washes to carbonate the E-phase. The first three contacts were with 8% K₂CO₃ to load the extractant with carbonate. In each wash, the 8% K₂CO₃ was added to the extractant in an extractant to aqueous (E/A) ratio of 2:1 (twice as much extractant as aqueous). Each mixture was shaken by hand for up to five minutes and allowed to separate in a separation funnel. The aqueous phase was drained out, and the volume and pH were recorded.

The next two contacts were with DI water to remove impurities. In each wash, DI water was added to the extractant to achieve an E/A ratio of 2:1, shaken by hand for two minutes, and allowed to separate. Caution was used in the second DI washes because it was found that a solution mixed for too long or too vigorously could produce a stable, milky-white emulsion. After the extractant and aqueous layers separated, the aqueous layer was pumped out. It was believed that if the solutions were transferred into a separation funnel, the solution might re-mix and possibly emulsify. After removing the aqueous solutions, their volumes and pH were recorded.

The last two contacts or washes were with 45 wt % KOH. It was found that when the extractant was not contacted with the 45 wt % KOH, the extractant anion became HCO₃⁻ instead of remaining as the di-anion CO₃²⁻. These washes were performed to raise the pH of the extractant and convert the HCO₃⁻ to CO₃². In each wash, the 45 wt % KOH solution was added to the extractant by using an E/A ratio of 2:1, and then the mixture was shaken by hand for 3 minutes and allowed to separate. Upon separation, the mixture was transferred into a separation funnel and the aqueous layer or phase was drained out. The volume and pH of the aqueous solutions were recorded. It was observed that the extractant turned from relatively colorless to a clear yellow liquid during the 45% KOH washes. It is presently believed that the yellow color was caused by the organic impurities left in the Aliquat 336 from the manufacturer. For this reason, 0.1 to 1.0 M KOH might be better for washing Aliquat 336 carbonate solution, especially prior to storage.

### Extractant Testing

After completing extractant preparation, each extractant composition was mixed with a sample of the filtered AD process water: The AD process water was filtered to remove the solids by using three different filter sizes: 20-25 μm, 0.125 mm, and 1.0 mm.

Six different extractant concentrations were combined with three different samples of the filtered AD process water for a total of 18 batch tests. Each solution was mixed with a magnetic stirrer for two minutes and transferred into a separation funnel. After a 10-minute separation period, the aqueous layer or phase was drained into a centrifuge tube.

The aqueous phases were centrifuged for 5 minutes at a high speed. After centrifuging, the volume of extractant and aqueous solutions within each sample were measured. Using the following equation, the separation effectiveness was calculated for each sample:

$${E}_{sep} = ( 1 - \frac{{V}_{extractant}}{{V}_{total}} ) * 100 ( \% )$$

After determining the separation effectiveness for each sample, the aqueous phase was sent for analysis to evaluate the efficacy of the extractant composition for phosphorus removal.

### Results:

Although the measured phosphorus removal from the process water was high, the overall results from the batch testing were low compared to the results found in Examples 7 to 11, primarily due to the minimal phase separation. To improve the results, several changes were proposed:
Use an impeller from the FLLX Unit C to mix the extractant and AD process water instead of a magnetic mixer. It was believed that using the LLX impeller might give results closer to what would be achieved during the continuous flow experiment.
Perform a second contact of the previously treated AD process water with fresh extractant. This approach is representative of the counter-current operation of the continuous flow bench test equipment.
Mix untreated AD process water with used extractant, for the same reason as given above.
Add anti-foam additive to the mixture. It was believed that the additive could help break any emulsions in the solutions.

It was concluded that the filtration size of the AD process water did not significantly impact extractant performance. Due to the time necessary to filter the AD process water with the 20-25 μm filter size, the AD process water was filtered at either 0.125 mm or 1.0 mm for future testing. Table 15 provides the results from this round of extractant testing. The results show that the extractant with the compositions of either 4.5% Aliquat and 4.5% modifier or 9.1% Aliquat and 2.25% modifier did not extract phosphorus as well as other compositions. However, they did appear to improve the phase disengagement at an E:A ratio of 3:1.

TABLE 15
Results from Preliminary Extractant Composition Screening

| | Separation | Average Total |
|---|---|---|
| Extractant and Process | Effectiveness | Phosphorus |
| water Combination | (%) | (mg/L) |
| 1 mm filtered process | | 128.5 |
| water | | |
| 4.5% A 2.25% M | 62.5 | 0.6 |
| 4.5% A 4.5% M | 73.7 | 1.6 |
| 6.8% A 2.25% M | 68.8 | 0.5 |
| 6.8% A 4.5% M | 67.4 | 0.0 |
| 9.1% A 2.25% M | 76.8 | 2.3 |
| 9.1% A 4.5% M | 60.0 | 1.3 |
| .125 mm filtered process | | 126.2 |
| water | | |
| 4.5% A 2.25% M | 64.6 | 0.0 |
| 4.5% A 4.5% M | 78.1 | 2.0 |
| 6.8% A 2.25% M | 73.7 | 0.0 |
| 6.8% A 4.5% M | 68.9 | 0.0 |
| 9.1% A 2.25% M | 70.5 | 5.8 |
| 9.1% A 4.5% M | 56.8 | 0.2 |
| 20-25 μm filtered process | | 15.3 |
| water | | |
| 4.5% A 2.25% M | 69.8 | 0.0 |
| 4.5% A 4.5% M | 80.6 | 6.5 |
| 6.8% A 2.25% M | 77.3 | 3.0 |
| 6.8% A 4.5% M | 67.4 | 0.0 |
| 9.1% A 2.25% M | 67.4 | 0.0 |
| 9.1% A 4.5% M | 61.2 | 0.0 |

### Example 16

This example examined the effects of treating the treated AD process water and using the used extractant: the used AD process water with the unused extractant, the untreated AD process water with the used extractant, the used AD process water and the used extractant were prepared. To do this, 150 mL of each extractant composition was mixed with 50 mL of AD process water. The solutions were mixed with an impeller from the LLX continuous flow set-up for 2 minutes at ˜600 rpm, and transferred into a separation funnel and allowed to sit for 10 minutes. After this period, both the aqueous and extractant layers were collected and became the used AD process water and extractant.

Unused extractant of each composition was added to the used AD process water to bring the total volume to 200 mL. The solution was mixed for 2 minutes at ˜600 rpm with an LLX impeller, then transferred into a separation funnel and allowed to sit for 10 minutes. The bottom 50 mL was removed, centrifuged for 5 minutes, and allowed to sit overnight. The separation effectiveness was calculated using the above mentioned formula in Example 15.

The Untreated AD process water was then mixed with the used extractant of each extractant composition. The untreated AD process water was added to the used extractant in an amount to reflect an E/A ratio of 3:1. Each mixture was mixed for 2 minutes at ˜600 rpm with an LLX impeller, transferred into a separation funnel, and allowed to sit for 10 minutes. After the 10-minute period, the bottom 50 mL was removed. Each 50-mL sample was centrifuged for 5 minutes and allowed to sit overnight. The separation effectiveness was calculated using the formula in Example 15. Table 16 summarizes separation effectiveness for the different extractant.

TABLE 16
Summary of separation Effectiveness
for Various Extractant Compositions

| | Separation | |
|---|---|---|
| | Effectiveness (%) | |
| | Old Process | New Process |
| Extractant | water, New | water, Old |
| Composition | Extractant | Extractant |
| 4.5% A 2.25% M | 85% | 56% |
| 4.5% A 4.5% M | 62% | 71% |
| 6.8% A 2.25% M | 73% | 64% |
| 6.8% A 4.5% M | 50% | 67% |
| 9.1% A 2.25% M | 82% | 68% |
| 9.1% A 4.5% M | 86% | 68% |

Based on the results in Table 16, it was found that the composition comprised of 9.1 wt % Aliquat, 4.5 wt % Modifier, and 86.4 wt % Solvent showed the best separation effectiveness. More extractant solution at this composition was prepared for the extraction and stripping batch tests in the next examples.

More importantly, all of the formulations of Table 16 were found to be effective for the removal of P-based ionic species. In particular, the results show that the effective E-phase compositions include the Aliquot (“amine” or “A”) range of about 4.5% to about 9.1%, the modifier (“M”) range of about 2.25% to about 4.5%; the balance being a nonflammable diluent). It is therefore believed that actual effective ranges would span larger than these, from about 2% to 25% A and from 0% to about 50% M.

It was observed that the anti-foaming additive and the impeller from the LLX continuous flow set-up caused no significant change to the results.

### Example 17

This example evaluated the technical feasibility of processing samples of the food-based process waters by the LLX method. All tests performed were carried out in a batch mode. Properties evaluated included phase separation, phosphate removal efficiency, and methods to handle solids contained within AD food process waters. These evaluations were performed in preparation for the continuous flow demonstration of the LLX process.

### Characterization of AD Process Water:

Four AD process water samples (can be referred to as “AD process water”) were obtained from a local farm with facilities located in Zanesville, Wooster, and Columbus Ohio, one in April and three in September. After delivery, all samples were stored in a cold room maintained at approximately 4° C. All samples were characterized within 1 or 2 days following receipt. Table 17A lists the results of characterization for all four samples.

All four samples contained very high phosphate concentrations ranging from 2,500 to 4,400 mg/L. Ammonia concentrations were found to be between 2,000 and 3,700 mg/L. The samples of the AD process water had drastically different viscosities including some that were too high for the LLX processing without using one or more pretreatment processes, such as increasing process water temperature to 30-70 C, adjusting mixing shear rate/impeller type, pH adjustment to the isoelectronic point (“pI”), filtration, dispersion, and/or dilution.

One sample of the AD process water from the Zanesville Ohio facility had a viscosity of 13 centistokes, which allowed for easy mixing and dispersion within the LLX bench scale processing equipment. Samples from Wooster Ohio and Columbus Ohio facilities had viscosities as high as 900-1,300 centistokes. While processing of these process waters in the LLX system, certain processes were used to lower the viscosity.

The total and volatile solid content was relatively uniform for all three samples, between 6.6-8.2% for total solids and between 3.0-5.4% for volatile solids. This indicates that the large viscosity differences are not due to higher or lower solids content in the process water. All tested samples were neutral to slightly basic with pH levels between 7.4 and 8.2.

TABLE 17A
Results of Characterization of AD Food-Based Process water Samples

| | | | | Nutrients | | | | | |
|---|---|---|---|---|---|---|---|---|---|
| | Solids | | | | Ortho | | | | |
| | | Total | | Total | P | Ammonia | | | |
| | TS | Volatile | Viscosity | Phosphate | (PO₄) | (NH₃—N) | | Dissolved | ORP |
| Sample Description | % | Solids % | (centistokes) | (PO⁴) mg/L | mg/L | mg/L | pH | O % | (mV) |
| Process water sample | 6.6 | 3.6 | NA | 3,300 | NA | 2,000 | 7.76 | NA | NA |
| collected in April 2011 | | | | | | | | | |
| Processwater sample | 8.2 | 5.4 | 13 | 2,500 | 2,495 | 3,700 | 8.23 | 1.2 | −304.3 |
| collected on Sep. 15, 2011 | | | | | | | | | |
| Process water Sample, | 8.1 | 3.3 | 900-1,300 | 4,400 | 4,950 | 2,000 | 7.41 | 6.6 | −256.4 |
| primary digester, | | | | | | | | | |
| collected on Sep. 15, 2011 | | | | | | | | | |
| Process water Sample, | 8.2 | 3.0 | 900-1,300 | 5,200 | 6,100 | 2,800 | 7.76 | 0.3 | −263.5 |
| dual digester, collected | | | | | | | | | |
| on Sep. 15, 2011 | | | | | | | | | |

### Initial Tests

The challenge with some of AD process waters was its very high viscosity and solids content—unsupported pipettes placed in the process water would stand straight up for hours. In the early AD process water trials, E/A was maintained at 3 parts (6.8% Aliquat, 4.5% modifier) extractant, and 1 part process water, although trials were run with the AD process water diluted 2× and 4× by volume with DI water. While not wishing to be bound by theory, it is presently believed that other combinations of alternative pretreatments and handling means mentioned above could also be effective. Dilution is readily accomplished for this screening testing. Non-dilution methods are more preferred since they keep the size of processing hardware as small as possible, reducing the cost associated with the larger size processing hardware.

The extractant solution and process water were mixed with an impeller for 2 minutes at 600 rpm, and then transferred to a separatory funnel for 10 minutes, after which the bottom layer was removed and retained as treated AD process water and the top layer retained as the used extractant. These used portions of the extractant were combined with fresh or “new” extractant and “new” AD process water, respectively. When using the used extractant, “new” AD process water was added in a portion that conserves the 3:1 ratio, and vice versa. For both combinations, the original volume of AD process water present was removed from the bottom of the separatory funnel, centrifuged 5 minutes, set overnight, and the separation efficiency was calculated as done previously. TP analysis was also performed on the processed AD process water.

The first test was done with 50 mL of unfiltered, undiluted AD process water and 150 mL of extractant. The separatory funnel was clogged by the AD process water and no process water was collected for analysis. A larger valve opening would be required to enable flow. Alternatively, other mechanical means, such as slurry pump, rake, or an auger, could be used to remove such material at production scales.

The second test was run with 50 mL of the undiluted AD process water filtered at 1 mm and 150 mL of extractant. About 100 mL of the bottom phase and 100 mL of the top phase (“E-phase”) were separated and removed from the separatory funnel. The bottom phase (the treated AD process water) was combined with 100 mL of fresh or “new” extractant. Fifty milliliters was taken from the separatory funnel, and the separation efficiency was calculated to be 50%. The 100 mL of “old” e-phase was combined with 33 mL of “new” 1-mm filtered AD process water and 33 mL was removed from the separatory funnel. The separation efficiency was calculated to be 94%.

The third and fourth tests were done in the same manner, and TP was tested in all the AD process water samples. Phase separation and phosphorus results are included in Table 17B.

TABLE 17B
Analytical and Phase Separation Results from AD Process water Trials

| | Total Phosphate | Separation |
|---|---|---|
| Sample Description | mg/L | Efficiency |
| Unfiltered, untreated AD process water | 3320 | N/A |
| Old AD process water + new E-phase | 70.5 | 25% |
| (undiluted process water) | | |
| NewAD process water + old E-phase | 2620 | 94% |
| (undiluted) | | |
| Old AD process water + new E-phase | Emulsified | 60% |
| (1:3 dilution process water) | | |
| Old AD process water + new E-phase | Under-reading | 40% |
| (1:1 dilution process water) | (<0.1) | |
| New AD process water + old E-phase | 11.75 | 44% |
| (1:3 dilution process water) | | |
| New AD process water + old E-phase | 196.5 | No Separation |
| (1:1 dilution process water) | | |

Subsequent AD Process Water Tests with Dilution Pretreatment

The second group of phase separation tests was performed on the AD process water from a local farm's Wooster facility. These tests used the tests described previously. The high viscosity of this sample was reduced by dilution with tap water. Two dilution levels were evaluated: 1:1 and 1:3 process water:tap water ratios by volume. Separation efficiencies were evaluated for extraction with fresh process water and fresh extractant, as well as for systems with previously extracted (used) process water and extractant. The last two tests simulated phase separation conditions during continuous flow counter current LLX operation with two extraction stages. Tests run with fresh AD process water and the used extractant solution simulated conditions in a first extraction stage (E1) in a counter-current configuration as shown in FIGS. 25 and 26. Tests run with previously treated process water and fresh extractant simulated conditions characteristic to the second extraction stage (E2).

Table 17C presents results of initial phase separation tests. A very broad range of phase separation efficiencies were observed, from 10% to 94%, and these values did not seem to correlate with dilution level or with the type of experiment. Overall, the initial phase separation tests appeared to be inconclusive, pointing to a possibility that the phase separation test method does not properly evaluate phase separation. It was theorized that the phase separation test, especially the use of a separatory with conical geometry, may give misleading values of phase separation efficiencies that do not represent phase disengagement characteristics in the actual LLX mixer-settler equipment. It was decided that phase separation experiments should be carried out in a simple graduated beaker and with a disc-shaped mixer for the sequent examples, which would simulate typical LLX commercial plant operations.

TABLE 17C
Phase Separation Efficiency for Different Extraction Conditions and Dilution Levels

| | Phase Separation Efficiency | | |
|---|---|---|---|
| Experiment | No dilution | 1:1 water dilutiont | 1:3 water dilution |
| Fresh process water + fresh extractant | NA | 48% | 62% |
| Fresh AD process water + extractant | 9.4% | 10% | 44% |
| used once (E1 conditions) | | | |
| AD process water used once + | | | |
| extractant used once (E1 conditions | 25% | 40% | 60% |

Extraction carried out at E/A = 3 using extractant containing 9.1% Aliquat 336, 4.5%
Exxal 10 modifier, in 467 solvent.

Table 17D presents the total phosphate levels detected in the aqueous phases recovered during the initial phase separation experiments. Very effective phosphate recovery was observed, especially after the water dilution and the following double extraction. The observed phosphate reduction levels demonstrate that the LLX method is highly effective for treatment of AD food-based process waters.

TABLE 17D
Total Phosphate Removal For Different Extraction Conditions And Dilution Levels

| | Total Phosphate (PO₄) Remaining mg/L | | |
|---|---|---|---|
| Experiment | No dilution | 1:1 water dilution | 1:3 water dilution |
| Fresh process water + fresh extractant | 3,320 | 1,660 | 830 |
| | | (calculated) | (calculated) |
| Fresh AD process water + extractant | 2,620 | 196 | 12 |
| used once (E1 conditions) | | | |
| AD process water used once + | | | |
| extractant used once (E1 conditions) | NA | <0.1 | NA |

Extraction carried out at E/A = 3 using extractant containing 9.1% Aliquat 336, 4.5%
Exxal 10 modifier, in 467 solvent.

Later, additional AD food-based process water samples were collected from a local farm's facilities in Zanesville and Columbus. Low viscosity process water from Zanesville was used for phase separation and phosphate removal tests. Outcomes of these tests were found to be quite sensitive to mixing conditions. Both extractions were carried out at E/A=3 by using fresh extractant containing 9.1% Aliquat 336, 4.5% Exxal 10 modifier, and 467 solvent. In both cases, the process water was previously extracted at E/A=1 and the experiments simulated E2 conditions in a two extraction stage continuous flow process. Rapid phase separation was observed at 1 minute 20 seconds and at 5 minutes following mixing at 600 rpm for 1 minute. The phase separation was very rapid and the observed thickness of both layers was consistent with the E/A=3/1 ratio used. However, an essentially identical experiment performed with a brief shaking (by hand, in a closed container) prior to mixing with a disc-shaped stirrer at 600 rpm for 1 minute showed a very poor phase separation. In the shaking experiment, an emulsion was formed and little separation was accomplished even after the 5 minute duration. While not wishing to be bound by theory, it is presently believed that a separatory funnel with a conical shape (or other similar containers) might result in excessive mixing shear from more vigorous mixing, which in turn might cause the formation of ultra-small droplets. These ultra-small droplets require a much longer phase separation time, which may be hours or even days. The use of tanks or other engineered mixers might reduce the occurrence of excessive mixing shear force and promote phase separation.

Process waters recovered during both experiments were analyzed for total phosphate content. Results of these tests, shown in Table 17E, indicate that phosphate removal efficiency is also very dependent on mixing conditions. Gentler mixing, which led to the rapid phase separation, only reduced phosphate concentration to 800 mg/L. A more vigorous mixing applied during extraction reduced this concentration to 22 mg/L. The finding suggests that much of the P-based species are contained inside of the bio-solids or low solubility solids of the AD process water. It is possible that the extractant is able to penetrate these bio-solids or low solubility solids, within which the extractant pairs with the organic phosphates such as DNA, ATP, cell wall materials, and the like, to bring them into the E-phase for recovery. This is an unexpected and valuable feature of the present invention.

TABLE 17E
Total Phosphate Removal for Different Extraction Conditions and the
Mixing Conditions used in Experiments as shown in Error! Reference
source not found. and Error! Reference source not found..

| | Total |
|---|---|
| | Phosphate |
| Sample Description | (PO₄) mg/L |
| AD process water from a local farm Zanesville, as received | 2,500 |
| AD process water from a local farm Zanesville, after single | 1,400-2,100 |
| extraction | |
| AD process water from a local farm Zanesville, after double | 800 |
| extraction, aqueous phase recovered from experiment shown | |
| in FIG. 1 | |
| AD process water from a local farm Zanesville, after double | 22 |
| extraction, more vigorous mixing, aqueous phase recovered | |
| from experiment shown in FIG. 2 | |

Extraction carried out at E/A = 3 using 9.1% Aliquat 336, 4.5% Exxal 10
modifer, in 467 solvent.

The results of the combined phase separation and phosphate removal tests demonstrate that the processing of AD food-based process waters by the LLX process is feasible but challenging. Several conditions will have to be carefully adjusted to balance efficient phosphate recovery with rapid phase separation. These conditions include mixer blade tip shear, mixing time, E/A ratio, viscosity adjustment (see above for the list of options to adjust viscosity), pump mixing shear effects, phase settling time, and the like.

### Testing of Methods for Lowering the Viscosity of the Concentrated AD Process Water

AD food-based process water samples from Wooster and Columbus were too viscous for direct processing in the LLX bench scale equipment. Two methods to lower the viscosity were tested: increase pH of the solution and dilution with water. Primary digester process water from a local farm in Columbus was used in both tests. The pH increase was realized by a gradual addition of 45 wt % KOH solution until the pH reached 10.7. Viscosity of the process water was monitored by a cup method, which determines the time needed for the tested liquid to drain from a cup of a certain geometry. The time required for draining corresponds to the viscosity of the liquid. The tests indicated some reduction of viscosity, from 900-1,300 centistokes for untreated process water to 430-650 centistokes measured once pH reached 9.6. However, this reduction of viscosity was not sufficient for the LLX processing of the present invention. The second method to reduce process water viscosity was water dilution. Tap water was used in these tests in order to avoid artificial effects from distilled or deionized water. As shown in Table 17F, water dilution effectively reduced viscosity when applied at 1:1, and more visibly at 1:3 levels.

TABLE 17F
Effects of KOH Addition and Water Dilution on AD Process
water pH and Viscosity

| Sample Description | pH | Viscosity |
|---|---|---|
| AD process water from a local farm Columbus, primary | 7.4 | 900-1,300 |
| digester, as received | | |
| AD process water from a local farm Columbus, primary | 9.6 | 430-650 |
| digester, with 1.5 vol % of 45 wt % KOH solution | | |
| AD process water from a local farm Columbus, primary | 10.7 | 430-650 |
| digester, with 3.0 vol % of 45 wt % KOH solution | | |
| AD process water from a local farm Columbus, primary | NA | 12 |
| digester, diluted with water (1 part process water, 1 part | | |
| water) | | |
| AD process water from a local farm Columbus, primary | NA | <10 |
| digester, diluted with water (1 part process water, 2 | | |
| parts water) | | |
| AD process water from a local farm Zanesville, as | 8.2 | 13 |
| received AD process water from a local farm Zanesville, | 10.2 | 16 |
| with 2.8 vol % of 45 wt % KOH Solution | | |

Viscosities of common liquids, listed for comparison

| | | |
|---|---|---|
| Pure water | — | 1 |
| Olive oil | — | 100 |
| Glycerin | — | 4 |
| Molasses | — | 4,000 |

### Conclusion:

Analysis of the AD food-based process water samples collected from various farm facilities demonstrated that these process water samples contained very high levels of phosphate and ammonia nutrients. The LLX process has the potential to effectively recover phosphate from these process waters assuming proper mixing conditions are applied. Viscosity of AD food-based process waters can be lowered effectively by water dilution. The next step in the process development was continuous flow LLX process testing with AD food-based process waters to develop complete process conditions and operating parameters to maximize phosphate and extractant recovery.

### Example 18

This example used batch tests to determine the effective E/A ratio(s) and the pH range for the extraction and stripping of nutrients from the AD process water.

AD process water was filtered with 0.125 mm filtration screen, and the extractant with the composition of 9.1 wt % Aliquat, 4.5 wt % Modifier, and 86.4 wt % Solvent was used in the extraction batch tests. Table 18A summarizes the experiments performed.

TABLE 18A
Batch Extraction Experiments Performed

| | | | |
|---|---|---|---|
| | | Volume of AD | |
| | E/A | process water | |
| Experiment # | Ratio | (mL) | Comments |

Experiment with original pH of AD process water

| | | |
|---|---|---|
| 1 | 3:1 | 100 |
| 2 | 2:1 | 100 |
| 3 | 1:1 | 100 |
| 4 | 1:2 | 100 |
| 5 | 1:3 | 100 |
| 6 | 1:0 | 100 |
| 7 | 1:12 | 100 |

Experiment with adjusted pH

| | | | |
|---|---|---|---|
| 8 | 1:1 | 100 | Increase pH by ~1-2 |
| | | | using KOH addition |
| 9 | 1:1 | 100 | Decrease pH by ~1-2 |
| | | | using H₂SO₄ addition |

For each test run, the extractant and AD process water were combined in a ˜600 milliliter beaker and mixed for two minutes at ˜600 rpm using an impeller from the LLX continuous flow set-up. The solution was transferred into a separation funnel and allowed to sit for 10 minutes. After this period, 100 mL of the bottom aqueous phase was drained into two 50-mL centrifuge tubes and the top extractant phase was disposed. The aqueous phase was centrifuged and allowed to settle overnight. The next day, the clear portion of the recovered aqueous was submitted for analysis.

For test number eight, the pH was increased from 8.1 to 9. 6 with the addition of 10 drops of 45 wt % KOH. For test number nine, the pH was decreased from 8.0 to 6.6 with the addition of 8 drops of 70% H₂SO₄.

In order to provide a homogenous solution throughout the tests to minimize the possibility of error, a 1-liter bottle containing the AD process water was allowed to sit to room temperature and continuously stirred with a magnetic stirrer disc. The AD process water needed for each test was drawn from this bottle. By continuously stirring the AD process water, no parts of the AD process water were allowed to settle to the bottom, maintaining the AD process water at a constant condition.

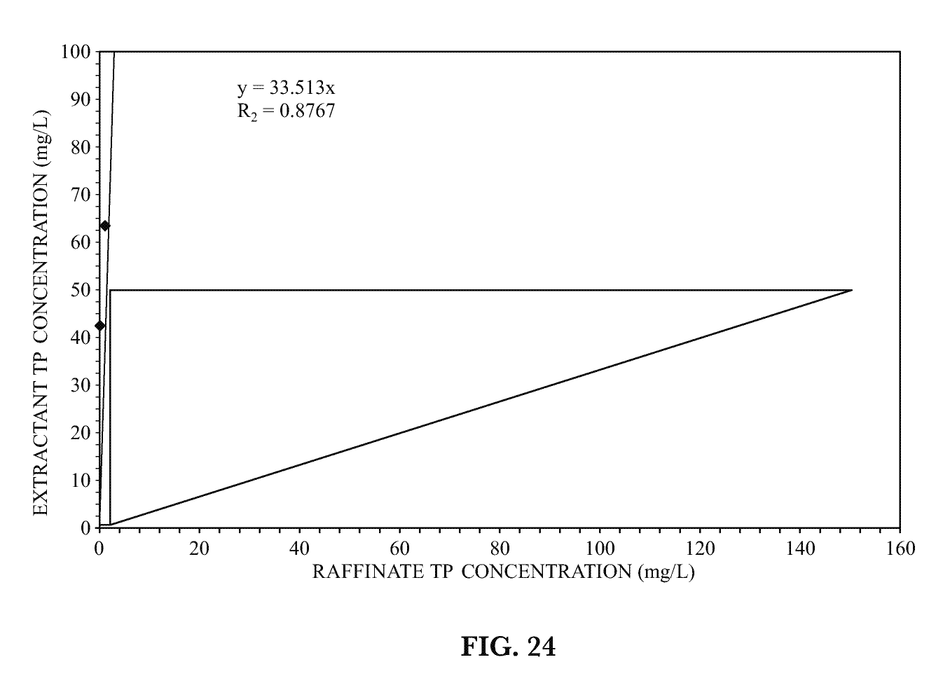

Analytical results from the extraction batch tests are provided in Table 18B. These results were used to construct an equilibrium line for a McCabe Thiele diagram (provided in FIG. 24). Based on this data it was determined that two extraction stages would be sufficient for this AD process water to achieve the phosphorus removal target of <1 mg/L. The McCabe Thiele analysis also reveals a great deal of flexibility for the E:A ratio. The lower blue line represents the operating line for a 3:1 E:A ratio, and as the E:A decreases, the slope of the operating line increases. This suggests low extraction sensitivity to E:A ratio, allowing for adjustments to improve phase disengagement.

TABLE 18B
Analytical Results from Extraction Batch Testing

| E/A Ratio | TP (mg/L) |
|---|---|
| Untreated farm AD process water | 128.0 |
| 3:1 E/A Ratio Original process water | under-reading |
| pH | (<1) |
| 2:1 E/A Ratio Original process water | under-reading |
| pH | (<1) |
| 1:1 E/A Ratio Original process water | 1.1 |
| pH | |
| 1:2 E/A Ratio Original process water | 7.2 |
| pH | |
| 1:3 E/A Ratio Original process water | 11.6 |
| pH | |
| 1:6 E/A Ratio Original process water | 25.7 |
| pH | |
| 1:12 E/A Ratio Original process water | 28.8 |
| pH | |
| 1:1 E/A Ratio Higher process water pH | 3.4 |
| 1:1 E/A Ratio Lower process water pH | 5.6 |

### Stripping Tests

The stripping batch tests were conducted to identify the most effective operating parameters for the stripping stages, which concentrate the nutrient in the product while at the same time regenerate the E-phase for reuse or recycle. The extractant with composition 9.1 wt % Aliquat, 4.5 wt % Modifier, and 86.4 wt % Solvent was prepared as described above, and 30 wt % K₂CO₃ were used in the stripping batch tests. The extractant was preloaded (simulated extraction) by contacting with the AD process water at a 10:1 process water to extractant ratio (A/E ratio), or the E/A ratio of 1:10. During preloading, a tertiary intermediate phase (the rag layer) was formed and was taken out with the aqueous phase or layer. The clear extractant phase on the top was used in the stripping tests.

For each experiment, the extractant and 30% K₂CO₃ were combined in a ˜600 mL beaker and mixed for 2 minutes at ˜600 rpm using an impeller from the LLX continuous flow set-up. A small amount of 45 wt % KOH was added to the solution and was mixed for ˜10 seconds. The pH was then immediately recorded. This process continued until the pH was above 13. The amount of 45 wt % KOH added was also recorded. Once the solution reached a pH above 13, it was transferred into a separation funnel and allowed to sit for 10 minutes. After this period, 100 mL of the bottom aqueous phase was drained into two 50-mL centrifuge tubes. The top extractant phase was also drained and saved. The aqueous phase was centrifuged and allowed to settle overnight. The next day, the clear portion of the recovered aqueous phase was submitted for analysis. Results are given in Table 18C.

TABLE 18C
Analytical Results from the Stripping Batch
Tests excluding the Intermediate Phase

| Stripping E:A | Volume of 30% | |
|---|---|---|
| Ratio | wt K₂CO₃ (mL) | TP (mg/L) |
| 3:1 E/A | 100 | 16.5 |
| 1:1 E/A | 100 | under-reading |
| 1:3 E/A | 100 | under-reading |
| 1:10 E/A | 100 | under-reading |

As can be seen in Table 18C, it seems that phosphate ions were not stripped. It was assumed that the phosphate is actually contained in the intermediate tertiary phase that was removed with the aqueous phase during pre-loading of the extractant. This tertiary phase was thought to contain the aliquat-encapsulated polyphosphates. One stripping test was performed on the tertiary phase to check whether the tertiary phase was where the extracted phosphates resided. The Loaded extractant and 30% K₂CO₃ were contacted at a 1:1 ratio, and the stripping solution showed 269 mg/L TP after the contact, confirming that the phosphate was extracted into the tertiary phase. Because there was only one data point, a McCabe Thiele plot was not constructed, but the partition coefficient was calculated to be 3.3 for this trial. The results suggest that stripping was not very efficient or complete. Therefore, to ensure adequate stripping of the phosphate from the loaded E-phase, all five stripping stages in the bench top set up were used for the continuous flow testing, as described in the following examples.

### Example 19

This example evaluated a range of effective process control parameters and flow configurations for a continuous flow bench-scale run for extracting nutrients from the AD process water. Three separate test runs were performed: the first test run to verify extraction of phosphorus from the AD process water and stripping of phosphorus from the extractant; the second to test the effect of KOH pre-treatment of the process water; and the third to improve phase disengagement and to further concentrate the phosphate product from the LLX process. The LLX bench-scale system was run for over 94 hours.

### Test Run #1—Extraction and Stripping Verification Run

FIG. 25 shows a process flow schematic of the continuous flow mixer-settler LLX unit configured for the extraction and stripping verification run (a counter-current configuration for both the extraction phase and the stripping phase). The AD process water and the extractant were fed counter-current to the two extraction stages at a ratio of one part process water (aqueous solution) per three parts of extractant (E:A ratio of 3:1). The AD process water was fed from a five gallon bucket that was mixed on a stir plate with a three-inch magnetic stir bar. The 45 wt % KOH solution (the second aqueous base solution) was fed into the first stripping stage (S1 in FIG. 25) to maintain a pH above 13, assuring that the carbonate stripping solution is not converted to bicarbonate, which was found to reduce stripping efficiency in the previous examples. 30 wt % K₂CO₃ (the first aqueous base solution or the aqueous stripping solution) was fed to the fifth stripping stage (S5), and the sixth stripping stage was converted to a water wash (WW) to remove excess ions from the extractant before recycling to the extractant surge tank. Process parameters for the run are provided in Table 19A.

TABLE 19A
Rough Process Parameters during the Test Run #1

| | E1 | E2 | S1 | S2 | S3 | S4 | S5 | WW |
|---|---|---|---|---|---|---|---|---|
| Mixer Volume (mL) | 198 | 191 | 216 | 216 | 216 | 216 | 216 | 216 |
| Settler Volume (mL) | 1200 | 1178 | 390 | 390 | 390 | 390 | 390 | 390 |
| Extractant (mL/min) | 18 | 18 | 18 | 18 | 18 | 18 | 18 | 18 |
| Process water (By | 6 | 6 | 180 | 180 | 180 | 180 | 180 | 0 |
| Recycle in Stripping | | | | | | | | |
| Stages, mL/min) | | | | | | | | |
| Base (30% wt K₂CO₃, DI | 0 | 0 | 11.0 | 11.0 | 11.0 | 11.0 | 11.0 | 0.0 |
| in WW) in (mL/min) | | | | | | | | |
| Base (45% wt KOH) in | N/A | N/A | N/A | N/A | N/A | N/A | N/A | N/A |
| (mL/min) | | | | | | | | |
| Raffinate Out (mL/min) | | 16.0 | | | | | | |
| Total Flow Rate (mL/min) | 24 | 24 | 209 | 209 | 209 | 209 | 209 | 18 |
| E/A | | | 0.10 | 0.10 | 0.10 | 0.10 | 0.10 | 0.5 |
| pH | 8.5-9.5 | 8.5-9.5 | 13-14 | 12-13 | 12-13 | 12-13 | 12-13 | 12-13 |
| Mixing Speed (rpm) | 1600 | 1500 | 1750 | 1800 | 1750 | 1450 | 1700 | 1500 |
| Mixer Residence Time | 8.3 | 8.0 | 1.0 | 1.0 | 1.0 | 1.0 | 1.0 | 12.0 |
| (min) | | | | | | | | |
| Settler Residence Time | 50.0 | 49.1 | 1.9 | 1.9 | 1.9 | 1.9 | 1.9 | 21.7 |
| (min) | | | | | | | | |

The AD process water was fed at 6 mL/min, the extractant at 18 mL/min, and the carbonate stripping solution at 11 mL/min. The carbonate stripping solution was fed in excess partly to assure effective stripping of the extractant and partly due to pumping equipment limitations.

On the first day of this run, the extractant was not recycled so that if it was not adequately stripped, it would not contaminate the remainder in the surge tank. At the end of the day, the stripping efficiency was tested by combining the untreated AD process water with the stripped extractant in a 1:1 ratio, shaking for 1 minute, and testing the aqueous phase for TP. Analysis of the aqueous phase showed no residual TP, indicating that the extractant had been efficiently stripped of loaded nutrients. Therefore, the extractant was recycled after the second day of continuous flow testing.

It was observed during this run that the extractant does not flow continuously over the straight-wall overflow weirs in the bench scale LLX unit, and in later runs with higher solids-content process water, the extractant phase overflowed the settler before it ran over the weir to the next stage. Skimming or notched weirs might alleviate this issue.

Also during this run, an emulsified intermediate phase formed in the extraction stages. Coalescing media was inserted into the settlers to aid in disengagement, but it was later removed because it tended to clog and overflow the settlers while providing minimal improvement in emulsion reduction. Small volumes of this emulsion left the system with the raffinate. When the intermediate emulsion was later collected and centrifuged, it turned out to contain greater than 90% aqueous phase. The extractant was retained in the E-phase trap before the raffinate collection tank.

The first run was terminated after about 40 hours due to buildup of a thick jelly that formed between the aqueous and extractant phases in the last stripping stage with the water wash (“WW” stage). This viscous, emulsified phase was too thick to pipette and would not drain through the tubing, so it eventually displaced the extractant and fed the emulsion back to the extractant surge tank. When 50 mL of this jelly (“WW jelly”) was scooped out and centrifuged, it yielded about 10 mL of extractant, 11 mL of thicker jelly, and the balance was aqueous phase.

The thicker jelly that remained after centrifugation was submitted for XRD and EDS analysis after preparing it as described previously in the analytical methods section. The dried jelly contained what looked like small plant fibers, indicating that waste solids from the AD process water might contribute to the formation of the dried jelly. XRD spectra for these samples reveal that the jelly contains quartz, calcite, and a potassium-magnesium carbonate hydrate, and the EDS showed about 30% by weight Carbon and Oxygen, which is likely to be some form of cellulose, and 10 wt % Calcium, 9 wt % Magnesium, and 5 wt % Nitrogen.

Final samples of aqueous stripping phase from each stripping stage were taken for analysis before the system was emptied and rinsed with DI water. The analytical results for the run are provided in Table 19B. The results show that the aqueous samples from the stripping state contain no measurable phosphorus level. It might be caused by the high flow rate of carbonate stripping solution.

TABLE 19B
Final Analytical Results from the Test Run #1

| | Total |
|---|---|
| | Phosphate |
| Sample | (mg/L) |
| AD process water | 49.5 |
| Raffinate | Under-reading |
| KPO4 Product | Under-reading |
| S1 Aqueous | Under-reading |
| S2 Aqueous | Under-reading |
| S3 Aqueous | Under-reading |
| S4 Aqueous | Under-reading |
| S5 Aqueous | Under-reading |

### Test Run #2—KOH Pretreatment Test

Previous examples' results indicate that most of the phosphate might be extracted into a tertiary emulsified phase between the aqueous and organic phases. It was theorized that this tertiary phase contained the encapsulated polyphosphates, and that it was the same emulsion that was found in the extraction phases during the Test Run #1 the extraction and stripping verification run. This test run evaluated whether KOH pretreatment would hydrolyze the polyphosphates and reduce the appearance of this emulsion, and perhaps eliminate the jelly formation in the water wash. Table 19C provides rough process parameters for the run.

TABLE 19C
Rough Process Parameters for the KOH Pretreatment Test Run

| | E1 | E2 | S1 | S2 | S3 | S4 | S5 | WW |
|---|---|---|---|---|---|---|---|---|
| MixerVolume (mL) | 198 | 191 | 216 | 216 | 216 | 216 | 216 | 216 |
| Settler Volume (mL) | 1200 | 1178 | 390 | 390 | 390 | 390 | 390 | 390 |
| Extractant Flow | 18 | 18 | 18 | 18 | 18 | 18 | 18 | 18 |
| (mL/min) | | | | | | | | |
| Process Water Flow | 6 | 6 | 180 | 180 | 180 | 180 | 180 | 0 |
| (By Recycle in | | | | | | | | |
| Stripping Stages, | | | | | | | | |
| mL/min) | | | | | | | | |
| Base (30% wt K2CO3, | 0 | 0 | 0.5 | 0.5 | 0.5 | 0.5 | 0.5 | 0.5 |
| DI in WW) in (mL/min) | | | | | | | | |
| Base (45% wt KOH) in | N/A | N/A | N/A | N/A | N/A | N/A | N/A | N/A |
| (mL/min) | | | | | | | | |
| Raffinate Out (mL/min) | | 16.0 | | | | | | |
| Total Flow (mL/min) | 24.0 | 24.0 | 198.5 | 198.5 | 198.5 | 198.5 | 198.5 | 18.5 |
| E/A | | | 0.10 | 0.10 | 0.10 | 0.10 | 0.10 | 0.5 |
| pH | 8.5-9.5 | 8.5-9.5 | 13-14 | 12-13 | 12-13 | 12-13 | 12-13 | 12-13 |
| Mixing Speed (rpm) | 1300 | 1100 | 1700 | 1200 | 1300 | 1450 | 1450 | 1300 |
| Mixer Residence Time | 8.3 | 8.0 | 1.1 | 1.1 | 1.1 | 1.1 | 1.1 | 11.7 |
| (min) | | | | | | | | |
| Settler Residence Time | 50.0 | 49.1 | 2.0 | 2.0 | 2.0 | 2.0 | 2.0 | 21.1 |
| (min) | | | | | | | | |

FIG. 26 shows a process flow schematic of the continuous flow mixer-settler LLX unit configured for this KOH pretreat test run (a counter-current configuration for both the extraction phase and the stripping phase). The process flow schematic of FIG. 26 is the same as that of FIG. 25 except for the flow of DI water to the WW (Water Wash) stage (please see Test Run #1 for the process details).

As shown in FIG. 26, a steady flow of DI water was introduced into the stripping stage to evaluate whether this step would remove the solids that caused the jelly build up in the water wash during the Test Run #1. The water wash plumbing was changed so that a continuous trickle of DI water could be pumped in at the mixer and removed via a Y-overflow weir at the end of the settler. Also, the K₂CO₃ feed pump was swapped out for a new pump that could regulate flow down to 0.5 mL/min so that the phosphate product could be more concentrated. Finally, a smaller E-phase trap was constructed so that the raffinate flow rate could be measured over a short run time. FIG. 26 provides a flow schematic of the continuous flow mixer-settler LLX unit apparatus during the KOH pretreatment test.

The process water pH was adjusted to between 9 and 10 by dropwise addition of 45 wt % KOH into the feed bucket. The E:A ratio was maintained at 3:1 in the extraction circuit (18 mL/min extractant and 6 mL/min process water), and the pH in S1 was kept above 13 by KOH addition.

Formation of the jelly in the water wash settler continued in spite of the changes, and the KOH pretreatment had no observable effect on disengagement in the extraction stages, which continued to be poor. A test was run in beakers to determine whether an E:A ratio of 1:2, which would exhibit the properties of oil dispersed in water rather than water dispersed in oil, would improve disengagement. The 1:2 ratio disengaged much more rapidly in the beaker, and showed less tertiary phase emulsion. Based on the results for the 1:2 E/A ratio, the flows were changed to 10 mL/min extractant and 20 mL/min AD process water. Analysis performed on the raffinate showed good extraction (below 1 mg/L) of phosphorus with the lower E:A. However, the KOH pretreatment test was terminated after about 34 hours due to jelly forming in the water wash, which displaced the extractant.

A sample of the water wash jelly was collected and centrifuged, and the thicker jelly was sent for XRD analysis before drying (the wet jelly). XRD on the wet jelly showed the same crystalline phases identified before, namely quartz, calcite, and a potassium-magnesium carbonate hydrate. The jelly was allowed to air dry over a few days, and an EDS pattern was obtained. The compounds present and their proportion are given in Table 19D. The abundance of potassium in the dried solid could potentially make it a valuable and marketable fertilizer.

TABLE19D
Elemental Analysis of
Air-Dried Water Wash Jelly

| Element | Wt % | At % |
|---|---|---|
| C | 29.23 | 42.93 |
| N | 1.71 | 2.15 |
| O | 35.52 | 39.17 |
| Mg | 1.52 | 1.11 |
| Al | 0.2 | 0.13 |
| Si | 0.83 | 0.52 |
| P | 0.13 | 0.08 |
| S | 0.12 | 0.07 |
| K | 28.72 | 12.96 |
| Ca | 2.01 | 0.89 |

Final analytical results for the KOH pretreatment test gave an under-reading (<1 mg/L) on total phosphorus in the raffinate, and a reading of 26.8 mg/L for the phosphate product. The product was still not concentrated to the desired levels due to the entrained water flowing into the stripping stages with the extractant (through the intermediate emulsion or rag layer), low process water phosphorus content, and a large volume of carbonate stripping solution to load.

### Test Run #3—Phase Disengagement and Product Concentration

In order to improve phase disengagement, prevent aqueous overflow into the stripping stages, and to improve the product concentration, the extraction circuit was changed to a co-current configuration with two extraction stages (E1 and E2) as shown by FIG. 27. FIG. 27 provides a flow schematic for the continuous flow mixer-settler LLX unit apparatus with a co-current flow configuration for the extraction stage and a counter-current configuration for the stripping stage. The process flow schematic of FIG. 27 is similar to that of FIGS. 25 and 26 except (1) FIG. 27 provides a co-current flow configuration for the extraction stage, and no water was fed into the WW stage (see discuss below).

FIG. 27 shows that during the extraction phase, the AD effluent (a type of the process water) and the extractant phase were introduced into the top of the mixer for E1, forming an unstable emulsion, in which some of the P- and/or N-based ionic species were removed from the process water into or onto the extractant phase, resulting in a first treated (or processed) process water and an ion-loaded extractant phase. Then the treated process water (aqueous phase) and the ion-loaded extractant phase (extractant phase) were disengaged and separated in the settler of E1. Thereafter, the treated process water and the loaded extractant phase flowed to the mixer of E2 in two separate streams to undergo the second extraction stage: the treated process water and the loaded extractant phase were mixed to form a second unstable emulsion, in which at least a part of the remaining P- and/or N-based ionic species was removed from the process water into or onto the already ion-loaded extractant phase, resulting in the treated process water or processed water and the second ion-loaded extractant phase. The processed water then flowed out to be collected in a treated water tank (not shown).

The second ion-loaded E-phase then proceeded to the stripping stage to stripped of the ionic species. In this striping phase, the flow schematic and the details are the same as that of Test Run #1 (a counter-current configuration, see FIGS. 25 and 26) except that no water was fed into the WW stage.

By feeding the flows of both of the extractant and the AD process water into the top of the first mixer for the E-1 stage, the pumping requirement of the impeller is negated, and the impeller speed can be lowered, improving disengagement. The second impeller necessarily spins faster to pump the flows into the mixing box, but disengagement was still improved in the second extraction stage. A scale was also set up under the KOH feed tank to monitor the feed rate. Table 19E provides rough process parameters during this run.

TABLE 19E
Process Parameters during the Phase Disengagement and Product
Concentration Run

| | E1 | E2 | S1 | S2 | S3 | S4 | S5 | WW |
|---|---|---|---|---|---|---|---|---|
| Mixer Volume (mL) | 198 | 191 | 216 | 216 | 216 | 216 | 216 | 216 |
| Settler Volume (mL) | 1200 | 1178 | 390 | 390 | 390 | 390 | 390 | 390 |
| Extractant Flow | 10 | 10 | 10 | 10 | 10 | 10 | 10 | 10 |
| (mL/min) | | | | | | | | |
| Process Water Flow (By | 20 | 20 | 40 | 40 | 40 | 40 | 40 | 0 |
| Recycle in Stripping | | | | | | | | |
| Stages, mL/min) | | | | | | | | |
| Base (30% wt K2CO3, | 0 | 0 | 0.0 | 0.0 | 0.0 | 0.0 | 0.0 | 0.0 |
| DI in WW) in (mL/min) | | | | | | | | |
| Base (45% wt KOH) in | | | 0.6 | | | | | |
| (mL/min) | | | (.85 g/ | | | | | |
| | | | min) | | | | | |
| Raffinate Out (mL/min) | | 19.5 | | | | | | |
| Total Flow (mL/min) | 30 | 30 | 50 | 50 | 50 | 50 | 50 | 10 |
| E/A | | | 0.25 | 0.25 | 0.25 | 0.25 | 0.25 | 0.0 |
| pH | 8.5-9.5 | 8.5-9.5 | 13-14 | 12-13 | 12-13 | 12-13 | 12-13 | 12-13 |
| Mixing Speed (rpm) | 500 | 1600 | 1700 | 1200 | 1300 | 1500 | 1500 | 1500 |
| Mixer Residence Time | 6.6 | 6.4 | 4.3 | 4.3 | 4.3 | 4.3 | 4.3 | 21.6 |
| (min) | | | | | | | | |
| Settler Residence Time | 40.0 | 39.3 | 7.8 | 7.8 | 7.8 | 7.8 | 7.8 | 39.0 |
| (min) | | | | | | | | |

Plumbing for the water wash was changed so that no water was fed into the water wash stage (the “WW” stage in FIG. 27) at all. The water wash acted simply as a decanter to allow water and solids to disengage from the extractant before it was recycled. The water and solids (referred as the WW jelly) were separated and taken out from one tube, while the regenerated extractant flowed out to the extractant surge tank. This step reduced the jelly formation and the amount of the entrained water recycled to the extractant surge tank. There was also no carbonate stripping solution fed to the process so that the pre-charged carbonate solution would be as concentrated as possible.

The extractant solution was fed at 10 mL/min and the AD process water at 20 mL/min, maintaining the 1:2 E:A ratio that was found to improve phase disengagement in the previous test run. During this time, the dairy farm at Circleville Ohio, the source for the AD process water, began land applying water from their lagoons. This lowered the water levels in the digester, causing the samples to have higher solids content and phosphorus content. For the first half of this run, the AD process water had 441.5 mg/L TP, and the second half the AD process water had an increased phosphorus concentration of 1600 mg/L TP.

In spite of the higher phosphorus concentration in the process water, the LLX system was able to efficiently treat the AD process water. In the first half of the run, the TP was reduced from 441.5 mg/L to 10 mg/L, which is greater than a 97% reduction of TP. In the second half, the TP was reduced from 1600 mg/L to 65 mg/L, which is a 96% reduction.

The process water in the latter half of testing also had much higher solids content, and made the extractant phase extremely viscous. It is surmised that the viscosity increase was due to bio-polymers and lysed cells in the process water that was sampled closer to the biosludge at the bottom of the digester. The high viscosity required an increase in impeller speeds to pump extractant between stages, and the high solids content caused frequent clogging in the tubing, which had to be massaged out by hand. This clogging was especially troublesome in the stripping stages, where plugs in the Y overflow weirs would periodically cause siphoning between the stages. Ultimately, S2 became filled with the aqueous solution or phase from the upstream stages and overflowed the aqueous solution/phase back into S3. Furthermore, the rate of jelly production in the water wash increased significantly during the latter half of the run, which was attributable to the higher solids content. It was observed that during surges in the stripping stages that prevented steady extractant flow between stages, the lower E:A led to a more emulsified and slightly thicker E-phase in the subsequent stages. It was therefore determined that a lower E:A in the stripping stages is preferred, probably in the range of 1:1 to 1:4.

In spite of the blockages caused by the solids and higher viscosity, the phase disengagement in the extraction stages was good with the co-current setup. The purified water volume recovery was consistently around 95%, but this became difficult to measure later in the run as clogs in the raffinate outlet made for sporadic readings. Also, there began to be solids flowing out with the raffinate in the latter half of the run. These solids harbored the entrained extractant, but the extractant seemed to have no trouble disengaging under the vacuum filtration.

The third run demonstrated that the solids favor the extractant phase, and can be pushed through the stages and collected at the exits so long as there is a method to reclaim the entrained extractant. Furthermore, there were no solids that left the system in the K₃PO₄ product.

As mentioned previously, the rate of jelly formation in the water wash was accelerated in the second half of the run due to the higher solids content process water. The jelly quickly displaced the extractant and flowed to the surge tank, but the system was not shut down because it was the final run and the goal was to concentrate the phosphate product. The jelly formation was troubling, however, because of its high aqueous content, which suggests that the residence time in the stripping stages was not sufficient to allow the extractant to dewater between stages, or the increased mixing speeds over-emulsified the extractant. In such a case, the product would not concentrate in the first stripping stage, but would collect over all the stripping stages. This result was confirmed by the final analytical samples, which are shown in Table. The total phosphate concentration in all the stripping stage settlers was similar, around 1300 mg/L. This effect was compounded by the aforementioned Y-overflow weir clogs and the ensuing siphoning of aqueous into adjacent stages.

The rate of product concentration is in line with results found in the FY10 work, where the product was concentrated to around 1000 mg/L after 20 hours of run time. The final samples for the co-current run were taken after 20 hours of run time. The FY10 product was concentrated to above 8000 mg/L after 140 hours of run time, and there is no reason to doubt similar results would have been achieved if sufficient process water had been available to continue the run.

TABLE 19F
Disengagement and Concentration
Run Final Samples

| | Total Phosphate (mg/L) | |
|---|---|---|
| Sample | Trial 1 | Trial 2 |
| AD process | 1612.5 | 1587.5 |
| water | | |
| Raffinate | 75 | 56.5 |
| E1 Settler | 71.5 | 61 |
| E2 Settler | 42.5 | 31.5 |
| S1 Settler | 1240 | 1267.5 |
| S2 Settler | 1352.5 | 1357.5 |
| S3 Settler | 1317.5 | 1315 |
| S4 Settler | 1217.5 | 1187.5 |
| S5 Settler | 1312.5 | 1285 |

### Conclusion:

1. KOH pretreatment of the AD process water had no observable effect on phase disengagement or phosphorus extraction and should no longer be considered.
2. Solids entering the system with the AD process water flow through the system with the extractant and collect in the water wash as an emulsified jelly. It is possible that excluding water from the water wash entirely (including allowing incoming extractant to completely dewater) would eliminate gelling, but this is not confirmed. The dried solids are rich in potassium, magnesium and calcium, and have potential as a saleable product. Visually, it appears that the extractant can be successfully filtered out.
3. Although the solids flow through the system and can be collected at the end, they stabilize emulsions in the stripping section, requiring more residence time in the settlers for proper disengagement.
4. A co-current configuration in the extraction stages provided improved phase disengagement over the counter current configuration. However, it is possible that the counter-current configuration might provide better extraction results.
5. An E:A ratio of 1:2 in the extraction stages improved phase disengagement. It also successfully extracted >95% of phosphorus in the AD process water, even with higher strength process water (>1500 mg/L TP), a co-current extraction stage configuration, and greater solids contents.
6. Concentration of the K₃PO₄ product from the continuous flow run was good: the LLX process achieved 8000 mg/L after 140 hours of run time with an AD process water with low solids content. With more AD process water and running time, there is no reason to doubt the attainment of a similarly high concentrated product.
7. E:A in the stripping stages should be minimized to reduce emulsification in the mixing boxes. A good range is 1:1 to 1:4.
8. With higher solids content process water, solids begin to exit with the raffinate. These solids contain entrained extractant, but the extractant appears to elute smoothly from the solids under vacuum filtration.

### Example 20

The example tested for pathogen inactivation during the LLX extraction process. Anaerobically digested cow manure was tested as the process water.

The process water samples were digested through a two-staged digestion process at 50° C. and 35° C. The process water stayed in each stage for 10 days. Most of the bacteria were anaerobic, typical of anaerobic digesters. Digested process water was stored in a cold room prior to going through the several LLX extraction processes, that were carried out (1) after a day of storage (first set of experiments), and (2) after five days of storage for the second set of experiments. A five-day timeframe resulted in a minor reduction of organism concentration for the samples that went through the AD-LLC process, as compared to that of untreated samples, as indicated in Table 20. The LLX experiments were performed in a batch mode with 1:1 volume ratio between the process water and the extractant solution. The extractant solution or composition (similar to that of Example 16) comprised of 9.1 wt % Aliquat, 4.5 wt % Modifier, and 86.4 wt % Solvent: The two liquids were mixed for 2 minutes in a 100 ml beaker using a magnetic stirrer disk 1.5 inch in diameter, rotating at 600 rpm. These mixing conditions were sufficient to generate an emulsion that was stable for several seconds—a condition necessary for an effective mass transfer between the two liquids.

30-60 seconds after the mixing was stopped, two liquid phases started to separate, forming two distinct layers. At this point the samples were centrifuged for 5 minutes at 100 g acceleration (20 cm diameter centrifuge operating at 900 rpm), which caused a formation of two distinct layers. The bottom layer contained treated water with a small amount of fiber-like material forming larger agglomerates, which constituted indigestible materials from animal consumption as well as fragments of bio organisms living in manure. These agglomerates collected both at the bottom of a beaker and just below the phase interface.

In the first set of extraction experiments, the agglomerates contained in the aqueous layer were collected together with this layer. In the second set of extraction experiments, the fiber-like agglomerates were filtered from the water samples prior to undergoing the LLX process. The extraction was repeated three times to simulate a three-stage LLX extraction system. It was observed that after the extraction process, the treated process water does not contain much of the strong odor that was presented in the un-treated process water.

Table 20 lists the results of preliminary pathogen inactivation tests. Standard microbiology spread plating method was used to test for the total microbial count for each sample. Initial results from testing the process water containing organic fibers/agglomerates yielded 93% total pathogen reduction after the first extraction and 97% after the third extraction. These inactivation levels, while promising, may not provide adequate pathogen risk reduction. In addition, the entrapment of pathogens in the fiber agglomerates may have prevented pathogens from being direct exposed to the extractant, thereby necessitating alternative engineering solutions to optimize contact time. The second set of experiments using pre-separation of agglomerates resulted in pathogen inactivation levels of 95% and 99.1% after the first and third extractions, respectively. These results suggest that further optimization of the LLX process may yield higher inactivation levels.

TABLE 20
Inactivation of Organisms in Extraction Testing

| | 1^{st} set of experiments, | 2^{nd} set of experiments, |
|---|---|---|
| | process water not separated | process water without |
| | from organic | organic fibers/ |
| Property | fibers/agglomerates | agglomerates |
| Organism concentration | 6.6 × 10⁶/cc | 2.4 × 10⁶/cc |
| prior to extraction | | |
| Inactivation after 1^{st} | 93% (1.14 log) | 95% (1.30 log) |
| extraction | | |
| Inactivation after 2^{nd} | 91% (1.03 log) | 98.5% (1.82 log) |
| extraction | | |
| Inactivation after 3^{rd} | 97% (1.52 log) | 99.1% (2.06 log) |
| extraction | | |

### Conclusion:

The test results from Table 20 show that the LLX's extraction phase inactivated pathogen up to 99.1%. It appears that the LLX process of the present invention is able to destroy pathogens along with removing N- and P-based nutrients from the AD process water along with reducing odor in one single process, making nutrient removal a simplified, safe, and economical process.

While not wishing to be bound by theory, it is presently theorized that the pathogen inactivation efficiency may be a function of process parameters. The model will assume an exponential decay of a number of active pathogen P(t) organism with time:

P(t)=P₀exp(−At)

Where the decay constant A is a function of process parameters such as temperature, process water to extractant ratio, extractant strength, and mixing conditions.

### Example 21

This example evaluated the effectiveness of the LLX process of the present invention in extracting or removing trace phosphate from the phosphorus surrogate solution—a type of the process water.

4 mg/l phosphorus surrogate solution (NH₄H₂PO₄) (the “process water”) was prepared. The process water was extracted 10 times with the fresh extractant solution in an 1:2 E/A ratio. The extractant solution comprised of 9.1 wt % Aliquat, 4.5 wt % Modifier, and 86.4 wt % Solvent. Aqueous samples were taken from the treated process water after each extraction. Activated carbon was used to remove residual organics. Inductive Coupled Plasma-Mass Spectrometry (ICP-MS) ( ) was used to quantify phosphorus in samples. The model number for the ICP-MS was Perkin Elmer ELAN DRC-e (Dynamic Reaction Cell) with Perkin Elmer's Elan Data Software System.

The following were the procedure for this Example:
1. Prepared 500 mL of the process water (˜4 mg/L (˜4 ppm) phosphorus surrogate solution (about 10 mg/L to 13 mg/L phosphate solution)) by adding 6.0 mg of ammonium phosphate (NH₄H₂PO₄) to a 500-mL volumetric flask containing ˜250 mL of high purity (18.2 MΩ*cm) deionized (HPDI) water. The balanced was a Mettler Toledo AB54-S Classic. Mixed until the ammonium phosphate solids have completely dissolved, and then add HPDI water to the 500-mL mark. Capped, mixed well, and transferred this solution to a 1-L plastic bottle. Retained about 10-15 mL of this phosphate solution in a centrifuge tube for analysis.
2. Prepared a blank by adding about 500 mL of HPDI water to the same type of plastic bottle used in step 1. Retained 10-15 mL of the blank in a centrifuge tube as a sample.
3. To the blank and the process water, added the extractant solution in an E:A ratio of 1:2. Shook the bottles to mix the two phases.
4. Poured the blank and the extractant solution into a PTFE separatory funnel supported on a ring stand. Allowed the phases to separate. Drained 25-30 mL of the bottom (aqueous) phase into a centrifuge tube.
5. Washed the separatory funnel with Micro-90 in tap water, rinsed well with tap water, and then rinsed well with HPDI water.
6. Poured the mixture of process water and extractant into a PTFE separatory funnel supported on a ring stand. Allowed the phases to separate. Drained the bottom (aqueous) phase into the same plastic bottle, dispose of the extractant. Took 25-30 mL of the aqueous phase (the treated process water) from the bottle and placed in a centrifuge tube.
7. Washed the separatory funnel with Micro-90 in tap water, rinsed well with tap water, and then rinsed well with HPDI water.
8. To the bottle containing the treated process water or the aqueous phase from step 6, added fresh extractant solution in an E:A ratio of 1:2. Shake the bottle to mix the two phases.
9. Repeated steps 6-8 nine more times, to simulate ten stages of extraction. Added fresh extractant solution to the process water (aqueous solution) in volumes that maintained the 1:2 E:A ratio. Collected all the aqueous samples in separate centrifuge tubes.
10. Added about 5 g of granular activated carbon to each sample and shook for at least one minute. Allowed to sit overnight.
11. Filtered the aqueous through a 0.45 μm syringe filter into a separate centrifuge tube. Collected at least 10 mL of each solution for analysis.
12. Analyzed samples for phosphorus concentration by ICP-MS.

### Results & Discussion:

After ten extractions, the phosphorus concentration in the process water was reduced to 17 μg/l (˜17 ppb) from 4 ppm, indicating that the present method is effective in removing trace phosphate and in reducing the phosphate in the AD solution to a very low level (down to possibly 15 ppb).

The present LLX process can be improved by (1) adjusting extractant formulation to improve phase disengagement, which allows better mixing, and/or (2) active separations, such as centrifuges/cyclones.

The extracted phosphorus can be recovered in a concentrated tri-basic phosphate solution after the stripping phase, where the extractant is recharged for regeneration and recycling back to be used to extracting more phosphorus from the incoming AD process water.

1. A method for treating a process water to remove one or more P- and/or N-based ionic species, comprising steps of:
A. mixing the process water with an extractant phase to form a first unstable emulsion wherein the extractant phase comprises:
i. an extractant that forms the first unstable emulsion with one or more of the ionic species of the process water, wherein the extractant comprises a positively charged molecule having at least 8 carbon atoms, and an anionic base;
ii. an optional diluent; and
iii. an optional modifier for modifying phase disengagement;
B. disengaging and separating a first treated process water and an ion-loaded extractant phase from the first unstable emulsion to generate a separated ion-loaded extractant phase; and
C. stripping one or more ionic species from the separated ion-loaded extractant phase to obtain a stripped extractant phase and the concentrate ionic products, comprising steps of
i. mixing the separated ion-loaded extractant phase with a first aqueous base solution to form a second unstable emulsion; wherein one or more ionic species, such as phosphate, in the separated ion-loaded extractant phase are stripped from the separated ion-loaded extractant phase and loaded into the first aqueous base solution; wherein a second aqueous base solution is added to the second unstable emulsion during the stripping process to keep the equilibrium pH of the second unstable emulsion to be about 11 or above, preferably at about pH of 13 to 14; and
ii. disengaging and separating a stripped extractant phase and a loaded first aqueous base solution from the second unstable emulsion, resulting in a regenerated extractant phase and an ion-loaded aqueous phase containing the concentrated ionic products.

2. The method according to claim 1, wherein the ionic species are phosphate, polyphosphate, organo-phosphate, nitrate, nitrite, or a mixture thereof.

3. The method according to claim 1, wherein the first aqueous base solution is selected from a group consisting of aqueous carbonate solution; aqueous hydroxide solution; an aqueous solution of ionic bases selected from a group consisting of CO₃²⁻, HCO₃⁻, OH⁻, HS⁻ and S²⁻, wherein CO₃²⁻ is most preferred; other bases with a pKa value of >11; and a mixture thereof.

4. The method according to claim 1, wherein the second aqueous base solution is selected from a group consisting of potassium hydroxide, sodium hydroxide, milk of lime, or other OH⁻ basic solutions, or a mixture thereof.

5. The method according to claim 1, wherein the positively charged extractant component comprises a quaternary ammonium or phosphonium compound selected from the group consisting of R₄N⁺, R₄P⁺, an alkylated monoguanadinium compound, and a mixture thereof; where the R groups may differ and are a hydrocarbon consisting of alkyl groups, aryl groups, alkylaryl groups, any combination of these, including atoms of other elements such as N, P, O and S so that the water solubility is not significantly increased or the monocationic charge for the whole molecule is not changed, and the charge does not change with pH up until a pH of about 11, and where the minimum carbon number (CN) is >8, preferably >17, and more preferably >24, and most preferably where at least one alkyl group in the molecule is branched, and wherein the anionic base is selected from the group consisting of CO₃²⁻, HCO₃⁻, OH⁻, HS⁻, S²⁻, and a mixture thereof.

6. The method according to claim 1 step B, wherein sufficient time, such as 0 to 50 minutes, preferably 10-30 minutes, is provided to sufficiently separate the first treated process water and the ion-loaded extractant phase from the first unstable emulsion.

7. The method according to claim 1, further comprising a step of diluting the process water with a second aqueous solution prior to the mixing step A, wherein the second aqueous solution comprises water, deionized water, process water, cistern water, city water, surface water, well water, process product water, or a mixture thereof.

8. The method according to claim 1, further comprising a step of removing solid particulates from the process water prior to the mixing step A.

9. The method according to claim 1, further comprising a step of recycling the stripped extractant phase of step C to the mixing step A.

10. The method according to claim 1, further comprising a step of further treating with or recycling the first treated process water of step B to the mixing step A.

11. The method according to claim 1, wherein the ion-loaded aqueous phase containing the concentrated ionic product is further treated by one or more of an oil/water separator, a solid/liquid separator, a sorbent for odor removal, or a mixture thereof, wherein one or more aqueous ion concentrate products are obtained.

12. The method according to claim 1, further comprising
A. mixing at least a portion of the first treated process water with the extraction phase to form a third unstable emulsion;
B. disengaging and separating the second treated process water and a second ion-loaded extractant phase from the third unstable emulsion to generate a separated second ion-loaded extractant phase, wherein the separated second ion-loaded extractant phase contains one or more P- and/or N-based ionic species; and
C. stripping one or more P- and/or N-based ionic species from the separated second ion-loaded extractant phase to obtain a stripped extractant phase and concentrated ionic products, wherein the first aqueous base solution is mixed with the separated second ion-loaded extractant phase to form a fourth unstable emulsion to strip ionic species from the ion-loaded extractant phase; and the second aqueous base solution is added to keep the fourth unstable emulsion during the stripping to be about pH 11 or above, preferable at about pH 13 or 14.

13. The method according to claim 1, further comprising
A. removing ammonium ions, as ammonia vapor, from the mixture of the process water and the extractant phase in step A; and
B. recovering the ammonia, such as ammonia liquid, aqueous ammonia solution, or ammonium ions as concentrated ammonium products.

14. The method according to claim 1, further comprising:
washing the stripped extractant phase of step C with a third aqueous solution to obtain a washed ion stripped extractant reduced in one or more water soluble ions, preferably reduced in one or more entrained water soluble ions;
wherein the third aqueous solution comprises water, deionized water, process water, cistern water, city water, surface water, well water, process product water, or a mixture thereof.

15. The method according to claim 15, wherein the washed ion stripped extractant phase is recycled to the mixing step A of claim 1.

16. The method according to claim 1, wherein the process water has a phosphate concentration in a range of about 1 to about 30 ppm, preferably in a range of about 1 to about 15 ppm.

17. The method according to claim 1, wherein the phosphate concentration in the first treated process water is in a range of about 50 ppb to about 200 ppb.

18. The method according to claim 12, wherein the phosphate concentration in the second treated process water is in a range of about 50 ppb to about 200 ppb.

19. The method according to claim 1, wherein the polyphosphate level in the first treated process water is in a range of about 1 mg/L to about 75 mg/L.

20. The method according to claim 15, wherein the pathogens and/or waste vapors are removed from the process water.
